(19) United States
(12) Patent Application Publication
(10) Pub. No.: US 2026/0135747 A1
(43) Pub. Date: May 14, 2026

(54) BEAM TRACKING

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US); Md. Saifur Rahman, Plano, TX (US)

(21) Appl. No.: 19/367,799

(22) Filed: Oct. 23, 2025

Related U.S. Application Data
(60) Provisional application No. 63/718,326, filed on Nov. 8, 2024.
(60) Provisional application No. 63/724,149, filed on Nov. 22, 2024.
(60) Provisional application No. 63/744,663, filed on Jan. 13, 2025.
(60) Provisional application No. 63/816,335, filed on Jun. 2, 2025.

(51) Int. Cl. H04L 27/26; H04B 17/318; H04L 5/00; H04W 72/23

(52) U.S. Cl. CPC H04L 27/261; H04B 17/328; H04L 5/0007; H04W 72/23

(57) ABSTRACT

Methods and apparatuses for beam tracking. A method of operating a user equipment (UE) includes receiving a physical downlink shared channel (PDSCH). The PDSCH includes first resource elements (REs) associated with downlink shared channel (DL-SCH), second REs associated with demodulation reference signals (DMRS), and third REs associated with N reference signals (RSs), where N is larger than or equal to 1. Each of the N RSs is associated with a corresponding spatial domain filter. The method further includes measuring the N RSs, determining information based on the measurement of the N RSs, and transmitting a first channel that includes the information.

### CROSS-REFERENCE TO RELATED AND CLAIM OF PRIORITY

The present application claims priority under 35 U.S.C. § 119(e) to U.S. Provisional Patent Application No. 63/718,326 filed on Nov. 8, 2024; U.S. Provisional Patent Application No. 63/724,149 filed on Nov. 22, 2024; U.S. Provisional Patent Application No. 63/744,663 filed on Jan. 13, 2025; and U.S. Provisional Patent Application No. 63/816,335 filed on Jun. 2, 2025, which are hereby incorporated by reference in their entirety.

### TECHNICAL FIELD

The present disclosure relates generally to wireless communication systems and, more specifically, the present disclosure relates to methods and apparatuses for beam tracking.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam tracking.

In one embodiment, a user equipment (UE) is provided. The UE includes a transceiver configured to receive a physical downlink shared channel (PDSCH). The PDSCH includes first resource elements (REs) associated with downlink shared channel (DL-SCH), second REs associated with demodulation reference signals (DM-RS), and third REs associated with N reference signals (RSs), where N is larger than or equal to 1. Each of the N RSs is associated with a corresponding spatial domain filter. The UE further includes a processor operably coupled to the transceiver. The processor is configured to measure the N RSs and determine information based on the measurement of the N RSs. The transceiver is further configured to transmit a first channel that includes the information.

In another embodiment, a base station (BS) is provided. The BS includes a processor and a transceiver operably coupled to the processor. The transceiver configured to transmit a PDSCH and receive a first channel that includes information related to measurement of N RSs. The PDSCH includes first REs associated with DL-SCH, second REs associated with DMRS, and third REs associated with the N RSs, where N is larger than or equal to 1. Each of the N RSs is associated with a corresponding spatial domain filter.

In yet another embodiment, a method of operating a UE is provided. The method includes receiving a PDSCH. The PDSCH includes first REs associated with DL-SCH, second REs associated with DMRS, and third REs associated with N RSs, where N is larger than or equal to 1. Each of the N RSs is associated with a corresponding spatial domain filter. The method further includes measuring the N RSs, determining information based on the measurement of the N RSs, and transmitting a first channel that includes the information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system and FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of a PDSCH DM-RS supporting 4 antenna ports according to embodiments of the present disclosure;

FIG. 8 illustrates an example of a PDSCH DM-RS supporting 8 antenna ports according to embodiments of the present disclosure;

FIG. 9 illustrates an example of a PDSCH supporting 6 antenna ports according to embodiments of the present disclosure;

FIG. 10 illustrates an example of a PDSCH supporting 12 antenna ports according to embodiments of the present disclosure;

FIG. 11 illustrates an example of a code division multiplexing (CDM) groups and the ports of each CDM group according to embodiments of the present disclosure;

FIG. 12 illustrates an example of a PUSCH DM-RS supporting 8 antenna ports according to embodiments of the present disclosure;

FIG. 13 illustrates an example of a PUSCH DM-RS supporting 16 antenna ports according to embodiments of the present disclosure;

FIG. 14 illustrates an example of a PUSCH DM-RS supporting 12 antenna ports according to embodiments of the present disclosure;

FIG. 15 illustrates an example of a PUSCH DM-RS supporting 24 antenna ports according to embodiments of the present disclosure;

FIG. 16 illustrates an example of a frequency hop within a slot according to embodiments of the present disclosure;

FIG. 17 illustrates an example of a transceiver architecture with joint phase-time arrays (JPTAs) according to embodiments of the present disclosure;

FIG. 18 illustrates an example of JPTA beamforming in a wireless network according to embodiments of the present disclosure;

FIGS. 19A and 19B illustrate examples of a beam change due to mobility and channel conditions according to embodiments of the present disclosure;

FIG. 20 illustrates an example of a multi-beam system, where each beam can have a set of adjacent or associated beams according to embodiments of the present disclosure;

FIG. 21 illustrates an example timeline for scheduling the PDSCH whether to receive beam tracking reference signals according to embodiments of the present disclosure;

FIG. 22 illustrates an example of beam transmission for scheduling the PDSCH whether to receive beam tracking reference signals according to embodiments of the present disclosure;

FIGS. 23A-25D illustrate examples of DM-RS configurations according to according to embodiments of the present disclosure;

FIGS. 26A-26D illustrate examples of allocating contiguous REs or contiguous RBs to different types of reference signals according to embodiments of the present disclosure;

FIGS. 27A-27D illustrate examples of allocating REs or RBs to different types of reference signals according to embodiments of the present disclosure;

FIG. 28 illustrates an example of transmission of different types of RSs in symbols of a DL channel according to embodiments of the present disclosure;

FIGS. 29A-29D illustrate examples of allocating contiguous REs or contiguous RBs to different Beam Tracking Reference Signal (BT-RS) according to embodiments of the present disclosure;

FIGS. 30A-30D illustrate examples of allocating REs or RBs to different types of reference signals according to embodiments of the present disclosure;

FIG. 31 illustrates an example timeline for scheduling the PDSCH whether to a UE measurement report with HARQ-ACK feedback according to embodiments of the present disclosure;

FIG. 32 illustrates an example of transmission of cell beam tracking reference signals (CBT-RS) according to embodiments of the present disclosure;

FIGS. 33A-33D illustrate examples of allocating contiguous REs or contiguous RBs to different types of reference signals according to embodiments of the present disclosure;

FIGS. 34A-34D illustrate examples of allocating REs or RBs to different types of reference signals according to embodiments of the present disclosure;

FIGS. 35A-35D illustrate examples of allocating contiguous REs or contiguous RBs to different CBT-RS according to embodiments of the present disclosure;

FIGS. 36A-36D illustrate examples of allocating REs or RBs to different CBT-RS according to embodiments of the present disclosure;

FIG. 37 illustrates an example of DL channel or signal reception using multiple spatial domain reception filters according to embodiments of the present disclosure;

FIGS. 38A-38F illustrate examples of UE reports according to embodiments of the present disclosure;

FIGS. 39A-39D illustrate examples of UE reporting according to embodiments of the present disclosure;

FIGS. 40A and 40B illustrate examples of UE reporting according to embodiments of the present disclosure;

FIGS. 41A-41B illustrate examples of UE reporting according to embodiments of the present disclosure;

FIG. 42 illustrates examples of components for an integrated sensing and communications system according to embodiments of the present disclosure

FIG. 43 illustrates an example sensing and communications transmitter (SCT) according to embodiments of the present disclosure;

FIG. 44 illustrates an example sensing and communication beam interference according to embodiments of the present disclosure;

FIGS. 45A and 45B illustrate examples of beam patterns for sensing signals according to embodiments of the present disclosure;

FIG. 46 illustrates an example transmission period for a sensing signal over time and frequency units according to embodiments of the present disclosure;

FIG. 47A illustrates an example of a sensing signal transmitted by the same device transmitting the communication signal according to embodiments of the present disclosure;

FIG. 47B illustrates an example of the sensing signal and the communication signal transmitted from different devices according to embodiments of the present disclosure;

FIGS. 48A-48D illustrate examples of multiplexing a first DMRS transmitted on sensing signal and a second DMRS transmitted on communication signal and data transmitted on both the communication and data signal according to embodiments of the present disclosure;

FIG. 49 illustrates an example of devices performing sensing and communication according to embodiments of the present disclosure;

FIG. 50 illustrates another example of devices performing sensing and communication according to embodiments of the present disclosure; and

FIG. 51 illustrates an example method performed by a UE in a wireless communication system according to embodiments of the present disclosure.

### DETAILED DESCRIPTION

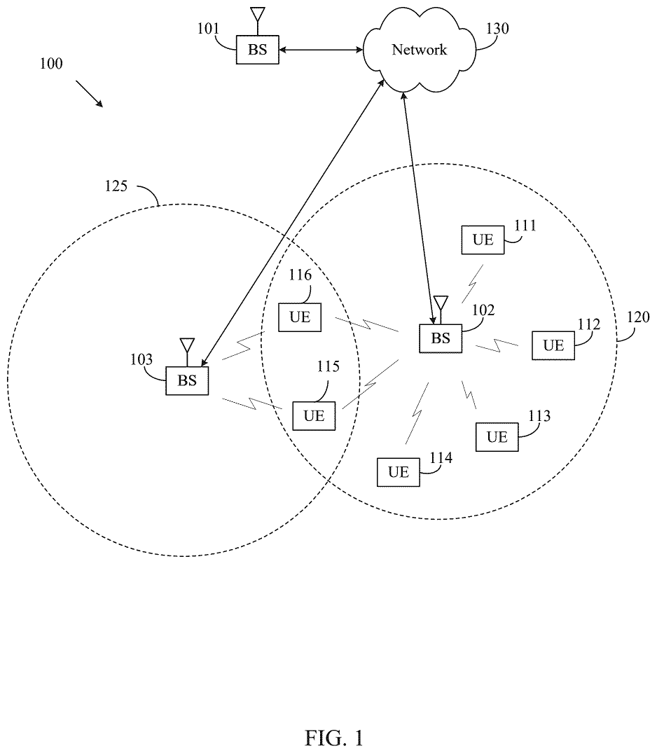

FIGS. 1-51, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v18.4.0, “NR; Physical channels and modulation;” [REF 2] 3GPP TS 38.212 v18.4.0, “NR; Multiplexing and Channel coding;” [REF 3]3GPP TS 38.213 v18.4.0, “NR; Physical Layer Procedures for Control;” [REF 4] 3GPP TS 38.214 v8.4.0, “NR; Physical Layer Procedures for Data;” [REF 5] 3GPP TS 38.321 v18.3.0, “NR; Medium Access Control (MAC) protocol specification;” and [REF 6] 3GPP TS 38.331 v18.3.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing beam tracking. In certain embodiments, one or more of the BSs 101-103 include circuitry, programing, or a combination thereof to support beam tracking.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

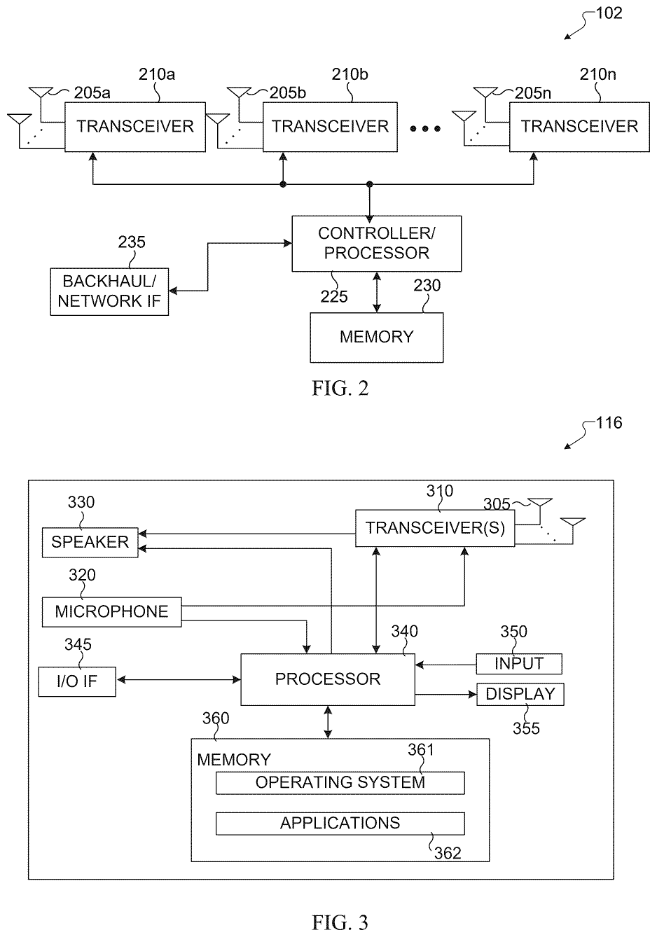

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support includes a number of symbols forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting beam tracking. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize beam tracking as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

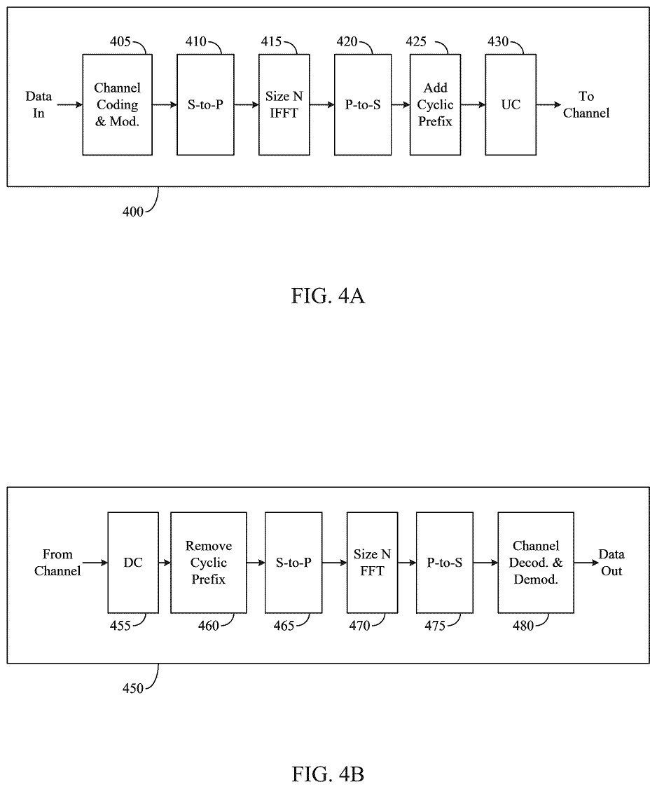

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support beam tracking as described in embodiments of the present disclosure. In some embodiments, the receive path 450 is configured to support beam tracking as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

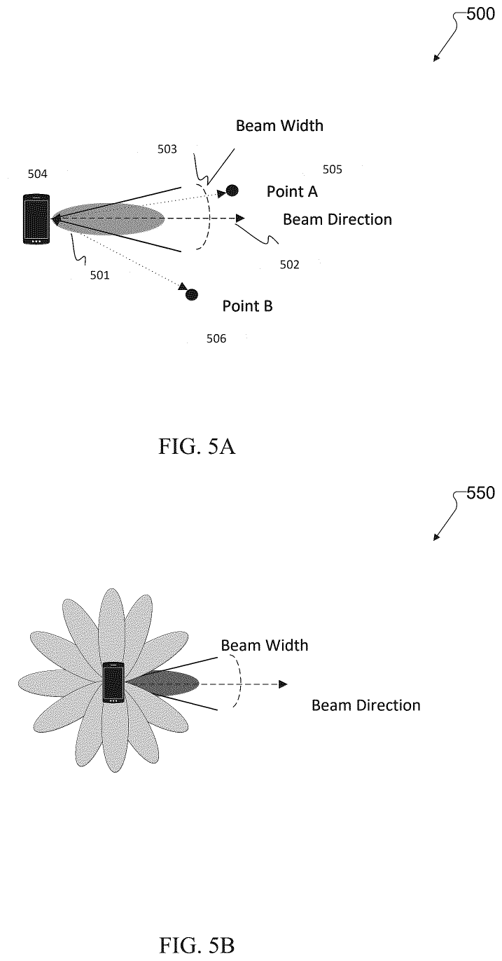

FIG. 5A illustrates an example of a wireless system 500 according to embodiments of the present disclosure. For example, the wireless system 500 can be implemented in the wireless network 100 of FIG. 1. This example is for illustration only and other embodiments can be used without departing from the scope of the present disclosure.

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

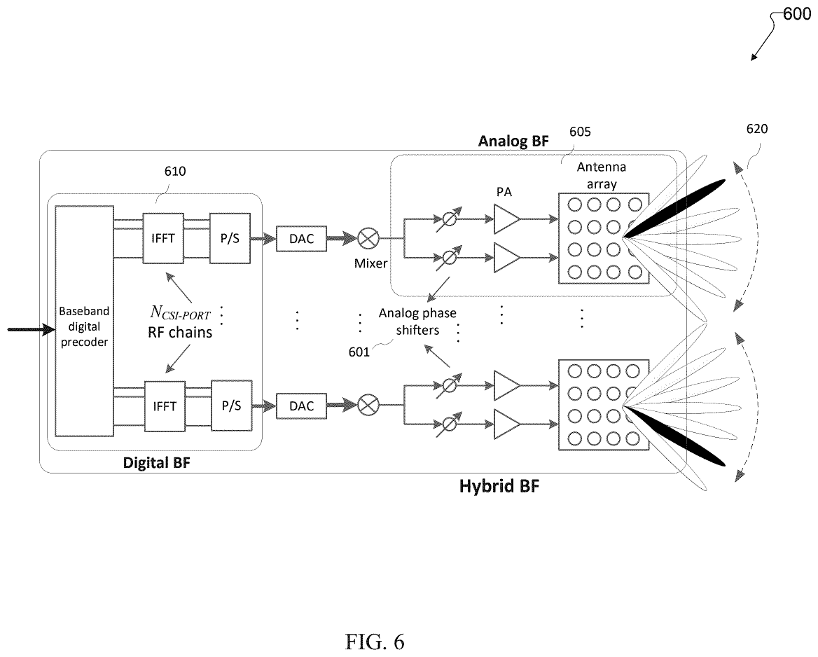

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond, and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). A slot can include sub-band full duplex (SBFD) symbols, wherein a symbol includes DL sub-band(s) and UL sub-band(s). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 38.212, are referred for brevity as a unicast DCI format. A DCI format scheduling PDSCH reception for multicast communication, such as a DCI format with CRC scrambled by G-RNTI/G-CS-RNTI as described in 38.212, are referred to as multicast DCI format. DCI formats providing various control information to at least a subset of UEs in a serving cell, such as DCI format 2_0 in 38.212, are referred to as group-common (GC) DCI formats.

The downlink physical-layer processing of transport channels on PDSCH can consist of the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As aforementioned, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of TPC commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the DRX on-duration; (10) In IAB context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A BS (such as BS 102) transmits one or more of multiple types of RS including channel state information RS (CSI-RS) and demodulation RS (DMRS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE (such as UE 116) can determine CSI-RS transmission parameters through DL control signaling or higher layer signaling, such as radio resource control (RRC) signaling from a BS. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a BS to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The BS can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a BS to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a BS of a largest modulation and coding scheme (MCS) for the UE to detect a data TB with a predetermined block error rate (BLER), such as a 10% BLER, of a precoding matrix indicator (PMI) informing a BS how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A BS can use a DMRS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random-access channel (PRACH)

The PDSCH DM-RS is mapped to physical resources (resources elements in a DM-RS symbol) according to configuration Type 1 or configuration Type 2

For configuration type 1:

$$k = 4 n + 2 {k}^{′} + Δ$$

Where,
   k′=0,1
   n=0,1, . . .
   Δ=0, for ports 1000, 1001, 1004 and 1005. λ=1, for ports 1002, 1003, 1006 and 1007.

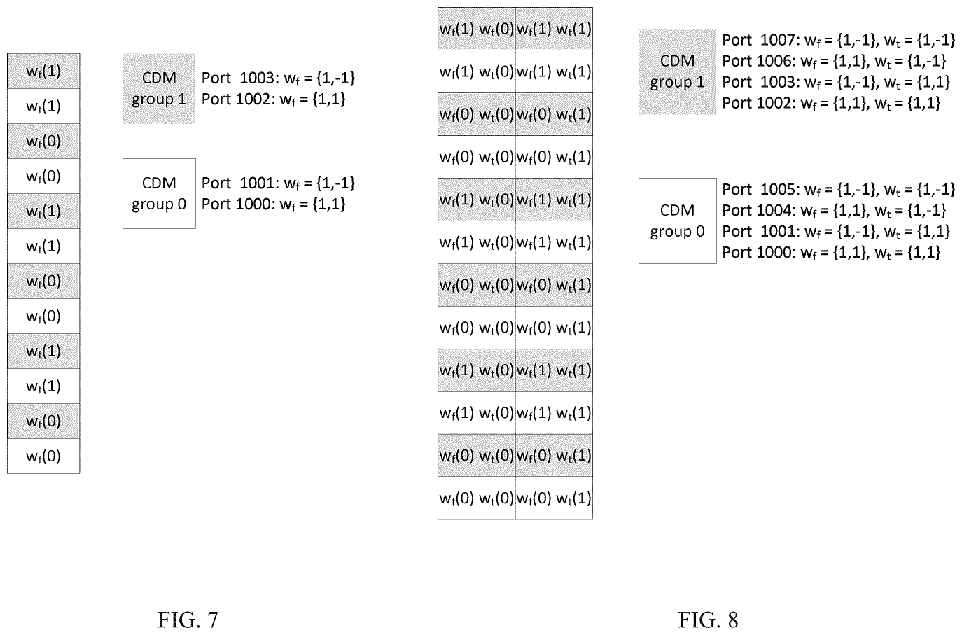

FIG. 7 illustrates an example of a PDSCH DM-RS supporting 4 antenna ports according to embodiments of the present disclosure. FIG. 8 illustrates an example of a PDSCH DM-RS supporting 8 antenna ports according to embodiments of the present disclosure. These examples are for illustration only and other embodiments can be used without departing from the scope of the present disclosure.

With a single DM-RS symbol, the PDSCH DM-RS supports 4 antenna ports (1000 . . . 1003) as illustrated in FIG. 7. With double DM-RS symbols, the PDSCH DM-RS supports 8 antenna ports (1000 . . . 1007) as illustrated in FIG. 8. In FIG. 7, antenna ports 1000 and 1001 are in a same code division multiplexing (CDM) group (e.g., CDM group 0), where the two antenna ports are differentiated by orthogonal codes in the frequency domain. Similarly, in FIG. 7, antenna ports 1002 and 1003 are in a same CDM group (e.g., CDM group 1), where the two antenna ports are differentiated by orthogonal codes in the frequency domain. In FIG. 8, antenna ports 1000, 1001, 1004 and 1005 are in a same CDM group (e.g., CDM group 0), where the four antenna ports are differentiated by orthogonal codes in the frequency domain and orthogonal codes in the time domain. Similarly, in FIG. 8 antenna ports 1002, 1003, 1006 and 1007 are in a same CDM group (e.g., CDM group 1), where the four antenna ports are differentiated by orthogonal codes in the frequency domain and orthogonal codes in the time domain.

For configuration type 2:

$$k = 6 n + {k}^{′} + Δ$$

Where,
   k′=0,1
   n=0,1, . . .
   Δ=0, for ports 1000, 1001, 1006 and 1007. Δ=2, for ports 1002, 1003, 1008 and 1009. Δ=4, for ports 1004, 1005, 1010 and 1011.

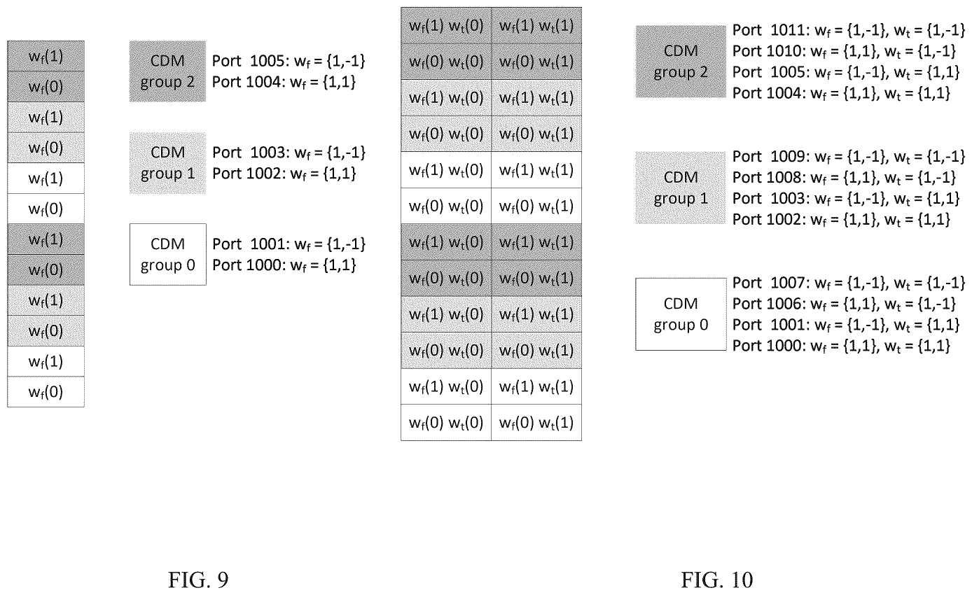

FIG. 9 illustrates an example of a PDSCH supporting 6 antenna ports according to embodiments of the present disclosure. FIG. 10 illustrates an example of a PDSCH supporting 12 antenna ports according to embodiments of the present disclosure. These examples are for illustration only and other embodiments can be used without departing from the scope of the present disclosure.

With a single DM-RS symbol, the PDSCH supports 6 antenna ports (1000 . . . 1005) as illustrated in FIG. 9. With double DM-RS symbol, the PDSCH supports 12 antenna ports (1000 . . . 1011) as illustrated in FIG. 10. In FIG. 9, antenna ports 1000 and 1001 are in a same CDM group (e.g., CDM group 0), where the two antenna ports are differentiated by orthogonal codes in the frequency domain. Similarly, in FIG. 9, antenna ports 1002 and 1003 are in a same CDM group (e.g., CDM group 1), where the two antenna ports are differentiated by orthogonal codes in the frequency domain. Similarly, in FIG. 9, antenna ports 1004 and 1005 are in a same CDM group (e.g., CDM group 2), where the two antenna ports are differentiated by orthogonal codes in the frequency domain. In FIG. 10, antenna ports 1000, 1001, 1006 and 1007 are in a same CDM group (e.g., CDM group 0), where the four antenna ports are differentiated by orthogonal codes in the frequency domain and orthogonal codes in the time domain. Similarly, in FIG. 10, antenna ports 1002, 1003, 1008 and 1009 are in a same CDM group (e.g., CDM group 1), where the four antenna ports are differentiated by orthogonal codes in the frequency domain and orthogonal codes in the time domain. Similarly, in FIG. 10, antenna ports 1004, 1005, 1010 and 1011 are in a same CDM group (e.g., CDM group 2), where the four antenna ports are differentiated by orthogonal codes in the frequency domain and orthogonal codes in the time domain.

Channel state information-reference signal (CSI-RS) is a downlink reference signal that is used for measuring the DL channel (i.e., channel state or quality estimation) between the UE and the BS. In case of reciprocity between UL and DL, the channel measurement of the DL channel can also be used for link adaptation and precoding on the UL channel from the UL to the BS. CSI-RS is transmitted independent of data transmissions on the DL. The CSI-RS can be configured for tracking (e.g., tracking reference signal (TRS)), or for CSI measurement or for beam management.

CSI-RS is mapped to resource elements outside the PDSCH transmission. The resource mapping depends higher layer configuration:
startPRB and nrofPRBs provide the starting RB index of the measurement (CSI-RS) bandwidth and the allowed size of the measurement (CSI-RS) BW in RBs respectively.
frequencyDomainAllocation is a bitmap that provides the REs used for CSI-RS within an RB. The interpretation of frequencyDomainAllocation is influenced by density and cdm-Type. The frequency domain allocation determines the values of k₀, k₁, k₂ and k₃ used for the starting RB of CDM groups as illustrated in Table 1.
firstOFDMSymbolInTimeDomain (l₀) and firstOFDMSymbolInTimeDomain2 (l₁) provide the first OFDM symbol in a slot used for a CMD group of CSI-RS as illustrated in Table 1.
density (ρ) provides the density of CSI-RS in terms of RE/port/RB. The allowed values are:
   3, which is used for tracking reference signal with one antenna port
   1.
   0.5, when ρ=0.5, the CSI-RS is mapped to even RBs or odd RBs as indicated by the density parameter. Density 0.5 is used for 1, 2, 16, 24 and 32 antenna ports.
nrofPorts (X) provides the number of antenna ports used for CSI-RS, allowed values are in the set {1, 2, 4, 8, 12, 16, 24, 32}.
cdm-Type provides the cdm-Type used for CSI-RS from the set of values {noCDM, fd-CDM2, cdm4-FD2-TD2, cdm8-FD2-TD4}. The allowed cdm-Type depends on the nrofPorts, and determines the number of CMD groups as illustrated in Table 1.

The REs within a PRB used for CSI-RS, with a sub-carrier k, and symbol l, is given by:

$$k = {nN}_{sc}^{RB} + \overline{k} + {k}^{′}$$

$$l = \overline{l} + {l}^{′}$$

Where
   k̅, k′, l̅ and l′ are provided by Table 1. k̅ and l̅ are the starting sub-carrier and symbol of a CDM group respectively. k′ and l′ are the sub-carrier and symbol within the CDM group respectively.
   n=0,1, . . .

$${N}_{sc}^{RB} = 12 sub - carriers .$$

TABLE 1
[38.211] CSI-RS locations within a slot

| | Ports | Density | | | CDM group | | |
|---|---|---|---|---|---|---|---|
| Row | (X) | (ρ) | cdm-Type | (k̅, l̅) | index | k′ | l′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀) | 0 | 0 | 0 |
| 3 | 2 | 1, 0.5 | fd-CDM2 | (k₀, l₀) | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), | 0, 1, 2, 3 | 0, 1 | 0 |
| | | | | (k₃, l₀) | | | |
| 7 | 8 | 1 | fd-CDM2 | (k₀, l₀), (k₁, l₀), (k₀, l₀ + | 0, 1, 2, 3 | 0, 1 | 0 |
| | | | | 1), (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), | 0, 1, 2, 3, 4, 5 | 0, 1 | 0 |
| | | | | (k₃, l₀), (k₄, l₀), (k₅, l₀) | | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7 | | |
| | | | | (k₁, l₀ + 1), (k₂, l₀ + 1), | | | |
| | | | | (k₃, l₀ + 1) | | | |
| 12 | 16 | 1, 0.5 | cdm4-FD2- | (k₀, l₀), (k₁, l₀), (k₂, l₀), | 0, 1, 2, 3 | 0, 1 | 0, 1 |
| | | | TD2 | (k₃, l₀) | | | |
| 13 | 24 | 1, 0.5 | fd-CDM2 | (k₀, l₀), (k₁, l₀), (k₂, l₀), | 0, 1, 2, 3, 4, 5, | 0, 1 | 0 |
| | | | | (k₀, l₀ + 1), (k₁, l₀ + 1), | 6, 7, 8, 9, 10, 11 | | |
| | | | | (k₂, l₀ + 1), (k₀, l₁), | | | |
| | | | | (k₁, l₁), (k₂, l₁), (k₀, l₁ + | | | |
| | | | | 1), (k₁, l₁ + 1), (k₂, l₁ + | | | |
| | | | | 1) | | | |
| 14 | 24 | 1, 0.5 | cdm4-FD2- | (k₀, l₀), (k₁, l₀), (k₂, l₀), | 0, 1, 2, 3, 4, 5 | 0, 1 | 0, 1 |
| | | | TD2 | (k₀, l₁), (k₁, l₁), (k₂, l₁) | | | |
| 15 | 24 | 1, 0.5 | cdm8-FD2- | (k₀, l₀), (k₁, l₀), (k₂, l₀) | 0, 1, 2 | 0, 1 | 0, 1, 2, 3 |
| | | | TD4 | | | | |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7, | | |
| | | | | (k₁, l₀ + 1), (k₂, l₀ + 1), | 8, 9, 10, 11, | | |
| | | | | (k₃, l₀ + 1), (k₀, l₁), | 12, 13, 14, 15 | | |
| | | | | (k₁, l₁), (k₂, l₁), (k₃, l₁), | | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4-FD2- | (k₀, l₀), (k₁, l₀), (k₂, l₀), | 0, 1, 2, 3, 4, | 0, 1 | 0, 1 |
| | | | TD2 | (k₃, l₀), (k₀, l₁), (k₁, l₁), | 5, 6, 7 | | |
| | | | | (k₂, l₁), (k₃, l₁) | | | |
| 18 | 32 | 1, 0.5 | cdm8-FD2- | (k₀, l₀), (k₁, l₀), (k₂, l₀), | 0, 1, 2, 3 | 0, 1 | 0, 1, 2, 3 |
| | | | TD4 | (k₃, l₀) | | | |

As an example, the RE allocation for row 14 in Table 1 corresponds to X=24 ports, assume density ρ=1, cdm-Type cdm4-FD2-TD2. Let the frequencyDomainAllocation be 010101, therefore k₀=0, k₁=4 and k₂=8. Let, l₀=4, and l₁=8. In this example, there are 6 CDM groups, each CDM group consists of 4 ports, and occupies 4 elements, 2 in the frequency domain with k′=0 and 1; by 2 in the time domain with l′=0 and 1.

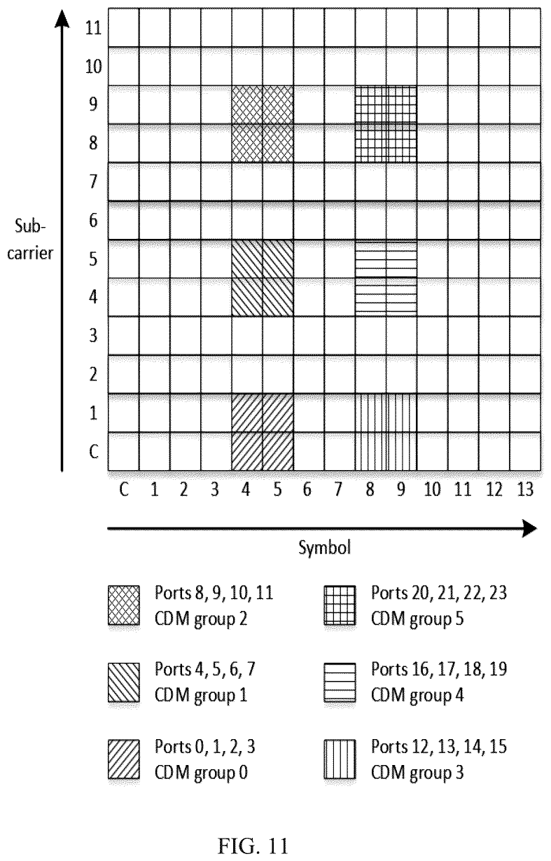

FIG. 11 illustrates an example of a CDM groups and the ports of each CDM group according to embodiments of the present disclosure. This example is for illustration only and other embodiments can be used without departing from the scope of the present disclosure.

The PUSCH DM-RS is mapped to physical resources (resource elements in a DM-RS symbol) according to configuration type 1 or configuration type 2. Rel-18 introduced enhanced DMRS type through higher layer parameter dmrs-TypeEnh, (enhanced DM-RS multiplexing) which doubles the number of antenna ports as illustrated in Table 2.

TABLE 2

| DM-RS | DM-RS | | Support antenna ports \tilde{p} | |
|---|---|---|---|---|
| multiplexing | duration | l′ | Config Type 1 | Config Type 2 |
| Basic (Rel-15) | Single symbol | 0 | 0-3 | 0-5 |
| | Double-symbol | 0, 1 | 0-7 | 0-11 |
| Enhanced (Rel- | Single symbol | 0 | 0-3, 8-11 | 0-5, 12-17 |
| 18) | Double-symbol | 0, 1 | 0-15 | 0-23 |

Configuration type 1 is used when transform precoding is enabled or disabled. Configuration type 2 is used when transform precoding is disabled. Enhanced DM-RS multiplexing is configured when transform precoding is disabled.

PUSCH DM-RS is mapped to resource elements for antenna ports \tilde{p}ⱼ, j=0, 1, . . . , v−1, where v are the number of layers. The DM-RS antenna ports {\tilde{p}₀, \tilde{p}₁, . . . , \tilde{p}ᵥ₋₁} are determined according to the DM-RS port(s) given by the tables in clause 7.3.1.1.2 of TS 38.212. After mapping DM-RS to resource elements for antenna ports \tilde{p}ⱼ, j=0, 1, . . . , v−1, where v are the number of layers, an antenna pre-coding matrix W is applied to transform {\tilde{p}₀, \tilde{p}₁, . . . , \tilde{p}ᵥ₋₁} to {p₀, p₁, . . . pᵥ₋₁}.

### Basic Configuration Type 1:

The mapping of PUSCH DM-RS to resource elements is similar to PDSCH DM-RS configuration type 1.

### Enhanced Configuration Type 1:

$$k = 8 n + 2 {k}^{′} + Δ$$

Where,
   n=0,1, . . .
   k′=0, 1, 2, 3
   Δ=0, for \tilde{p} 0, 1, 4, 5, 8, 9, 12 and 13. Δ=1, for \tilde{p} 2, 3, 6, 7, 10, 11, 14 and 15.

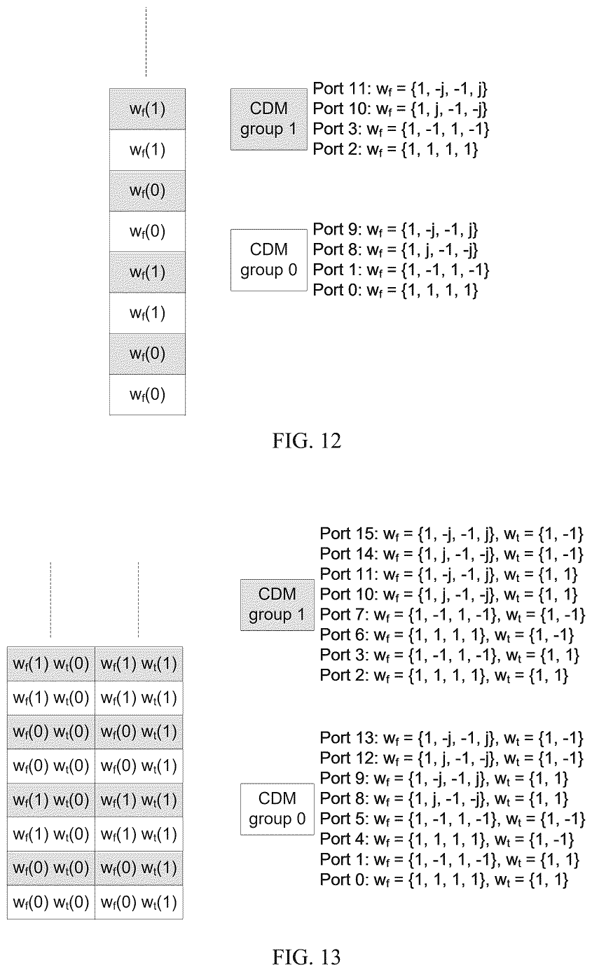

FIG. 12 illustrates an example of a PUSCH DM-RS supporting 8 antenna ports according to embodiments of the present disclosure. FIG. 13 illustrates an example of a PUSCH DM-RS supporting 16 antenna ports according to embodiments of the present disclosure. These examples are for illustration only and other embodiments can be used without departing from the scope of the present disclosure.

With a single DM-RS symbol, the PUSCH DM-RS supports 8 antenna ports, 0-3 and 8-11, as illustrated in FIG. 12. With double DM-RS symbols, the PUSCH DM-RS supports 16 antenna ports, 0-15, as illustrated in FIG. 13. In FIG. 12, antenna ports 0, 1, 8 and 9 are in a same CDM group (i.e., CDM group 0), where the four antenna ports are differentiated by orthogonal codes in the frequency domain. Similarly, in FIG. 12, antenna ports 2, 3, 10 and 11 are in a same CDM group (i.e., CDM group 1), where the four antenna ports are differentiated by orthogonal codes in the frequency domain. In FIG. 13, antenna ports 0, 1, 4, 5, 8, 9, 12 and 13 are in a same CDM group (i.e., CDM group 0), where the eight antenna ports are differentiated by orthogonal codes in the frequency domain and orthogonal codes in the time domain. Similarly, in FIG. 13, antenna ports 2, 3, 6, 7, 10, 11, 14 and 15 are in a same CDM group (i.e., CDM group 1), where the eight antenna ports are differentiated by orthogonal codes in the frequency domain and orthogonal codes in the time domain. Enhanced configuration type 1 is used when transform precoding is not enabled.

### For Configuration Type 2:

The mapping of PUSCH DM-RS to resource elements is similar to PDSCH DM-RS configuration type 2.

### Enhanced Configuration Type 2:

$$k = \{ \begin{matrix}12 n + {k}^{′} + Δ & {k}^{′} = 0 , 1 \\ 12 n + {k}^{′} + Δ & {k}^{′} = 2 , 3\end{matrix}$$

Where,
   n=0,1, . . .
   k′=0, 1, 2, 3
   Δ=0, for \tilde{p} 0, 1, 6, 7, 12, 13, 18 and 19. Δ=2, for \tilde{p} 2, 3, 8, 9, 14, 15, 20 and 21. Δ=4, for \tilde{p} 4, 5, 10, 11, 16, 17, 22 and 23.

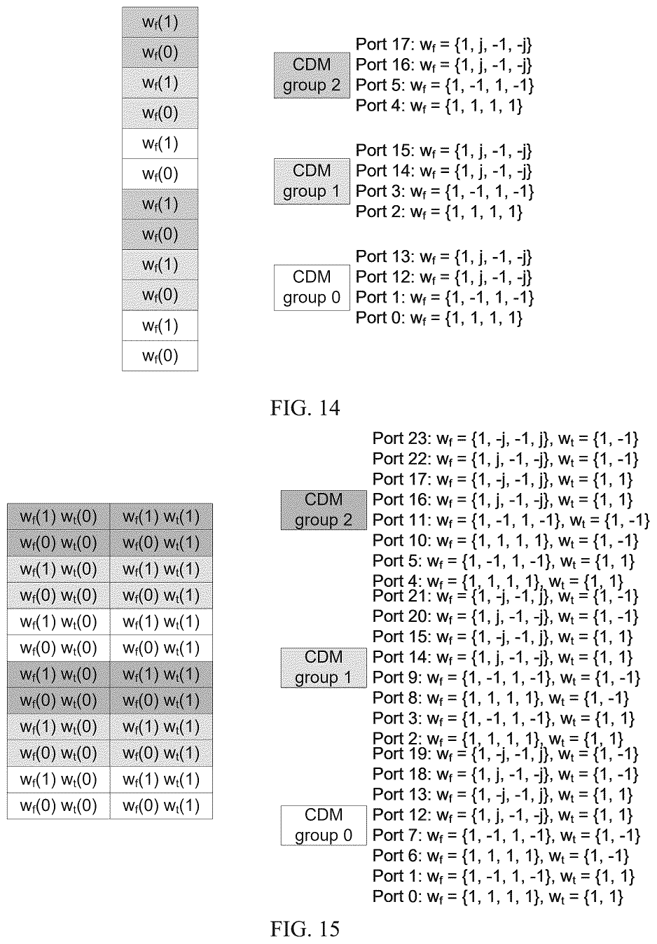

FIG. 14 illustrates an example of a PUSCH DM-RS supporting 12 antenna ports according to embodiments of the present disclosure. FIG. 15 illustrates an example of a PUSCH DM-RS supporting 24 antenna ports according to embodiments of the present disclosure. These examples are for illustration only and other embodiments can be used without departing from the scope of the present disclosure.

With a single DM-RS symbol, the PUSCH DM-RS supports 12 antenna ports, 0-5 and 12-17, as illustrated in FIG. 14. With double DM-RS symbols, the PUSCH DM-RS supports 24 antenna ports 0-23, as illustrated in FIG. 15. In FIG. 14, antenna ports 0, 1, 12 and 13 are in a same CDM group (i.e., CDM group 0), where the four antenna ports are differentiated by orthogonal codes in the frequency domain. Similarly, in FIG. 14 antenna ports 2, 3, 14 and 15 are in a same CDM group (i.e., CDM group 1), where the four antenna ports are differentiated by orthogonal codes in the frequency domain. Similarly, in FIG. 14, antenna ports 4, 5, 16 and 17 are in a same CDM group (i.e., CDM group 2), where the four antenna ports are differentiated by orthogonal codes in the frequency domain. In FIG. 15 antenna ports 0, 1, 6, 7, 12, 13, 18 and 19 are in a same CDM group (i.e., CDM group 0), where the eight antenna ports are differentiated by orthogonal codes in the frequency domain and orthogonal codes in the time domain. Similarly, in FIG. 15, antenna ports 2, 3, 8, 9, 14, 15, 20 and 21 are in a same CDM group (i.e., CDM group 1), where the eight antenna ports are differentiated by orthogonal codes in the frequency domain and orthogonal codes in the time domain. Similarly, in FIG. 15, antenna ports 4, 5, 10, 11, 16, 17, 22 and 23 are in a same CDM group (i.e., CDM group 2), where the eight antenna ports are differentiated by orthogonal codes in the frequency domain and orthogonal codes in the time domain. Enhanced configuration type 2 is used when transform precoding is not enabled.

Sounding reference signal (SRS) is an uplink reference signal that is used for sounding (i.e., channel state or quality estimation) the UL channel between the UE and the BS. In case of reciprocity between UL and DL, the channel sounding of the UL channel can also be used for link adaptation and precoding on the DL channel from the BS to the UE. SRS is transmitted independent of data transmissions on the UL. The SRS usage can be one of: beamManagement, codebook, nonCodebook, antennaSwitching, this is in addition to SRS for positioning. In one example, a signal with structure similar to SRS can be transmitted in the DL direction from the BS to the UE.

In NR, SRS resources are configured by the network, for example as part of RRC setup or RRC reconfiguration. SRS resources are configured in SRS resource sets. An SRS resource set includes a set of SRS resources, and defines the following parameters: (1) resourceType, which determines the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC}, being the transmission comb number, is provided in higher layer IE transmissionComb, K_{TC}∈{2,4,8}. l′ is the SRS symbol within a SRS resource of a slot,

$${l}^{′} ∈ \{ 0 , 1 , ... , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}$$

with

$${n}_{SRS}^{cs}$$

being provided by higher layer in IE transmissionComb

$${n}_{SRS}^{cs , max}$$

depends on K_{TC} as illustrated in Table 3.

TABLE 3

| K_{TC} | n_{SRS}^{cs, max} |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and v∈{0,1}, if 60<N_{ZC}. The base sequence, r̅_{u,v}(n), is generated as follows:
   1. For N_{ZC}∈{6,12,18,24}, r̅_{u,v}(n)=e_{jφ(n)π/4}, with 0≤n<M_{ZC}−1. φ(n) is given by Tables 5.2.2.2-1 to 5.2.2.2-4 of TS 38.211.
   2. For N_{ZC}=30,

$${\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π qm ( m + 1 )}{{N}_{ZC}}} .$$

N_{ZC} is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS}$$

∈{0, 1, . . . , 65535}. Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{µ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{µ} , {l}^{′} ) = ( {\sum }_{m = 0}^{7} c ( 8 ( {n}_{s , f}^{µ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length−31 Gold sequence defined as c(n)=(x₁(n+N_{c})+x₂(n+N_{c}))mod 2, with N_{c}=1600, x₁(n+31)=(x₁(n+3)+x₁(n))mod 2, x₂(n+31)=(x₂(n+3)+x₂(n+2)+x₂(n+1)+x₂(n)) mod 2, the first m-sequence is initialized with x₁(0)=1, and x₁(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{µ} , {l}^{′} ) = 0$$

and

$$v = \{ \begin{matrix}c ( {n}_{s , f}^{µ} {N}_{symb}^{slot} + {l}_{0} + {l}^{′} ) \\ 0\end{matrix} \begin{matrix}{M}_{sc , b}^{SRS} \geq 6 {N}_{SC}^{RB} \\ Otherwise\end{matrix}$$

$${N}_{symb}^{slot}$$

is the number of symbols in a slots, l₀ is the first SRS symbols in the slot, and c(n) a length−31 Gold sequence as previously defined.

The SRS sequence, r^{(p)}(n, l′) is mapped to resource elements

$${a}_{k , l}^{( p )}$$

within a slot, where k is the sub-carrier frequency, l is the symbol number within the slot and p is the antenna port, where for SRS with antenna port p,

$${a}_{k , l}^{( p )}$$

is given by

$${a}_{k , l}^{( p )} = {β}_{SRS} {r}^{( p )} ( {k}^{′} , {l}^{′} )$$

$$l = {l}^{′} + {l}_{0}$$

Where,
β_{SRS} is a scaling factor, k′=0,1, . . . ,

$${M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of TS 38.211, and l′=0,1, . . . ,

$${N}_{symb}^{SRS} - 1.$$

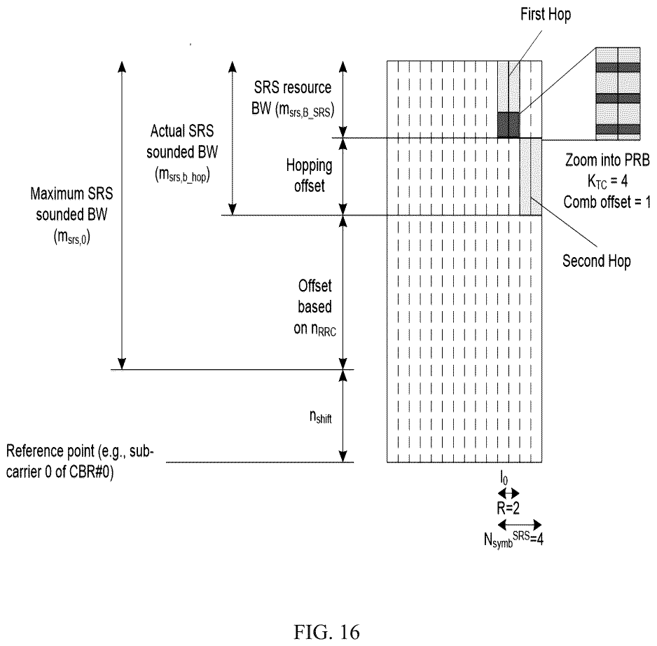

FIG. 16 illustrates an example of a frequency hop within a slot according to embodiments of the present disclosure. This example is for illustration only and other embodiments can be used without departing from the scope of the present disclosure.

The time domain position of SRS symbols l is determined by higher layer parameter startPosition (l₀), and higher layer parameter nrofSymbols

$$( {N}_{symb}^{SRS} ) . l = {l}^{′} + {l}_{0} ,$$

with l₀ the first SRS symbols in the slot, where l₀∈{0, 1, . . . , 13}. The repetition factor R provided by higher layer parameter repetitionFactor provides the number of SRS symbols used for each frequency hop within a slot, when frequency hopping is enabled as described later, where

$$R \leq {N}_{symb}^{SRS} .$$

In the example of FIG. 16, l₀=10, i.e., symbol index 10 is the starting symbol of the SRS, there are 4 SRS symbols in the slot

$${N}_{symb}^{SRS} = 4 ,$$

and the repetition factor R=2, where the SRS is transmitted in two consecutive symbols in each frequency hop.

The frequency domain position of SRS sub-carriers k consists of two components, (1) the comb offset, which determines which of the K_{TC} sub-carriers to use for SRS transmission, (2) the SRS RBs used for SRS transmission, which determines the starting RB and the number of RBs for SRS.

The comb offset, is determined, by higher layer parameter combOffstet. The comb offset can also depend on the SRS antenna port, and for SRS for positioning, on the SRS symbol index within the slot as described in the following. In the example of FIG. 16, K_{TC}=1, with a comb offset of 1. The comb offset is the same in each symbol (e.g., SRS for MIMO).

The SRS RBs are determined by following higher layer parameters:
c-SRS (C_{SRS}) in higher layer parameterfreqHopping. C_{SRS} selects a bandwidth configuration for the SRS resource, corresponding to a row in Table 6.4.1.4.3-1 of TS 38.211. C_{SRS} is in the range of {0, 1, . . . , 63}. The parameter M_{SRS,0} in the selected row determines the maximum SRS bandwidth that can be sounded as illustrated in FIG. 16.
b-SRS (B_{SRS}) in higher layer parameterfreqHopping. B_{SRS} determines the transmission bandwidth of the SRS resource, as illustrated in FIG. 16, based on the selected row of Table 6.4.1.4.3-1 of TS 38.211. B_{SRS} is in the range of {0, 1, 2, 3}, and corresponds to a column in Table 6.4.1.4.3-1 of TS 38.211.
b-hop (bₕₒₚ) in higher layer parameterfreqHopping. bₕₒₚ determines the actual SRS bandwidth that is sounded, using multiple frequency hops, as illustrated in FIG. 16, based on the selected row of Table 6.4.1.4.3-1 of TS 38.211. bₕₒₚ is in the range of {0, 1, 2, 3}, and corresponds to a column in Table 6.4.1.4.3-1 of TS 38.211. If bₕₒₚ<B_{SRS}, frequency hopping is enabled. Otherwise, bₕₒₚ≥B_{SRS}, frequency hopping is disabled, and the actual SRS bandwidth that is sounded is determined by b=min(B_{SRS}, bₕₒₚ) based on the selected row of Table 6.4.1.4.3-1 of TS 38.211.
freqDomainShift (n_{shift}), in units of RBs in the range {0, 1, . . . 268}, adjust the SRS allocation with respect to a reference point as illustrated in FIG. 16. If

$${N}_{BWP}^{start} \leq {n}_{shift}$$

the reference point for

$${k}_{0}^{( p )}$$

is sub-carrier 0 in common resource block (CRB) 0, otherwise the reference point is the lowest subcarrier of the BWP.
freqDomainPosition (n_{RRC}), in units of four RBs in the range {0, 1, . . . 67}, determines the position of the actual SRS bandwidth as illustrated in FIG. 16, based on bₕₒₚ, within the maximum SRS bandwidth, based on m_{SRS,0}.
When SRS frequency hopping enabled, the location of the frequency hop depends on a SRS counter n_{SRS} that counts the number of SRS instances.
   For aperiodic SRS, n_{SRS}=└l′/R┘.
   For periodic and semi-persistent SRS

$${n}_{srs} = ( \frac{{N}_{slot}^{frame , µ} {n}_{f} + {n}_{s , f}^{µ} - {T}_{offset}}{{T}_{SRS}} ) \cdot ( \frac{{N}_{symb}^{SRS}}{R} ) + ⌊ \frac{{l}^{′}}{R} ⌋$$

For slots that satisfy

$$( {N}_{slot}^{frame , μ} {n}_{f} + {n}_{s , f}^{μ} - {T}_{offset} ) mod {T}_{SRS} = 0 \cdot {T}_{SRS}$$

is the SRS periodicity, and T_{offset} is the SRS offset.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , \\ {\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} ,$$

$${k}_{TC}^{( {p}_{i} )} = \{ \begin{matrix}( {\overline{k}}_{TC} + & if {n}_{SRS}^{cs} ∈ \{ \frac{{n}_{SRS}^{cs , max}}{2} , ... , {n}_{SRS}^{cs , max} - \\ {K}_{TC} / 2 ) mod {K}_{TC} & 1 \} and {N}_{ap}^{SRS} = 4 \\ {\overline{k}}_{TC} & otherwise\end{matrix}$$

and pᵢ∈{1001,1003} k̅_{TC} is the transmission comb offset included within higher layer IE transmissionComb, with k̅_{TC}∈{0, 1, . . . , K_{TC}−1},

$${k}_{offset}^{{l}^{′}}$$

is a symbol dependent sub-carrier offset given by Table 4, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is a frequency position index. If frequency hopping is disabled (i.e., bₕₒₚ≥B_{SRS} as aforementioned), n_{b} remains constant and is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of TS 38.211 for the configured value of C_{SRS}.

If frequency hopping is enabled (i.e., bₕₒₚ<B_{SRS} as aforementioned), n_{b} depends on the SRS counter (n_{SRS}) and is given by:

$${n}_{b} = \{ ( \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix} )$$

Where, F_{b}(n_{SRS}) is given by:

$${F}_{b} ( {n}_{SRS} ) = \{ \begin{matrix}( {N}_{b} / 2 ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + & if {N}_{b} is even \\ ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋ & \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} is odd\end{matrix}$$

And where N_{b}_{ₕₒₚ}=1 regardless of the values of N_{b}

TABLE 4
${k}_{offset}^{0} , {k}_{offset}^{1} , ... , {k}_{offset}^{{N}_{symb}^{SRS} - 1}$

| KTC | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
|---|---|---|---|---|---|
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

The SRS resource can be configured as periodic, semi-persistent or aperiodic using higher layer parameter resourceType. For periodic and semi-persistent resources, a periodicity, T_{SRS}, and a slot offset, O, within the periodicity are configured. The allowed values of the periodicity in slots are:

$${T}_{SRS} ∈ \{ 1 , 2 , 4 , 5 , 8 , 10 , 16 , 20 , 32 , 40 , 64 , 80 , 160 , 320 , 640 , 1280 , 2560 \}$$

Every T_{SRS} slots has a candidate SRS slot. The offset O is with respect to slot 0 of frame 0, the allowed values of offset O where O∈{0, 1, . . . , T_{SRS}−1}. Candidate SRS slots are slots satisfying;

$$( {N}_{slot}^{frame , μ} {n}_{f} + {n}_{s , f}^{μ} - {T}_{offset} ) mod {T}_{SRS} = 0.$$

Periodic SRS resources are transmitted in slots determined by the periodicity and offset once the UE receives and processes the RRC configuration message. While semi-persistent SRS resources are activated by an MAC CE activation message, and can be deactivated by a MAC CE deactivation message,

Aperiodic SRS resources are triggered by a DCI command. The UE transmits the SRS in a slot with a configured offset from the slot of the DCI command. The offset can be a value between 1 to 32 slots, where for slot offset 1, the SRS slot is the slot after the slot containing the DCI trigger.

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

In this disclosure, [DEF1] a beam is determined by either of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) or the TCI state ID or the spatial relation ID identifies the beam.

Alternatively, [DEF3] a beam can be determined by a pair [A, B], which is any of:
[A, B]=[TCI state, port]
[A, B]=[TCI state, PG]
[A, B]=[Spatial relation information, port]
[A, B]=[Spatial relation information, PG]

Where TCI state, Spatial relation information, port and PG are as described above. In this case, a pair of IDs for [A, B] identifies the beam.

According to [DEF1], the TCI state and/or the spatial relation reference RS can determine a spatial Rx filter for reception of downlink channels at the UE, or a spatial Tx filter for transmission of uplink channels from the UE. The TCI state and/or the spatial relation reference RS can also determine a spatial Tx filter for transmission of downlink channels from the BS, or a spatial Rx filter for reception of uplink channels at the BS.

Likewise, for [DEF2], the port with dynamic virtualization and/or the PG with dynamic indication of one (or two) ports can determine a spatial Rx filter or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the BS, or a spatial Rx filter or a port or a PG for reception of uplink channels at the BS. In one example, a port can be associated with or indicated by a TCI state.

Likewise, for [DEF3], A and B together can determine a spatial Rx filter for reception of downlink channels at the UE, or a spatial Tx filter for transmission of uplink channels from the UE. They can also determine a spatial Tx filter for transmission of downlink channels from the BS, or a spatial Rx filter for reception of uplink channels at the BS.

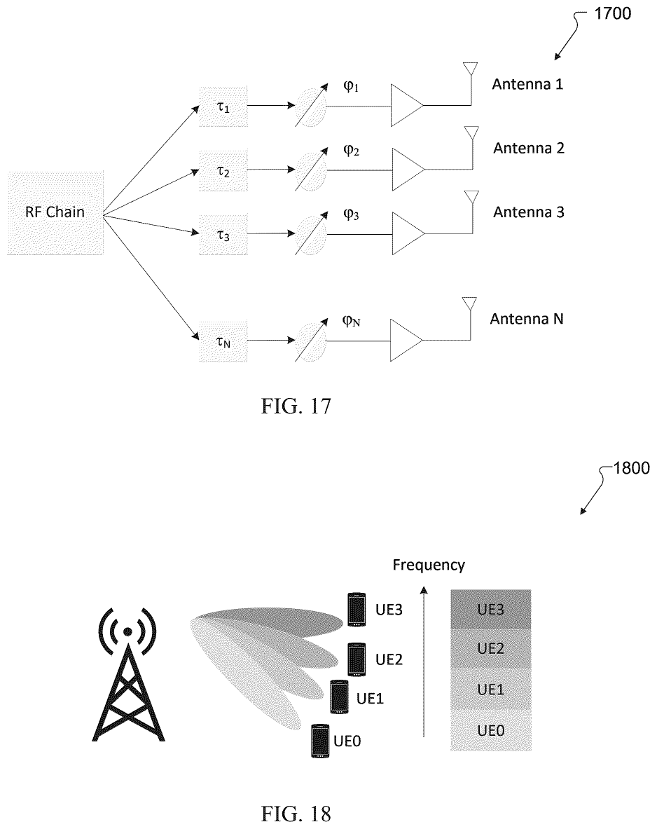

FIG. 17 illustrates an example of a transceiver architecture 1700 with JPTAs according to embodiments of the present disclosure. For example, the transceiver architecture 1700 may be implemented in a base station, such as, BS 102 in FIG. 1. This example is for illustration only and other embodiments can be used without departing from the scope of the present disclosure.

One technique for wireless systems, especially in mmWave is JPTA as illustrated in FIG. 17. The output of the RF chain is split into N paths for the N antennas, where each path includes a True-Time-Delay block (τ₁, τ₂, . . . , τ_{N}) followed by a phase shifter (φ₁, φ₂, φ_{N}) before going to the antenna.

FIG. 18 illustrates an example of JPTA beamforming 1800 in a wireless network 100 according to embodiments of the present disclosure. For example, the JPTA beamforming 1800 may be implemented in a wireless network, such as, wireless network 100 in FIG. 1. This example is for illustration only and other embodiments can be used without departing from the scope of the present disclosure.

As a result of this structure and by properly designing the JPTA parameters, e.g., (τ₁, τ₂, . . . , τ_{N}) and (φ₁, φ₂, φ_{N}), different groups of sub-carriers can have different beams pointing in different directions, as illustrated in FIG. 18. In FIG. 18, using the JPTA structure, the network is able to transmit in M different directions (e.g., M beams) using M different sub-bands, e.g., sub-band i is associated with beam i, wherein, i=0, 1, . . . , M−1. The example, of FIG. 18, M=4 and the transmission is to 4 different UEs. In this disclosure a sub-band can refer to any frequency domain region (e.g., sub-carriers, RBs or sub-channels)

To access the network, a UE monitors and receives synchronization signal/physical broadcast channel (PBCH) Blocks, referred to as SSB blocks. This allows the UE to establish time and frequency synchronization with the network and receive information (e.g., in master information block (MIB)) on the PBCH channel to access the network. In NR, up to 8 different SSBs can be transmitted in FR1 and up to 64 different SSBs can be transmitted in FR2. Each SSB can be associated with a quasi-co-location or a beam. The SSBs are time division multiplexed as described in TS 38.213. The SSBs repeat every time period T. For example, T can be 5 ms, 10 ms, 20 ms, 40 ms, 80 ms, or 160 ms. The period T can be configured by higher layers. In one example, a UE initially accessing the network can assume a default period T, for example the default period can be 20 ms.

With analog-based beamforming, a single beam is used at time t, hence the time division multiplexing of the SSBs that can be using different beams. However, leveraging JPTA, at time t there could be M different sub-bands as illustrated in FIG. 18, each sub-band can be on different beam. Each sub-band can include a different SSB, hence leveraging time-frequency multiplexing of SSBs.

Other multi-antenna architectures that support simultaneous transmissions on multiple beams and/or simultaneous reception on multiple beams can be used.

Rel-17 introduced the unified TCI framework, where a unified or main or indicated TCI state is signaled to the UE. The unified or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and all of dedicated PUCCH resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that can have a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, (Doppler shift, Doppler spread, average delay, delay spread)
Type B, (Doppler shift, Doppler spread)
Type C, (Doppler shift, average delay)
Type D, (Spatial Rx parameter) or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), or a purposed-designed DCI (or channel) for TCI state indication, wherein the DCI format includes a “transmission configuration indication” field that includes/indicates a TCI state code point out of the TCI state code points activated by a MAC CE. A DL related DCI format (or an UL related DCI format or purpose-design DCI or channel) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. Alternatively, a purpose designed DCI Format can be used to indicate a TCI state. A TCI state (TCI state code point) indicated/included in a DL related DCI format or UL related DCI format or a purpose designed DCI Format is applied after a beam application time from the corresponding HARQ-ACK feedback.

In FR2, the UE and BS use narrow beams to communicate with each other, as the UE moves within a cell or as the surrounding environment changes, the UE can move outside the coverage area of a beam used for communication between the UE and the BS, and a new beam can be used for communication between the UE and the BS. Embodiments of the present disclosure provide aspects related to beam tracking as the UE moves or as the channel conditions change.

Wireless mobile network operating in FR2, from 24 GHz to 71 GHz, and FR3, e.g., from 7 (or 7.125) GHz to 24 GHz, rely on beam-based operation for communication between wireless devices, e.g., BS and UE. As aforementioned, a beam is formed by a spatial domain filter that focuses the transmitted signal from a device in a certain direction within a certain beam width. Similarly, for a receiver, a beam or reception spatial domain filter allows the device to receive signals from a certain direction and within a certain beam width. For beam-based operation, a network device (e.g., BS) can transmit DL signals within different spatial domain filters (or beams). For example, the DL signals can be channel state information reference signals (CSI-RS) or Synchronization Signal/Physical Broadcast Channel (SS/PBCH) Blocks, also referred to as SSBs. In one example, DL signals transmitted with different beams can be demodulation reference signals (DM-RS) as described in this disclosure. A receiving device (e.g., UE) measures a quality of the signals transmitted on different beams and provides a measurement report (e.g., UE) to the BS, that includes a one or more resource IDs associated with the DL signals and corresponding quality measurement. The quality can be an absolute quality or a differential quality (e.g., relative to the quality of the first/strongest resource. In one example, the quality can be Layer 1 reference signal received power (L1-RSRP), or Layer 3 RSRP (L3-RSRP). L1-RSRP can be the instantaneous RSRP from one instance of the DL signal. L3-RSRP can be averaged RSRP (e.g., exponential averaging or sliding window) over multiple instances of the DL signal. In this disclosure, the term RSRP is used to refer to L1-RSRP or L3-RSRP. In one example, the quality can be L1 signal-to-interference-and-noise ratio (L1-SINR), or L3-SINR L1-SINR can be the instantaneous SINR from one instance of the DL signal. L3-SINR can be averaged SINR (e.g., exponential averaging or sliding window) over multiple instances of the DL signal. In this disclosure, SINR is used to refer to L1-SINR or L3-SINR. In one example, the quality can be channel quality indicator (CQI). In one example, the quality can be modulation coding (MCS), e.g., MCS to achieve a certain target error rate (e.g., block error rate (BLER)), e.g., 10% BLER. In one example, the quality can be BLER, e.g., BLER for a reference MCS.

Based on the measurement report (e.g., UE report), the network selects a beam and signals the beam (e.g., beam indication) to the UE using a DCI Format or a MAC CE. The beam is signaled as a TCI state ID or TCI state code point. The signal conveying the beam indication is acknowledged, and after signal conveying the acknowledgment by a beam application time (BAT), the beam is applied.

The aforementioned procedure for finding and applying new beams can be slow. The latency of finding and applying a new beam depends on the periodicity of the measurement reference signal and the UE/measurement report. With low-periodicity of measurement reference signals and UE/measurements reports latency can be lowered at the expense of overhead. Alternatively, the measurement reference signals can be event triggered (rather than periodic), the measurement reference signals can be triggered when the channel quality degrades, but this is a reactive procedure leading to longer latencies.

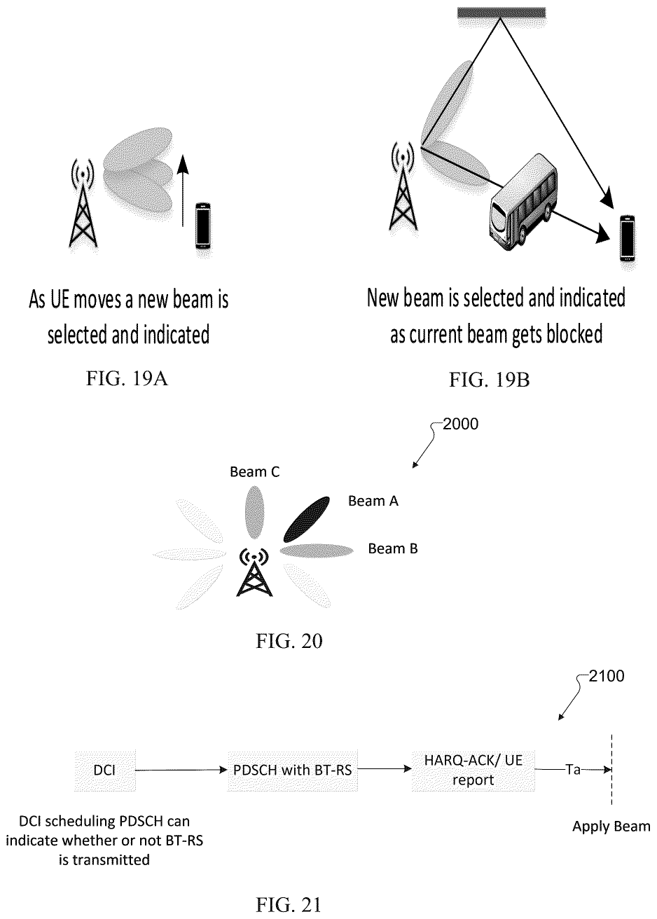

FIGS. 19A and 19B illustrate examples of a beam change due to mobility and channel conditions according to embodiments of the present disclosure. These examples are for illustration only and other embodiments can be used without departing from the scope of the present disclosure.

In FR2, beams can change due to the UE's mobility as illustrated in FIG. 19A, this can apply to the case of mobile communications. As the user's position changes, or due to device rotation, a new and better beam can be selected for communication between the BS and the UE. Beams can also change due to channel in channel conditions, for example, a beam can become blocked, and an alternative beam is used instead as illustrated in FIG. 19B, this can apply to fixed wireless communications as well as mobile communication.

Based on the above discussion, fast identification, indication and application of new beams, e.g., beam tracking would provide a more reliable communication link and better link quality. In this disclosure, methods to improve beam measurement, reporting and indication (e.g., beam tracking) by reducing latency and overhead of measurement signals and UE measurement reports are provided. The procedures discussed in the disclosure, can leverage simultaneous multi-beam operation of device (e.g., BS or UE), by transmitting multiple reference signals simultaneously on different beams. In one example, the reference signals transmitted on multiple beams, can be transmitted with DL data (e.g., PDSCH or PDCCH). In another example, the reference signals transmitted on multiple beams can be transmitted outside of the DL data, e.g., using CSI-RS like structure. In another example, the reference signal can have a physical signal structure similar to the physical signal structure of SRS.

The UE can signal a resource indicator of a preferred DL signal, the resource indicator can be signaled in a UE/measurement report. For example, the UE/measurement report can be sent with HARQ-ACK, and the beam is applied after a beam application time from the UE/measurement report. Alternatively, the beam signaled in a UE/measurement report can be used for subsequent beam indication to the UE.

The present disclosure relates to a 5G/NR and/or 6G communication system.

In this disclosure, the beam tracking reference signals can be transmitted with the DL transmission, the UE can provide with HARQ-ACK feedback an index of the preferred beam tracking reference signal. Alternatively, the UE is configured or indicated a set of beam tracking reference signals to measure, and the UE provides with HARQ-ACK feedback an index of the preferred beam tracking reference signal. This disclosure also provides for report structure and beam application timing aspects for the reported beam.

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, both FDD and TDD are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides for several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or BS) and based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/BS receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/BS receives the source RS, the NW/BS can measure and calculate the needed information to assign a particular DL (or/and UL) TX beam to the UE.

FIG. 20 illustrates an example of a multi-beam system 2000, where each beam can have a set of adjacent or associated beams according to embodiments of the present disclosure. For example, the multi-beam system 2000 may be implemented in a network, such as, wireless network 100 in FIG. 1. This example is for illustration only and other embodiments can be used without departing from the scope of the present disclosure.

In the example, of FIG. 20, beams are shown in 2D, and a beam (e.g., Beam A) has two adjacent beams (e.g., Beam B and Beam C). In 3D a beam can have more adjacent beams. As the UE moves, it is likely to move from a first beam to an adjacent or associated beam, by providing signaling to quickly identify and move to a new beam, system performance improves with fewer beam failures.

Various embodiments of the present disclosure provide for a beam tracking reference signal transmitted with DL transmissions. In one example, the UE can receive one or more reference signals for beam tracking (for brevity referred to as beam tracking reference signal or BT-RS), as explained in this disclosure, with the PDSCH transmission or the PDCCH transmission. In one example, the beam tracking reference signal(s) can be transmitted/received in the symbol(s) used for DM-RS. In one example, the beam tracking reference signal(s) can be transmitted/received in symbol(s) used for beam tracking reference signals with no DM-RS or DL data as described in this disclosure.

FIG. 21 illustrates an example timeline 2100 for scheduling the PDSCH whether to receive beam tracking reference signals according to embodiments of the present disclosure. For example, the timeline 2100 may be utilized for scheduling a UE, such as, UE 116 in FIG. 1. This example is for illustration only and other embodiments can be used without departing from the scope of the present disclosure.

In one example, the UE can be configured by higher layer signaling (e.g., SIB or RRC) whether or not beam tracking reference signals is transmitted with DL channels (e.g., PDSCH or PDCCH). In one example, the UE can be activated (e.g., by MAC CE or L1 control (e.g., DCI Format)), to receive beam tracking reference signal with DL channels (e.g., PDSCH or PDCCH). In one example, the DCI Format is UE specific. In one example, the DCI Format is to a group of UEs (e.g., group common DCI). In one example, for an instance of a PDSCH, the UE can be indicated by L1 control (e.g., DCI Format) scheduling the PDSCH whether or not to receive beam tracking reference signals, as illustrated in FIG. 21. In one example, the UE can be indicated by L1 control (e.g., DCI Format) scheduling the PDSCH the number of resources M for the beam tracking reference signal included in the PDSCH. In one example, in response to a PDSCH with M resources for beam tracking reference signal, the UE can report with a HARQ-ACK feedback, a resource index corresponding to the preferred resources, e.g., as illustrated in FIG. 21. In one example, the resource index reported with HARQ-ACK feedback is of size ┌log₂ M┐. In one example, the resource index reported with HARQ-ACK feedback is of size ┌log₂(M+1)┐, wherein the extra index (e.g., index 0) can be to report no beam change (e.g., current beam of PDSCH or PDCCH or corresponding DMRS is the preferred beam). In one example, after HARQ-ACK report by a beam application time (BAT) Tₐ, the beam corresponding to the indicated resource is applied as described later in this disclosure and indicated in FIG. 21. In one example, the BS sends a signal after the UE report in response to the beam report, after the signal is transmitted by the BS/received by the UE by a time Tₐ, the beam can be applied as described later in this disclosure. In one example, the BS can use the beam indicated by the UE in a UE report for subsequent beam indication, e.g., the beam can be signaled, e.g., as a TCI state or TCI state code point, to the UE in MAC CE activating/indication TCI state(s) or indicated to the UE using a DCI Format conveying a TCI state.

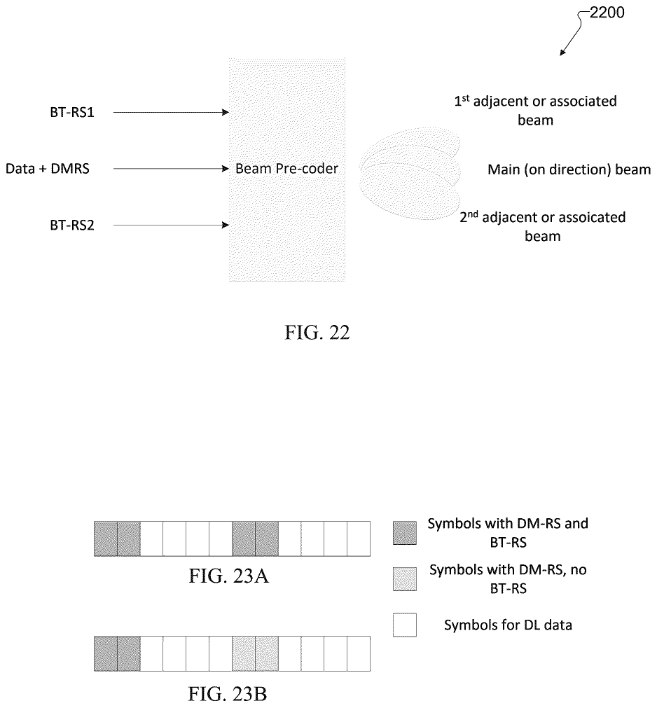

FIG. 22 illustrates an example of beam transmission 2200 for scheduling the PDSCH whether to receive beam tracking reference signals according to embodiments of the present disclosure. For example, the beam transmission 2200 may be implemented by a network device, such as, BS 102 in FIG. 1. This example is for illustration only and other embodiments can be used without departing from the scope of the present disclosure.

In one example, for a DL channel (e.g., PDSCH or PDCCH), the network transmits the DL channel and the demodulation reference signal of the DL channel using an indicated or main beam (an indicated or main spatial domain transmission filter). In addition, the network transmits M beam tracking reference signals (BT-RS) wherein BT-RS i, for i=1, . . . , M, is transmitted using beam or spatial domain transmission filter i associated with the indicated or main beam (or indicated or main spatial domain transmission filter) as illustrated in FIG. 22. The term beam tracking reference signal (BT-RS) is used to described the functionality of the reference signal to be used for beam tracking or identifying new beams as the channel conditions change. The BT-RS transmitted with a DL channel can be configured according to the following examples, as described in this disclosure:
In one example, a DM-RS is configured with N antenna ports, of the N antenna ports N₀ antenna ports follow the spatial domain filter (or beam or TCI state) of the DL channel (e.g., the indicated or main TCI state), N₁ antenna ports use a first spatial domain transmission filter for a first adjacent or associated beam or TCI state, N₂ antenna ports use a second spatial domain transmission filter for a second adjacent or associated beam or TCI state, . . . , N_{M} antenna ports use a Mth spatial domain transmission filter for a Mth adjacent or associated beam or TCI state. In one example, N₀+N₁+N₂ . . . +N_{M}≤N. In one example, N₀+N₁+N₂ . . . +N_{M}=N.
In one example, a DM-RS is configured for BT-RS separate from the DM-RS used for the demodulation of the DL channel. The BT-RS has a physical signal structure similar to DM-RS, but is configured in different resources. In one example, the BT-RS (or DM-RS for beam tracking) can be configured in symbols different from the symbols used for the DM-RS for demodulation. In one example, the BT-RS (or DM-RS for beam tracking) can be configured in resource blocks (RBs) different from the RBs used for the DM-RS for demodulation. In one example, the BT-RS (or DM-RS for beam tracking) can be configured in resource element (REs) different from the REs used for the DM-RS for demodulation. In one example, one DM-RS for beam tracking is configured for M beam tracking reference signals (e.g., different antenna ports are associated with different BT-RS). In one example, K DM-RS for beam tracking are configured for M BT-RS, e.g., each of the M BT-RS is associated with one of the K DM-RS configured for beam tracking. In one example, M DM-RS for beam tracking are configured for M BT-RS, e.g., with a one-to-one association.
In one example, the BT-RS has a physical signal structure similar to CSI-RS. In one example, the BT-RS (or CSI-RS for beam tracking) can be configured in symbols different from the symbols used for the DM-RS for demodulation or data. In one example, the BT-RS (or CSI-RS for beam tracking) can be configured in resource blocks (RBs) different from the RBs used for the DM-RS for demodulation. In one example, the BT-RS (or CSI-RS for beam tracking) can be configured in resource element (REs) different from the REs used for the DM-RS for demodulation. In one example, one CSI-RS for beam tracking is configured for M beam tracking reference signals (e.g., different antenna ports are associated with different BT-RS). In one example, K CSI-RS for beam tracking are configured for M BT-RS, e.g., each of the M BT-RS is associated with one of the K CSI-RS configured for beam tracking. In one example, M CSI-RS for beam tracking are configured for M BT-RS, e.g., with a one-to-one association.

In one example, the BS transmits a first beam tracking reference signals (BT-RS1) and a second beam tracking reference signal (BT-RS2), the receiver, e.g., in the UE measures a first metric from BT-RS1 and a second metric from BT-RS2, and the UE reports to the BS the first metric and the second metric. In one example, the BS can adjust the TCI state or spatial relation or spatial domain transmission filter the BS uses for DL transmissions (e.g., for PDSCH and/or PDCCH) based on the first metric and the second metric, and in case of reciprocity, the adjustment can also apply to the TCI state or spatial relation or spatial domain transmission filter the BS uses for UL transmissions (e.g., UL transmissions following a main or indicated joint TCI state received at the BS). In one example, BT-RS1 is a sum beam (or sum spatial domain filter), e.g., with beam coefficients

$$[ {c}_{0} , {c}_{1} , ... {c}_{\frac{n}{2} - 1} , {c}_{\frac{n}{2}} , {c}_{\frac{n}{2} + 1} , ... , {c}_{n - 1} ] ,$$

and BT-RS2 is a difference beam (or difference spatial domain filter), e.g., with beam coefficients

$$[ {c}_{0} , {c}_{1} , ... {c}_{\frac{n}{2} - 1} , - {c}_{\frac{n}{2}} , - {c}_{\frac{n}{2} + 1} , ... , - {c}_{n - 1} ] .$$

In a variant example, the first metric is measured using the DM-RS (e.g., using the main or indicated TCI state) and the second metric is measured using a BT-RS. In one example, the beam (or spatial domain filter) of the DM-RS is the sum beam, and the beam (or spatial domain filter) of the BT-RS is the difference beam. In a variant example, of the aforementioned examples, the BS determines a TCI state or spatial relation based on the first metric and the second metric, and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the first metric and the second metric, and the UE signals the TCI state or the spatial relation to the BS for the BS and/or UE to use for DL transmissions and in case of reciprocity for UL transmissions (e.g., UL transmissions following a main or indicated joint TCI state).

In one example, the BS transmits a first beam tracking reference signals (BT-RS1) and a second beam tracking reference signal (BT-RS2), the receiver, e.g., in the UE measures a first metric from BT-RS1 and a second metric from BT-RS2, the UE calculates a quantity based on the first metric and the second metric, and the UE reports the quantity to the BS.

In one example, the BS can adjust the TCI state or spatial relation, or spatial domain transmission filter the BS uses for DL transmissions (e.g., for PDSCH and/or PDCCH) based on the quantity, and in case of reciprocity, the adjustment can also apply to the TCI state or spatial relation or spatial domain transmission filter the UE uses for UL transmissions (e.g., UL transmissions following a main or indicated joint TCI state). In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and BT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the DM-RS (e.g., using the main or indicated TCI state) and the second metric is measured using a BT-RS. In one example, the beam (or spatial domain filter) of the DM-RS is the sum beam, and the beam (or spatial domain filter) of the BT-RS is the difference beam. In a variant example, of the aforementioned examples, the BS determines a TCI state or spatial relation based on the quantity (from the first metric and the second metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the quantity (from the first metric and the second metric), and the UE signals the TCI state or the spatial relation to the BS for the BS and/or UE to use for DL transmissions and in case of reciprocity for UL transmissions (e.g., UL transmissions following a main or indicated joint TCI state).

In one example, the BS transmits a first beam tracking reference signals (BT-RS1), a second beam tracking reference signal (BT-RS2), and a third beam tracking reference signal (BT-RS3) the receiver, e.g., in the UE measures a first metric from BT-RS1, a second metric from BT-RS2, and a third metric from BT-RS3 and the UE reports to the BS (base station) the first metric, the second metric and the third metric. In one example, the BS can adjust the TCI state or spatial relation or spatial domain transmission filter the BS uses for DL transmissions (e.g., for PDSCH and/or PDCCH) based on the first metric, the second metric and/or the third metric, and in case of reciprocity, the adjustment can also apply to the TCI state or spatial relation or spatial domain transmission filter the BS uses for UL transmissions (e.g., UL transmissions following a main or indicated joint TCI state received at the BS).
In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, BT-RS2 is a difference beam (or difference spatial domain filter) in the first dimension (e.g., azimuth), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

and
In one example, BT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the DM-RS (e.g., using the main or indicated TCI state) (e.g., DM-RS is used as BT-RS1) and the second metric and the third metric are measured using a BT-RS (e.g., BT-RS2 and BT-RS3). In one example, the beam (or spatial domain filter) of the DM-RS is the sum beam, and the beam (or spatial domain filter) of the BT-RS2 is the difference beam in the first dimension (e.g., azimuth), and the beam (or spatial domain filter) of the BT-RS3 is the difference beam in the second dimension (e.g., zenith). In a variant example, of the aforementioned examples, the BS determines a TCI state or spatial relation based on the first metric, the second metric and/or the third metric, and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the first metric, the second metric and/or the third metric, and the UE signals the TCI state or the spatial relation to the BS for the BS and/or UE to use for DL transmissions and in case of reciprocity for UL transmissions (e.g., UL transmissions following a main or indicated joint TCI state).

In one example, the BS transmits a first beam tracking reference signals (BT-RS1), a second beam tracking reference signal (BT-RS2) and a third beam tracking reference signal (BT-RS3), the receiver, e.g., in the UE measures a first metric from BT-RS1, a second metric from BT-RS2 and a third metric from BT-RS3. In one example, the UE calculates a quantity(s) based on the first metric, the second metric and/or the third metric, and the UE reports the quantity(s) to the BS. In one example, the UE calculates a first quantity based on the first metric and the second metric, and the UE calculates a second quantity based on the first metric and the third metric, and the UE reports the first quantity and the second quantity to the BS. In one example, the BS can adjust the TCI state or spatial relation, or spatial domain transmission filter the UE uses for DL transmissions (e.g., for PDSCH and/or PDCCH) based on the quantity or quantities, and in case of reciprocity, the adjustment can also apply to the TCI state or spatial relation or spatial domain transmission filter the UE uses for UL transmissions (e.g., UL transmissions following a main or indicated joint TCI state). In one example,
In one example, BT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, BT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

in the first dimension (e.g., azimuth), in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

and
In one example, BT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the DM-RS (e.g., using the main or indicated TCI state) (e.g., DM-RS is used as BT-RS1) and the second metric and the third metric are measured using a BT-RS (e.g., BT-RS2 and BT-RS3). In one example, the beam (or spatial domain filter) of the DM-RS is the sum beam, and the beam (or spatial domain filter) of the BT-RS2 is the difference beam in the first dimension (e.g., azimuth), and the beam (or spatial domain filter) of the BT-RS3 is the difference beam in the second dimension (e.g., zenith). In a variant example, of the aforementioned examples, the BS determines a TCI state or spatial relation based on the quantity(s) (from the first metric, the second metric and/or the third metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the BS determines a TCI state or spatial relation based on a first quantity (from the first metric and the second metric), and a second quantity (from the first metric and the third metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the quantity(s) (from the first metric and/or the second metric and/or the third metric), and the UE signals the TCI state or the spatial relation to the BS for the BS and/or UE to use for DL transmissions and in case of reciprocity for UL transmissions (e.g., UL transmissions following a main or indicated joint TCI state).

Various embodiments of the present disclosure provide for mapping BT-RS to REs or RBs or Symbols of a DL transmission. In one example, DM-RS using the main spatial domain transmission has N-ports. In one example, a BT-RS using an adjacent or associated spatial domain transmission filter has one port. In one example, a BT-RS using an adjacent or associated spatial domain transmission filter has two ports. In one example, a BT-RS using an adjacent or associated spatial domain transmission filter has N-ports.

FIGS. 23A-25D illustrate examples of DM-RS configurations according to according to embodiments of the present disclosure. For example, the DM-RS configurations may be utilized by a UE, such as, UE 116 in FIG. 1. These examples are for illustration only and other embodiments can be used without departing from the scope of the present disclosure.

In one example, the DM-RS and the BT-RS are multiplexed in a same symbol or in a same group of symbols. In one example, for a DM-RS configuration, the DM-RS for demodulation (also referred to as DM-RS for brevity) uses one or more CDM groups of the DM-RS configuration, and the DM-RS for beam tracking (also referred to as BT-RS for brevity) uses a second one of the CDM groups as illustrated in FIGS. 23A-25D.

As illustrated in FIG. 23A, a symbol can have DM-RS and BT-RS, for example, a first antenna port(s) or a first CDM group(s) or a first set of RE(s) or a first set of RB(s) is used for DM-RS, and a second antenna port(s) or a second CDM group(s) or a second set of RE(s) or a second set of RB(s) is used for BT-RS. The mapping of CDM groups to REs can be as described in this disclosure. In addition to DM-RS/BT-RS symbol(s), there are symbols for DL data transmission (e.g., for transmitting the encoded and modulated DL-SCH). In a variant example, DL data can be transmitted in unused CDM groups or unused REs of the DM-RS/BT-RS symbol(s). In a variant example, when the BT-RS is in the same symbol as the DM-RS, but uses different RBs, the BT-RS can have a physical signal structure similar to the CSI-RS.

As illustrated in FIG. 23B, a symbol can have DM-RS and BT-RS, for example, a first antenna port(s) or a first CDM group(s) or a first set of RE(s) or a first set of RB(s) is used for DM-RS, and a second antenna port(s) or a second CDM group(s) or a second set of RE(s) or a second set of RB(s) is used for BT-RS. The mapping of CDM groups to REs can be as described in this disclosure. In addition, a symbol can have DM-RS with no BT-RS. In addition to DM-RS for demodulation/BT-RS symbol(s) and DM-RS symbol(s), there are symbols for DL data transmission (e.g., for transmitting the encoded and modulated DL-SCH). In a variant example, DL data can be transmitted in unused CDM groups or unused REs of the DM-RS/BT-RS symbol(s) and/or the DM-RS symbol(s). In a variant example, when the BT-RS is in the same symbol as the DM-RS, but uses different RBs, the BT-RS can have a physical signal structure similar to the CSI-RS.

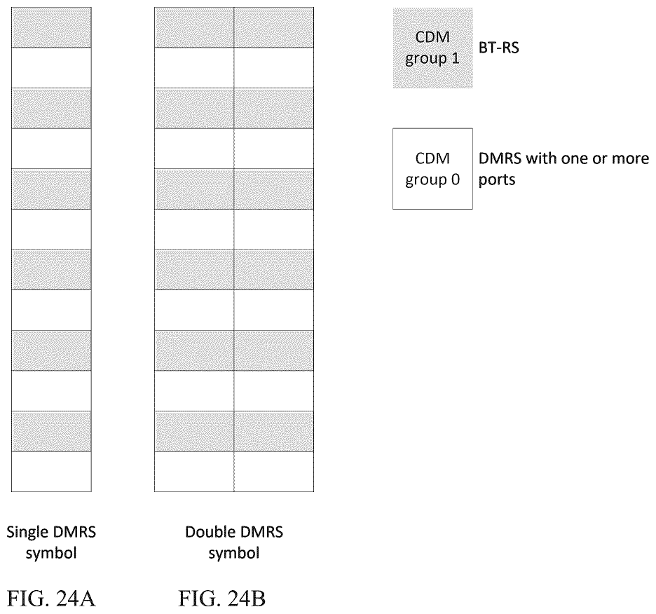

As illustrated in FIG. 24A, with DM-RS configuration type 1, a single DM-RS symbol is used. In one example, CDM group 0 can be used for DM-RS, in this example, the DM-RS can be a single port DMRS or a two-port DM-RS. In one example, CDM group 1 can be used for BT-RS, in one example a two-port BT-RS is transmitted in CDM group 1, in one example, two one-port BT-RS are transmitted in CDM group 1. In one example a one-port BT-RS is transmitted in CDM group 1.

As illustrated in FIG. 24B, with DM-RS configuration type 1, double DM-RS symbols are used. In one example, CDM group 0 can be used for DM-RS, in this example, the DM-RS can be a single port DMRS or a two-port DM-RS or a three-port DM-RS or a four-port DM-RS. In one example, CDM group 1 can be used for BT-RS, in one example two two-port BT-RS are transmitted in CDM group 1, in one example, four one-port BT-RS are transmitted in CDM group 1, in one example, one two-port BT-RS and two one-port BT-RS are transmitted in CDM group 1, in one example one four-port BT-RS is transmitted in CDM group 1. In one example one or two one-port BT-RS are transmitted in CDM group 1.

In one example, of the aforementioned examples, a CDM group used for BT-RS is associated with one BT-RS. In one example, of the aforementioned examples, a CDM group used for BT-RS can be associated with more than one BT-RS.

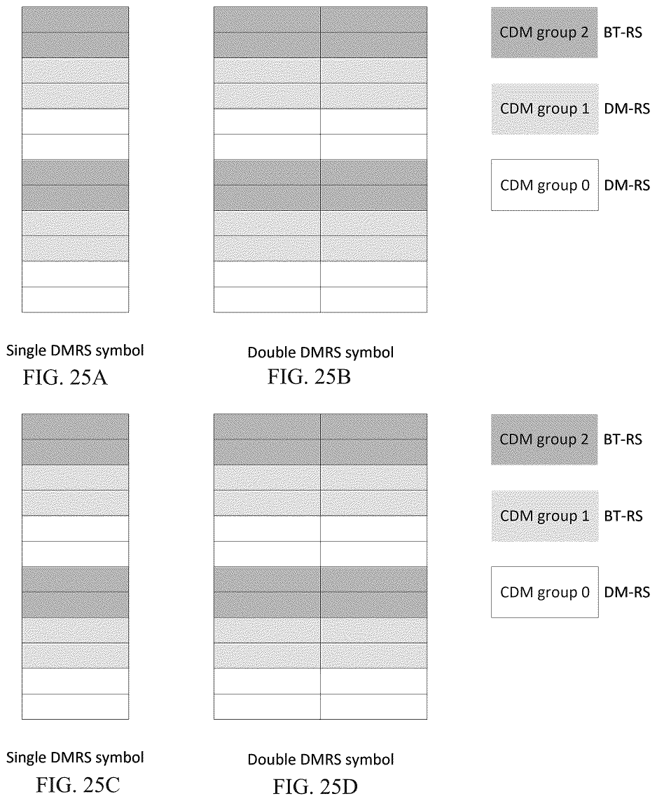

As illustrated in FIG. 25A, with DM-RS configuration type 2, a single DM-RS symbol is used. In one example, CDM group 0 and CDM group 1 can be used for DM-RS, in this example, the DM-RS can have a number of DM-RS varying from one DM-RS port to 4 DM-RS ports. In one example, CDM group 2 can be used for BT-RS, in one example a two-port BT-RS is transmitted in CDM group 2, in one example, two one-port BT-RS are transmitted in CDM group 2. In one example a one-port BT-RS is transmitted in CDM group 2.

As illustrated in FIG. 25B, with DM-RS configuration type 2, double DM-RS symbols are used. In one example, CDM group 0 and CDM group 1 can be used for DM-RS, in this example, the DM-RS can have a number of DM-RS varying from one DM-RS port to 8 DM-RS ports. In one example, CDM group 2 can be used for BT-RS, in one example two two-port BT-RS are transmitted in CDM group 2, in one example, four one-port BT-RS are transmitted in CDM group 2, in one example, one two-port BT-RS and two one-port BT-RS are transmitted in CDM group 2, in one example one four-port BT-RS is transmitted in CDM group 2. In one example one or two one-port BT-RS are transmitted in CDM group 2.

As illustrated in FIG. 25C, with DM-RS configuration type 2, a single DM-RS symbol is used. In one example, CDM group 0 can be used for DM-RS, in this example, the DM-RS can have a number of DM-RS varying from one DM-RS port to 2 DM-RS ports. In one example, CDM group 1 and CDM group 2 can be used for BT-RS, in one example two two-port BT-RS are transmitted in CDM group 1 and CDM group 2, in one example, four one-port BT-RS are transmitted in CDM group 1 and CDM group 2, in one example, one two-port BT-RS and two one-port BT-RS are transmitted in CDM group 1 and CDM group 2, in one example one four-port BT-RS is transmitted in CDM group 1 and CDM group 2. In one example, one one-port BT-RS is transmitted in each of CDM group 1 and CDM group 2.

As illustrated in FIG. 25D, with DM-RS configuration type 2, double DM-RS symbols are used. In one example, CDM group 0 can be used for DM-RS, in this example, the DM-RS can have a number of DM-RS ports varying from one DM-RS port to 4 DM-RS ports. In one example, CDM group 1 and CDM group 2 can be used for BT-RS, in one example four two-port BT-RS are transmitted in CDM group 1 and CDM group 2, in one example, eight one-port BT-RS are transmitted in CDM group 1 and CDM group 2, in one example, a combination of p₂ two-port BT-RS and p₁ one-port BT-RS are transmitted in CDM group 1 and CDM group 2 such that p₁+2p₂≤8, in one example two four-port BT-RS are transmitted in CDM group 1 and CDM group 2. In one example, one or two one-port BT-RS is transmitted in each of CDM group 1 and CDM group 2.

In one example, of the aforementioned examples, a CDM group used for BT-RS is associated with one BT-RS. In one example, of the aforementioned examples, a CDM group used for BT-RS can be associated with more than one BT-RS.

In one example, in symbols with reference signal (e.g., DM-RS/BT-RS symbols or BT-RS symbols) used in DL channel transmission (e.g., for PDSCH transmission), a first set of RBs are allocated to DM-RS (for symbols with DM-RS), and a second set of RBs are allocated to BT-RS.
In one example, the RBs allocated to DM-RS can be configured with CDM groups and antenna ports according to configuration type 1 and configuration type 2 as aforementioned.
In one example, the RBs allocated to BT-RS can be configured with CDM groups and antenna ports according to configuration type 1 and configuration type 2 as aforementioned. In one example, a BT-RS on an adjacent beam (or spatial domain filter) can be allocated one or two ports or more ports in a CDM group. In one example, a CDM group is used for one BT-RS. In one example, a CDM group can be used for more than one BT-RS.
In one example, the REs of RBs allocated to BT-RS can be divided into groups, wherein a group of REs is associated with a BT-RS. For example, the first group of REs are associated, with a first BT-RS, the second group of REs are associated with a second BT-RS and so on. In one example, the REs in a RB associated with a BT-RS can be contiguous. In one example, the REs in a RB associated with a BT-RS can be non-contiguous.
In one example, the RBs allocated to BT-RS can be divided into groups, wherein a group of RBs is associated with a BT-RS. For example, the first group of RBs are associated with a first BT-RS, the second group of RBs are associated with a second BT-RS and so on. In one example, the RBs associated with a BT-RS can be contiguous. In one example, the RBs associated with a BT-RS can be non-contiguous.

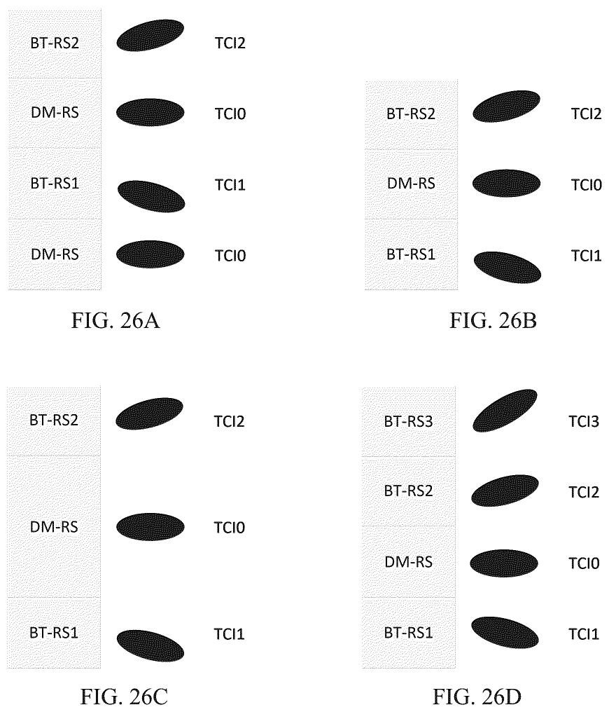

FIGS. 26A-26D illustrate examples of allocating contiguous REs or contiguous RBs to different types of reference signals according to embodiments of the present disclosure. For example, the allocations may be utilized by a UE, such as, UE 116 in FIG. 1. These examples are for illustration only and other embodiments can be used without departing from the scope of the present disclosure.

As illustrated in FIG. 26A, the frequency allocation is split in to 4 equal or near equal frequency bands. In DM-RS/BT-RS symbols, frequency band 0 and frequency band 2 are allocated to DM-RS using TCI state 0 or spatial domain filter 0, frequency band 1 is allocated to BT-RS1 and uses TCI state 1 or spatial domain filter 1, and frequency band 3 is allocated to BT-RS2 and uses TCI state 2 or spatial domain filter 2. In a variant example, as illustrated in FIG. 26B, the bands for DM-RS are contiguous bands, for example, frequency band 0 is allocated to BT-RS1 and uses TCI state 1 or spatial domain filter 1, frequency band 1 and frequency band 2 are allocated to DM-RS and uses TCI state 0 or spatial domain filter 0, frequency band 3 is allocated to BT-RS2 and uses TCI state 2 or spatial domain filter 2.

In yet another example, the frequency allocation is split in frequency bands that can be of unequal size, for example as illustrated in FIG. 26C for the DM-RS/BT-RS symbol, frequency band 1 is larger than frequency band 0 and frequency band 2. Frequency band 0 is allocated to BT-RS1 and uses TCI state 1 or spatial domain filter 1, frequency band 1 is allocated to DM-RS and uses TCI state 0 or spatial domain filter 0, and frequency band 2 is allocated to BT-RS2, and uses TCI state 2 or spatial domain filter 2.

In yet another example, the frequency allocation is split in to 4 equal or near equal frequency bands as illustrated in FIG. 26D for the DM-RS/BT-RS symbol. Frequency band 0 is allocated to BT-RS1 and uses TCI state 1 or spatial domain filter 1, frequency band 1 is allocated to DM-RS and uses TCI state 0 or spatial domain filter 0, frequency band 2 is allocated to BT-RS2, and uses TCI state 2 or spatial domain filter 2, and frequency band 3 is allocated to BT-RS3, and uses TCI state 3 or spatial domain filter 3.

In a variant of the aforementioned examples, the number of frequency bands can be N. In one example, N=2, e.g., a DM-RS and BT-RS are allocated to an OFDM symbol.

In one example of the aforementioned examples of FIGS. 26A-26D, the BT-RS can have a physical signal structure similar to the physical signal structure of DM-RS. In another example of the aforementioned examples of FIGS. 26A-26D, the BT-RS can have a physical signal structure similar to the physical signal structure of CSI-RS. In another example of FIGS. 26A-26D, the BT-RS can have a physical signal structure similar to the physical signal structure of SRS.

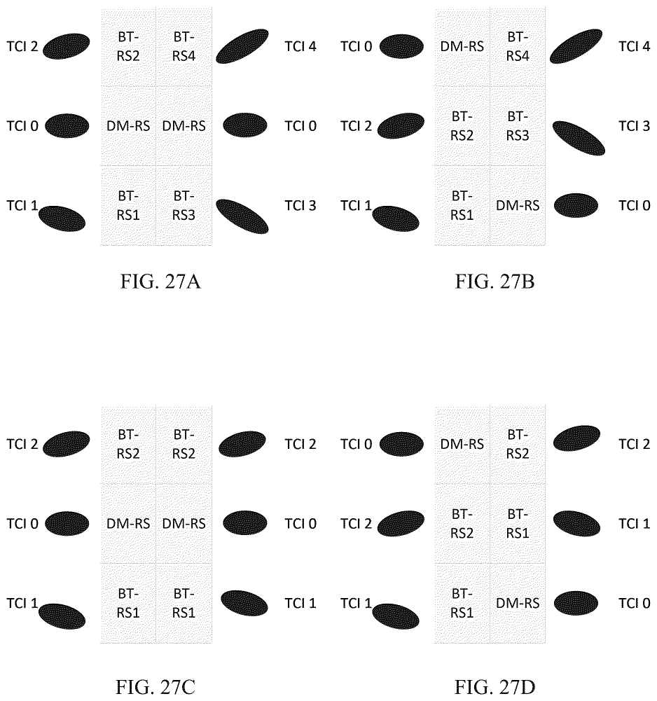

FIGS. 27A-27D illustrate examples of allocating REs or RBs to different types of reference signals according to embodiments of the present disclosure. For example, the allocations may be utilized by a UE, such as, UE 116 in FIG. 1. These examples are for illustration only and other embodiments can be used without departing from the scope of the present disclosure.

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein different BT-RS can be allocated to different DM-RS/BT-RS as illustrated in FIG. 27A:
In one example, frequency band 0 is allocated to BT-RS1 in DM-RS/BT-RS symbol 0 and frequency band 0 is allocated to BT-RS3 in DM-RS/BT-RS symbol 1.
In one example, frequency band 1 is allocated to DM-RS in DM-RS/BT-RS symbol 0 and DM-RS/BT-RS symbol 1, in this example, there is no frequency hopping of DM-RS between symbols.
In one example, frequency band 2 is allocated to BT-RS2 in DM-RS/BT-RS symbol 0 and frequency band 0 is allocated to BT-RS4 in DM-RS/BT-RS symbol 1.
In a variant example, the same BT-RS can be repeated in both DM-RS/BT-RS symbols without or with frequency hopping.

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein different BT-RS can be allocated to different DM-RS/BT-RS, with frequency hopping of DM-RS as illustrated in FIG. 27B:
In one example, frequency band 0 is allocated to BT-RS1 in DM-RS/BT-RS symbol 0 and frequency band 0 is allocated to DM-RS in DM-RS/BT-RS symbol 1.
In one example, frequency band 1 is allocated to BT-RS2 in DM-RS/BT-RS symbol 0 and frequency band 1 is allocated to BT-RS3 in DM-RS/BT-RS symbol 1.
In one example, frequency band 2 is allocated to DM-RS in DM-RS/BT-RS symbol 0 and frequency band 0 is allocated to BT-RS4 in DM-RS/BT-RS symbol 1.
In a variant example, the same BT-RS can be repeated in both DM-RS/BT-RS symbols with or without frequency hopping

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein same BT-RS can be allocated to different DM-RS/BT-RS without frequency hopping as illustrated in FIG. 27C:
In one example, frequency band 0 is allocated to BT-RS1 in DM-RS/BT-RS symbol 0 and DM-RS/BT-RS symbol 1.
In one example, frequency band 1 is allocated to DM-RS in DM-RS/BT-RS symbol 0 and DM-RS/BT-RS symbol 1.
In one example, frequency band 2 is allocated to BT-RS2 in DM-RS/BT-RS symbol 0 and DM-RS/BT-RS symbol 1.

In yet another example, there are two DM-RS/BT-RS symbols. In one example, the DM-RS/BT-RS symbols are consecutive. In one example, DM-RS/BT-RS symbols are non-consecutive. In one example, the frequency allocation of each DM-RS/BT-RS symbol is split into three frequency bands, wherein same BT-RS can be allocated to different DM-RS/BT-RS, with frequency hopping of DM-RS and BT-RS as illustrated in FIG. 27D:
In one example, frequency band 0 is allocated to BT-RS1 in DM-RS/BT-RS symbol 0 and frequency band 0 is allocated to DM-RS in DM-RS/BT-RS symbol 1.
In one example, frequency band 1 is allocated to BT-RS2 in DM-RS/BT-RS symbol 0 and frequency band 1 is allocated to BT-RS1 in DM-RS/BT-RS symbol 1.
In one example, frequency band 2 is allocated to DM-RS in DM-RS/BT-RS symbol 0 and frequency band 0 is allocated to BT-RS2 in DM-RS/BT-RS symbol 1.

In a variant of the aforementioned examples, the number of frequency bands can be N. In one example, N=2, e.g., a DM-RS and BT-RS are allocated to an OFDM symbol.

In the aforementioned mentioned: DM-RS uses TCI state 0 or spatial domain filter 0 or spatial relation 0, BT-RS1 uses TCI state 1 or spatial domain filter 1 or spatial relation 1, BT-RS2 uses TCI state 2 or spatial domain filter 2 or spatial relation 2, BT-RS3 uses TCI state 3 or spatial domain filter 3 or spatial relation 3, and BT-RS4 uses TCI state 4 or spatial domain filter 4 or spatial relation 4.

In one example of the aforementioned examples of FIGS. 27A-27D, the BT-RS can have a physical signal structure similar to the physical signal structure of DM-RS. In another example of the aforementioned examples of FIGS. 27A-27D, the BT-RS can have a physical signal structure similar to the physical signal structure of CSI-RS. In another example of FIGS. 27A-27D, the BT-RS can have a physical signal structure similar to the physical signal structure of SRS.

In one example, within respective frequency bands, one or more CDM groups are used for respective DM-RS or respective BT-RS. In one example, in addition to the DM-RS/BT-RS symbols, there is one or more DM-RS symbols wherein the entire frequency allocation of the DM-RS symbol is used for DM-RS, wherein TCI state 0 or spatial domain filter 0 or spatial relation 0 is used. In one example, for symbols used for data transmission (e.g., for transmitting the encoded and modulated DL-SCH), TCI state 0 or spatial domain filter 0 or spatial relation 0 is used. In the aforementioned, example, TCI state 0 or spatial domain filter 0 or spatial relation 0, is the TCI state or spatial relation of the main beam. TCI state 1 . . . M, or spatial domain filter 1 . . . M or spatial relation 1 . . . M, is the TCI state or spatial domain filter or spatial relation of the 1^{st}, . . . M^{th} beam respectively.

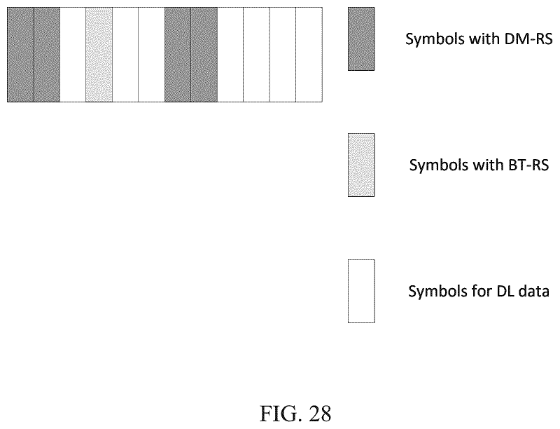

FIG. 28 illustrates an example of transmission of different types of RSs in symbols of a DL channel according to embodiments of the present disclosure. For example, the RSs may be received by a UE, such as, UE 116 in FIG. 1. This example is for illustration only and other embodiments can be used without departing from the scope of the present disclosure.

In one example, the DM-RS and the BT-RS associated with a DL channel (e.g., PDSCH) are transmitted (or multiplexed) in different symbols or in different groups of symbols as illustrated in FIG. 28. In one example of FIG. 28, the BT-RS can have a physical signal structure similar to the physical signal structure of DM-RS as described in the following. In another example of FIG. 28, the BT-RS can have a physical signal structure similar to the physical signal structure of CSI-RS as described later in this disclosure. In another example of FIG. 28, the BT-RS can have a physical signal structure similar to the physical signal structure of SRS.

In FIG. 28, a first one or more symbols or groups of symbols in a DL channel allocation can have DM-RS (e.g., DM-RS used for demodulation). A second one or more symbols or groups of symbols in a DL channel (e.g., PDSCH) allocation can have BT-RS (e.g., DM-RS configured for tracking, alternatively, the BT-RS can be CSI-RS configured for beam tracking as described layer in this disclosure). A third one or more symbols are symbols for DL data transmission (e.g., for transmitting the encoded and modulated DL-SCH). In a variant example, DL data can be transmitted in unused CDM groups or unused REs of the DM-RS symbol(s) and/or in unused CDM groups or unused REs of BT-RS symbol(s).

In one example, the symbol(s) or group(s) of symbols allocated to DM-RS can be configured with CDM groups and antenna ports according to configuration type 1 and configuration type 2 as aforementioned.

In one example, the symbol(s) or group(s) of symbols allocated to BT-RS can be configured with CDM groups and antenna ports according to configuration type 1 and configuration type 2 as aforementioned. In one example, a BT-RS on an adjacent beam (or spatial domain filter) can be allocated one or two ports or more ports in a CDM group. In one example, a CDM group is used for one BT-RS. In one example, a CDM group can be used for more than one BT-RS.

In one example, the REs of the symbol(s) or group(s) of symbols allocated to BT-RS can be divided into groups, wherein a group of REs is associated with a BT-RS. For example, the first group of REs are associated, with a first BT-RS, the second group of REs are associated with a second BT-RS and so on. In one example, the REs in a symbol or group of symbols associated with a BT-RS can be contiguous. In one example, the REs in a symbol or group of symbols associated with a BT-RS can be non-contiguous. In one example, the REs in a RB of a symbol or group of symbols associated with a BT-RS can be contiguous. In one example, the REs in a RB of a symbol or group of symbols associated with a BT-RS can be non-contiguous.

In one example, the RBs of the symbol(s) or group(s) of symbols allocated to BT-RS can be divided into groups, wherein a group of RBs is associated with a BT-RS. For example, the first group of RBs are associated with a first BT-RS, the second group of RBs are associated with a second BT-RS and so on. In one example, the RBs in a symbol or group of symbols associated with a BT-RS can be contiguous. In one example, the RBs in a symbol or group of symbols associated with a BT-RS can be non-contiguous.

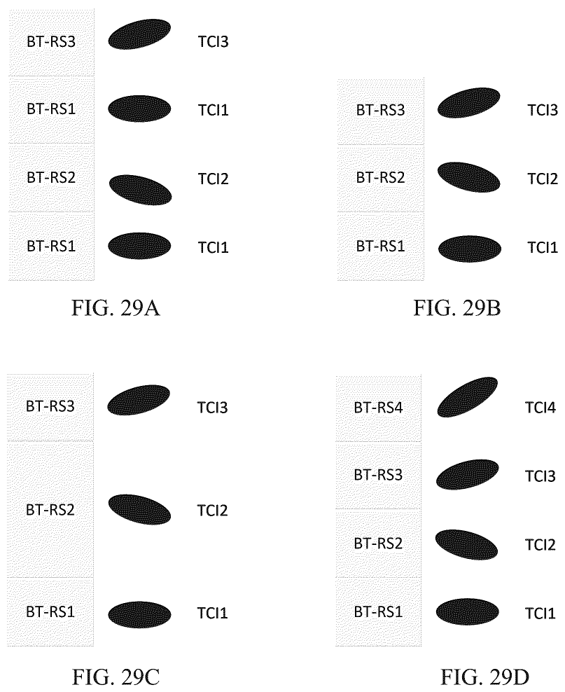

FIGS. 29A-29D illustrate examples of allocating contiguous REs or contiguous RBs to different BT-RS according to embodiments of the present disclosure. For example, the allocations may be utilized by a UE, such as, UE 116 in FIG. 1. These examples are for illustration only and other embodiments can be used without departing from the scope of the present disclosure.

In one example, a BT-RS is allocated a one frequency band. In one example, a BT-RS can be allocated multiple frequency bands. In one example, different BT-RS are allocated the same number of frequency bands. In one example, different BT-RS can be allocated different number of frequency bands. In FIG. 29A, the frequency allocation is split in to 4 equal or near equal frequency bands. In BT-RS symbols, frequency band 0 and frequency band 2 are allocated to BT-RS1 using TCI state 1 or spatial domain filter 1, frequency band 1 is allocated to BT-RS2 and uses TCI state 2 or spatial domain filter 2 and frequency band 3 is allocated to BT-RS3 and uses TCI state 3 or spatial domain filter 3. In a variant example, as illustrated in FIG. 29B, the bands for BT-RS, when BT-RS is allocated multiple bands, are contiguous bands, for example, frequency band 0 is allocated to BT-RS1 and uses TCI state 1 or spatial domain filter 1, frequency band 1 and frequency band 2 are allocated to BT-RS2 and uses TCI state 2 or spatial domain filter 2, frequency band 3 is allocated to BT-RS3 and uses TCI state 3 or spatial domain filter 3.

In yet another example, the frequency allocation is split in frequency bands that can be of unequal size, for example as illustrated in FIG. 29C, where each BT-RS is allocated one frequency band, for the BT-RS symbol, frequency band 1 is larger than frequency band 0 and frequency band 2. Frequency band 0 is allocated to BT-RS1 and uses TCI state 1 or spatial domain filter 1, frequency band 1 is allocated to BT-RS2 and uses TCI state 2 or spatial domain filter 2, and frequency band 2 is allocated to BT-RS3, and uses TCI state 3 or spatial domain filter 3.

In yet another example, the frequency allocation is split in to 4 equal or near equal frequency bands as illustrated in FIG. 29D for the BT-RS symbol. Frequency band 0 is allocated to BT-RS1 and uses TCI state 1 or spatial domain filter 1, frequency band 1 is allocated to BT-RS2 and uses TCI state 2 or spatial domain filter 2, frequency band 2 is allocated to BT-RS3, and uses TCI state 3 or spatial domain filter 3, and frequency band 3 is allocated to BT-RS4, and uses TCI state 4 or spatial domain filter 4.

In a variant of the aforementioned examples, the number of frequency bands can be N. In one example, N=2. In one example, N=1 (e.g., one BT-RS per OFDM symbol).

In one example of the aforementioned examples of FIGS. 29A-29D, the BT-RS can have a physical signal structure similar to the physical signal structure of DM-RS. In another example of the aforementioned examples of FIGS. 29A-29D, the BT-RS can have a physical signal structure similar to the physical signal structure of CSI-RS. In another example of FIGS. 29A-29D, the BT-RS can have a physical signal structure similar to the physical signal structure of SRS.

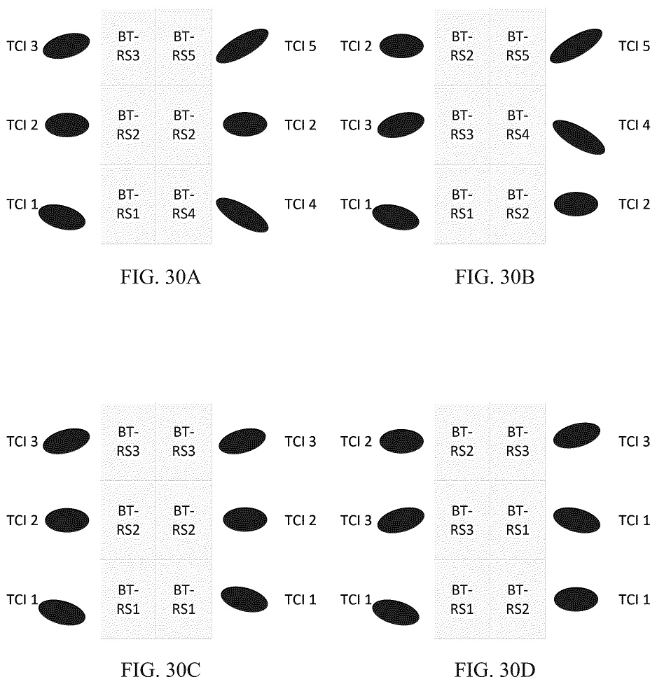

FIGS. 30A-30D illustrate examples of allocating REs or RBs to different types of reference signals according to embodiments of the present disclosure. For example, the allocations may be utilized by a UE, such as, UE 116 in FIG. 1. These examples are for illustration only and other embodiments can be used without departing from the scope of the present disclosure.

In yet another example, there are two BT-RS symbols. In one example, the BT-RS symbols are consecutive. In one example, BT-RS symbols are non-consecutive. In one example, some of the BT-RS occur in both symbols (e.g., BT-RS2 in FIG. 30A), while other BT-RS occur in one symbol (either symbol 0, such as BT-RS1 and BT-RS3 in FIG. 30A, or symbol 1 such BT-RS4 and BT-RS5 in FIG. 30A. In one example, BT-RS allocated to both BT-RS symbols are allocated the same frequency. In one example, the frequency allocation of each BT-RS symbol is split into three frequency bands, as illustrated in FIG. 30A:
In one example, frequency band 0 is allocated to BT-RS1 in BT-RS symbol 0 and frequency band 0 is allocated to BT-RS4 in BT-RS symbol 1.
In one example, frequency band 1 is allocated to BT-RS2 in BT-RS symbol 0 and BT-RS symbol 1, in this example, there is no frequency hopping of DM-RS between symbols.
In one example, frequency band 2 is allocated to BT-RS3 in DM-RS/BT-RS symbol 0 and frequency band 0 is allocated to BT-RS5 in DM-RS/BT-RS symbol 1.

In yet another example, there are two BT-RS symbols. In one example, the BT-RS symbols are consecutive. In one example, the BT-RS symbols are non-consecutive. In one example, some of the BT-RS occur in both symbols (e.g., BT-RS2 in FIG. 30B), while other BT-RS occur in one symbol (either symbol 0, such as BT-RS1 and BT-RS3 in FIG. 30B), or symbol 1 such BT-RS4 and BT-RS5 in FIG. 30B. In one example, BT-RS allocated to both BT-RS symbols can be allocated different frequencies (e.g., hopping between the first symbol and the second symbol). In one example, the frequency allocation of each BT-RS symbol is split into three frequency bands, as illustrated in FIG. 30B:
In one example, frequency band 0 is allocated to BT-RS1 in BT-RS symbol 0 and frequency band 0 is allocated to BT-RS2 in BT-RS symbol 1.
In one example, frequency band 1 is allocated to BT-RS3 in BT-RS symbol 0 and frequency band 1 is allocated to BT-RS4 in BT-RS symbol 1.
In one example, frequency band 2 is allocated to BT-RS2 in BT-RS symbol 0 and frequency band 0 is allocated to BT-RS5 in BT-RS symbol 1.

In yet another example, there are two BT-RS symbols. In one example, the BT-RS symbols are consecutive. In one example, the BT-RS symbols are non-consecutive. In one example, the BT-RS occur in both symbols. In one example, BT-RS allocated to both BT-RS symbols are allocated the same frequency. In one example, the frequency allocation of each BT-RS symbol is split into three frequency bands, as illustrated in FIG. 30C:
In one example, frequency band 0 is allocated to BT-RS1 in BT-RS symbol 0 and BT-RS symbol 1.
In one example, frequency band 1 is allocated to BT-RS2 in BT-RS symbol 0 and BT-RS symbol 1.
In one example, frequency band 2 is allocated to BT-RS3 in BT-RS symbol 0 and BT-RS symbol 1.

In yet another example, there are two BT-RS symbols. In one example, the BT-RS symbols are consecutive. In one example, the BT-RS symbols are non-consecutive. In one example, the BT-RS occur in both symbols. In one example, BT-RS allocated to both BT-RS symbols can be allocated different frequencies (e.g., hopping between the first symbol and the second symbol). In one example, the frequency allocation of each BT-RS symbol is split into three frequency bands, as illustrated in FIG. 30D:
In one example, frequency band 0 is allocated to BT-RS1 in BT-RS symbol 0 and frequency band 0 is allocated to BT-RS2 in BT-RS symbol 1.
In one example, frequency band 1 is allocated to BT-RS3 in BT-RS symbol 0 and frequency band 1 is allocated to BT-RS1 in BT-RS symbol 1.
In one example, frequency band 2 is allocated to BT-RS2 in BT-RS symbol 0 and frequency band 0 is allocated to BT-RS3 in BT-RS symbol 1.

In a variant of the aforementioned examples, the number of frequency bands can be N. In one example, N=2. In one example, N=1 (e.g., one BT-RS per OFDM symbol).

In the aforementioned mentioned: BT-RS1 uses TCI state 1 or spatial domain filter 1 or spatial relation 1, BT-RS2 uses TCI state 2 or spatial domain filter 2 or spatial relation 2, BT-RS3 uses TCI state 3 or spatial domain filter 3 or spatial relation 3, BT-RS4 uses TCI state 4 or spatial domain filter 4 or spatial relation 4, and BT-RS5 uses TCI state 5 or spatial domain filter 5 or spatial relation 5.

In one example of the aforementioned examples of FIGS. 30A-30D, the BT-RS can have a physical signal structure similar to the physical signal structure of DM-RS. In another example of the aforementioned examples of FIG. 28, the BT-RS can have a physical signal structure similar to the physical signal structure of CSI-RS. In another example of FIGS. 30A-30D, the BT-RS can have a physical signal structure similar to the physical signal structure of SRS.

In one example, within respective frequency bands, one or more CDM groups are for used respective BT-RS. In one example, there is one or more DM-RS symbols wherein the entire frequency allocation of the DM-RS symbol is used for DM-RS, wherein TCI state 0 or spatial domain filter 0 or spatial relation 0. In one example, for symbols used for data transmission (e.g., for transmitting the encoded and modulated DL-SCH), TCI state 0 or spatial domain filter 0 or spatial relation 0 is used. In aforementioned, example, TCI state 0 or spatial domain filter 0 or spatial relation 0, is the TCI state or spatial domain filter or spatial relation of the main beam. TCI state 1 . . . M, or spatial domain filter 1 . . . M or spatial relation 1 . . . M, is the TCI state or spatial domain filter or spatial relation of the 1^{st}, . . . Mth beam respectively.

In the above description of beam tracking reference signal transmitted with DL data (e.g., PDSCH or PDCCH), while the examples described are mainly for the case of a BT-RS with a signal structure similar to that of DM-RS, the BT-RS can also have a physical signal structure similar to the physical signal structure of CSI-RS as describe later in this disclosure or similar to SRS.

Various embodiments of the present disclosure provide for beam tracking reference signal transmitted outside DL transmissions. In one example, the UE can transmit one or more reference signals for periodic or continuous beam tracking (for brevity referred to as beam tracking reference signal or CBT-RS), as explained in this disclosure, outside the PDSCH transmission. In one example, the CBT-RS can have a physical signal structure similar to the physical signal structure of CSI-RS as described later in this disclosure. In one example, the CBT-RS can have a physical signal structure similar to the physical signal structure of DM-RS as aforementioned. In one examples, the CBT-RS can be NZP CSI-RS (e.g., used for beam measurements). In one example, the CBT-RS can have a physical signal structure similar to the physical signal structure of SRS.

In one example, a UE is configured with TCI states, and is configured CBT-RSes and is further configured an association between the TCI states and CBT-RSes, e.g., a TCI state is associated with up m CBT-RS. For example, if a UE is indicated a TCI state, the UE can measure a quality (e.g., RSRP/SINR/CQI/MCS/BLER) for each of the CBT-RSes associated with the TCI state. The UE can provide a measurement report including one or more CBT-RS resource indicator index (the index is of one of the M or up to M indices of CBT-RS associated with the TCI state) and possibly the corresponding quality to the network. In another example, the association between the TCI states and CBT-RSes can be indicated to the UE by a MAC CE (for example, for the activated TCI states/TCI state code points). In another example, the UE can be indicated the CBT-RS(es) to measure or monitor, e.g., by RRC or MAC CE or L1 control (e.g., DCI Format) signaling. In one example, the DCI Format is UE specific. In one example, the DCI Format is to a group of UEs (e.g., group common DCI). For example, the UE can be indicated to measure M CBT-RS(es), the UE can provide a measurement report including one or more CBT-RS resource indicator index and possibly a corresponding quality to the network. In one example, the index can be a value from 0 to M−1 corresponding to one of the indicated CBT-RS for the UE to measure. In one example, the index can be a value from 0 to M corresponding to one of the indicated CBT-RS for the UE to measure or to the RS/signal associated with the current beam used by the UE. In one example, the UE measurement report can be a standalone transmission from the UE to the network. In one example, the UE measurement report can be included with the HARQ-ACK feedback from UE. In one example, the UE measurement report with HARQ-ACK feedback can include an index of a preferred CBT-RS resource.

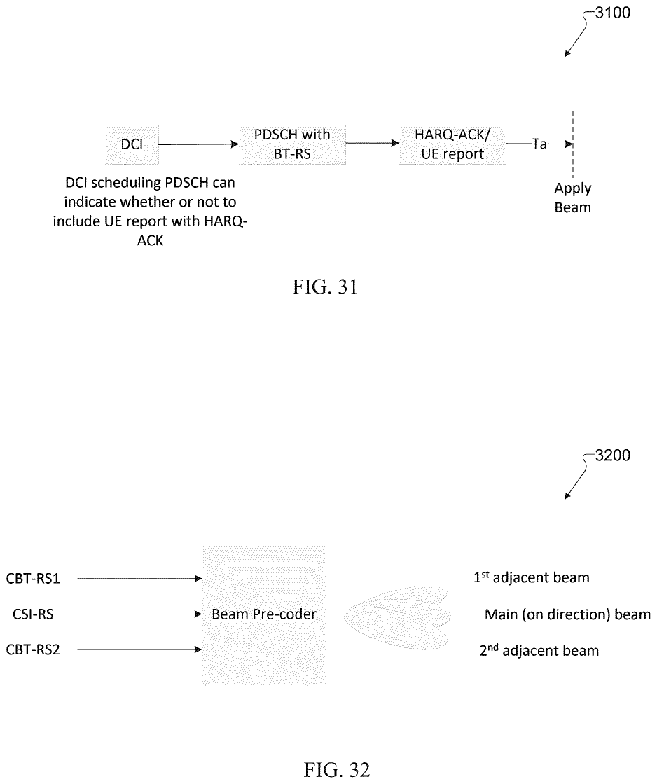

FIG. 31 illustrates an example timeline 3100 for scheduling the PDSCH whether to a UE measurement report with HARQ-ACK feedback according to embodiments of the present disclosure. For example, the timeline 3100 may be utilized by a UE, such as, UE 116 in FIG. 1. This example is for illustration only and other embodiments can be used without departing from the scope of the present disclosure.

In one example, the UE can be configured by higher layer signaling (e.g., SIB or RRC) whether or not to include a UE measurement report with HARQ-ACK feedback. In one example, the UE can be activated (or deactivated) (e.g., by MAC CE or L1 control (e.g., DCI Format)), to include (or not include respectively) a UE measurement report with HARQ-ACK feedback. In one example, the DCI Format is UE specific. In one example, the DCI Format is to a group of UEs (e.g., group common DCI). In one example, for an instance of a PDSCH, the UE can be indicated by L1 control (e.g., DCI Format) scheduling the PDSCH whether or not to include a UE measurement report with HARQ-ACK feedback as illustrated in FIG. 31. In one example, the UE can be indicated by L1 control (e.g., DCI Format) scheduling the PDSCH the number of resources K to include in the UE measurement report. In one example, in response to a PDSCH and with M CBT-RS(es) the UE is monitoring (e.g., associated with the indicated TCI state or indicated to the UE to measure/monitor), the UE can report with a HARQ-ACK feedback, K resource indices corresponding to the K preferred resources, e.g., as illustrated in FIG. 31. In one example K=1. In one example, the resource index reported with HARQ-ACK feedback is of size ┌K log₂ M┐ or K┌log₂ M┐. In one example, the resource index reported with HARQ-ACK feedback is of size ┌K log₂(M+1)┐ or K┌log₂(M+1)┐, wherein the extra index (e.g., index 0) can be to report no beam change or current beam (e.g., current beam of PDSCH or PDCCH or corresponding DMRS is the preferred beam). In one example, after HARQ-ACK report by a beam application time (BAT) Tₐ, the beam corresponding to the indicated resource is applied as described later in this disclosure and indicated in FIG. 31. In one example, the BS sends a signal after the UE report in response to the beam report, after the signal is transmitted by the BS/received by the UE by a time Tₐ, the beam can be applied as described later in this disclosure. In one example, the BS can use the beam indicated by the UE in a UE report for subsequent beam indication, e.g., the beam can be signaled, e.g., as a TCI state or TCI state code point, to the UE in MAC CE activating/indication TCI state(s) or indicated to the UE using a DCI Format conveying a TCI state.

FIG. 32 illustrates an example of transmission 3200 of CBT-RS according to embodiments of the present disclosure. For example, the transmission 3200 may be implemented by a network device, such as, BS 102 in FIG. 1. This example is for illustration only and other embodiments can be used without departing from the scope of the present disclosure.

In one example, the network can be configured to transmit reference signals outside of the DL data transmissions (e.g., outside of PDSCH and/or PDCCH). These signals can be transmitted periodically, semi-persistently or aperiodically. In addition, the network transmits M CBT-RS wherein CBT-RS i, for i=1, . . . , M, is transmitted using beam or spatial domain transmission filter i associated with the indicated or main beam (or indicated or main spatial domain transmission filter) as illustrated in FIG. 32. The term CBT-RS is used to described the functionality of the reference signal to be used for beam tracking or identifying new beams as the channel conditions change. The CBT-RS transmitted outside of the DL channel, and can be transmitted periodically, semi-persistently or aperiodically. The CBT-RS can be configured according to the following examples, as described in this disclosure:
In one example, a CSI-RS is configured with N antenna ports, of the N antenna ports N₀ antenna ports follow the spatial domain filter (or beam or TCI state) of the indicated or main TCI state, N₁ antenna ports use a first spatial domain transmission filter for a first adjacent or associated beam or TCI state, N₂ antenna ports use a second spatial domain transmission filter for a second adjacent or associated beam or TCI state, . . . , N_{M} antenna ports use a Mth spatial domain transmission filter for a Mth adjacent or associated beam or TCI state. In one example, N₀+N₁+N₂ . . . +N_{M}≤N. In one example, N₀+N₁+N₂ . . . + N_{M}=N.
In one example, a CSI-RS is configured for CBT-RS separate from the DM-RS used for the demodulation of the DL channel. The CBT-RS has a physical signal structure similar to CSI-RS, but is configured in different resources. In one example, the CBT-RS (or CSI-RS for beam tracking) can be configured in symbols different from the symbols used for the CSI-RS for other purposes. In one example, the CBT-RS (or CSI-RS for beam tracking) can be configured in resource blocks (RBs) different from the RBs used for the CSI-RS for other purposes. In one example, the CBT-RS (or CSI-RS for beam tracking) can be configured in resource element (REs) different from the REs used for the CSI-RS for other purposes. In one example, one CSI-RS resource for beam tracking is configured for M beam tracking reference signals (e.g., different antenna ports are associated with different CBT-RS). In one example, K CSI-RS resources for beam tracking are configured for M CBT-RS, e.g., each of the M CBT-RS is associated with one of the K CSI-RS configured for beam tracking. In one example, M CSI-RS for beam tracking are configured for M CBT-RS, e.g., with a one-to-one association.
In one example, the CBT-RS has a physical signal structure similar to DM-RS. In one example, the CBT-RS can be configured in symbols different from the symbols used for the CSI-RS. In one example, the CBT-RS can be configured in resource blocks (RBs) different from the RBs used for the CSI-RS. In one example, the CBT-RS can be configured in resource element (REs) different from the REs used for the CSI-RS. In one example, one CBT-RS configured with a DM-RS-like physical channel structure is configured for M beam tracking reference signals (e.g., different antenna ports are associated with different CBT-RS). In one example, K CBT-RS configured with a DM-RS-like physical channel structure are configured for M CBT-RS, e.g., each of the M CBT-RS is associated with one of the K CBT-RS. M CBT-RS configured with a DM-RS-like physical channel structure are configured for M CBT-RS, e.g., with a one-to-one association.
In one example, the CBT-RS has a physical signal structure similar to SRS, but transmitted to the UE. In one example, the CBT-RS can be configured in symbols different from the symbols used for the CSI-RS. In one example, the CBT-RS can be configured in resource blocks (RBs) different from the RBs used for the CSI-RS. In one example, the CBT-RS can be configured in resource element (REs) different from the REs used for the CSI-RS. In one example, one CBT-RS configured with a SRS-like physical channel structure is configured for M beam tracking reference signals (e.g., different antenna ports are associated with different CBT-RS). In one example, K CBT-RS configured with a SRS-like physical channel structure are configured for M CBT-RS, e.g., each of the M CBT-RS is associated with one of the K CBT-RS. In one example, M CBT-RS configured with a SRS-like physical channel structure are configured for M CBT-RS, e.g., with a one-to-one association.

In one example, a SRS-like signal structure can use distributed CDM groups, and a CSI-RS-like signal structure can use localized CDM groups.

Various embodiments of the present disclosure provide for association of beams. In one example, a beam can be identified by a TCI state ID or reference signal (RS ID), the reference signal can be a SS/PBCH block index or a CSI-RS or a SRS. The network can configure or update (e.g., through higher layer signaling or through dynamic signaling), as an aforementioned association between an indicated or main beam and a set (e.g., up to M) adjacent or associated beams (e.g., CBT-RS) for example as illustrated in Table 5.

TABLE 5

| Main | First adjacent/ | Second adjacent/ | | Mth adjacent/ |
|---|---|---|---|---|
| Beam | associated beam | associated beam | . . . | associated beam |
| TCI0 | TCI(0, 0) or | TCI(0, 1) or | . . . | TCI(0, M) or |
| RS0 | RS(0, 0) | RS(0, 1) | | RS(0, M) |
| TCI1 | TCI(1, 0) or | TCI(1, 1) or | | TCI(1, M) or |
| RS1 | RS(1, 0) | RS(1, 1) | | RS(1, M) |
| . . . | . . . | . . . | . . . | . . . |

In one example, the beams are associated with DL signals outside the DL data transmission. The UE can measure and report the reference signals associated with the indicated or main beam (or TCI state) based on the aforementioned association. The UE can report a measurement or a preferred beam, or beams based on the measurement

In one example, if a UE is indicated multiple TCI states (e.g., for multi-TRP), for example two indicated TCI states, the UE can measure and report first reference signals associated with the first indicated or main beam (or TCI state), and second reference signals associated with the second indicated or main beam (or TCI state) based on the aforementioned association. The UE can report a measurement or a first preferred beam or beams, and/or a second preferred beam or beams respectively based on the measurement.

In one example, the network transmits CSI-RS using a main beam (a main spatial domain transmission filter). In addition, the network transmits M beam tracking reference signals (CBT-RS) wherein CBT-RS i, for i=1, . . . , M, is transmitted using beam or spatial domain transmission filter i associated with the main beam (or main spatial domain transmission filter) as illustrated in FIG. 32.

In one example, the BS transmits a first beam tracking reference signals (CBT-RS1) and a second beam tracking reference signal (CBT-RS2), the receiver, e.g., in the UE measures a first metric from CBT-RS1 and a second metric from CBT-RS2, and the UE reports to the BS (base station) the first metric and the second metric. In one example, the BS can adjust the TCI state or spatial relation or spatial domain transmission filter the BS uses for DL transmissions (e.g., for PDSCH and/or PDCCH) based on the first metric and the second metric, and in case of reciprocity, the adjustment can also apply to the TCI state or spatial relation or spatial domain transmission filter the BS uses for UL transmissions (e.g., UL transmissions following a main or indicated joint TCI state received at the BS). In one example, CBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and CBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the CSI-RS (e.g., using the main or indicated TCI state) and the second metric is measured using a CBT-RS. In one example, the beam (or spatial domain filter) of the CSI-RS is the sum beam, and the beam (or spatial domain filter) of the CBT-RS is the difference beam. In a variant example, of the aforementioned examples, the BS determines a TCI state or spatial relation based on the first metric and the second metric, and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the first metric and the second metric, and the UE signals the TCI state or the spatial relation to the BS for the BS and/or UE to use for DL transmissions and in case of reciprocity for reception of UL transmissions (e.g., UL transmissions following a main or indicated joint TCI state).

In one example, the BS transmits a first beam tracking reference signals (CBT-RS1) and a second beam tracking reference signal (CBT-RS2), the receiver, e.g., in the UE measure a first metric from CBT-RS1 and a second metric from CBT-RS2, the UE calculates a quantity based on the first metric and the second metric, and the UE reports the quantity to the BS (base station). In one example, the BS can adjust the TCI state or spatial relation or spatial domain transmission filter the BS uses for DL transmissions (e.g., for PDSCH and/or PDCCH) based on the quantity, and in case of reciprocity, the adjustment can also apply to the TCI state or spatial relation or spatial domain transmission filter the BS uses for UL transmissions (e.g., UL transmissions following a main or indicated joint TCI state received at the BS). In one example, CBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

and CBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] .$$

In a variant example, the first metric is measured using the CSI-RS or SRS-like RS (e.g., using the main or indicated TCI state) and the second metric is measured using a CBT-RS. In one example, the beam (or spatial domain filter) of the CSI-RS is the sum beam, and the beam (or spatial domain filter) of the CBT-RS is the difference beam. In a variant example, of the aforementioned examples, the BS determines a TCI state or spatial relation based on the quantity (from the first metric and the second metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the quantity (from the first metric and the second metric), and the UE signals the TCI state or the spatial relation to the BS for the BS and/or UE to use for DL transmissions and in case of reciprocity for UL transmissions (e.g., UL transmissions following a main or indicated joint TCI state).

In one example, the BS transmits a first beam tracking reference signals (CBT-RS1), a second beam tracking reference signal (CBT-RS2), and a third beam tracking reference signal (CBT-RS3), the receiver, e.g., in the UE measures a first metric from CBT-RS1, a second metric from CBT-RS2 and a third metric from CBT-RS3, and the UE reports to the BS (base station) the first metric, the second metric and the third metric. In one example, the BS can adjust the TCI state or spatial relation or spatial domain transmission filter the BS uses for DL transmissions (e.g., for PDSCH and/or PDCCH) based on the first metric, the second metric and the third metric, and in case of reciprocity, the adjustment can also apply to the TCI state or spatial relation or spatial domain transmission filter the BS uses for UL transmissions (e.g., UL transmissions following a main or indicated joint TCI state received at the BS).

In one example, CBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, CBT-RS2 is a difference beam (or difference spatial domain filter) in the first dimension (e.g., azimuth), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ]$$

in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

and
In one example, CBT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the CSI-RS (e.g., using the main or indicated TCI state)(e.g., CSI-RS is used as CBT-RS1) and the second metric and third metric are measured using a CBT-RS (e.g., CBT-RS2 and CBT-RS3). In one example, the beam (or spatial domain filter) of the CSI-RS is the sum beam, and the beam (or spatial domain filter) of the CBT-RS2 is the difference beam in the first dimension (e.g., azimuth), and the beam (or spatial domain filter) of the CBT-RS3 is the difference beam in the second dimension (e.g., zenith). In a variant example, of the aforementioned examples, the BS determines a TCI state or spatial relation based on the first metric, the second metric and/or the third metric, and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the first metric, the second metric and/or the second metric, and the UE signals the TCI state or the spatial relation to the BS for the BS and/or UE to use for DL transmissions and in case of reciprocity for reception of UL transmissions (e.g., UL transmissions following a main or indicated joint TCI state).

In one example, the BS transmits a first beam tracking reference signals (CBT-RS1), a second beam tracking reference signal (CBT-RS2) and a third beam tracking reference signal (CBT-RS3), the receiver, e.g., in the UE measures a first metric from CBT-RS1, a second metric from CBT-RS2 and a third metric from CBT-RS3. In one example, the UE calculates a quantity(s) based on the first metric, the second metric and/or the third metric, and the UE reports the quantity(s) to the BS (base station). In one example, the UE calculates a first quantity based on the first metric and the second metric, and the UE calculates a second quantity based on the first metric and the third metric, and the UE reports the first quantity and the second quantity to the BS (base station). In one example, the BS can adjust the TCI state or spatial relation or spatial domain transmission filter the BS uses for DL transmissions (e.g., for PDSCH and/or PDCCH) based on the quantity or quantities, and in case of reciprocity, the adjustment can also apply to the TCI state or spatial relation or spatial domain transmission filter the BS uses for UL transmissions (e.g., UL transmissions following a main or indicated joint TCI state received at the BS).
In one example, CBT-RS1 is a sum beam (or sum spatial domain filter), e.g., with beam coefficients

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] ,$$

in a first dimension (e.g., azimuth) and

$$[ {d}_{0} , d , … {d}_{\frac{n}{2} - 1} , {d}_{\frac{n}{2}} , {d}_{\frac{n}{2} + 1} , … , {d}_{n - 1} ] ,$$

in a second dimension (e.g., zenith),
In one example, CBT-RS2 is a difference beam (or difference spatial domain filter), e.g., with beam coefficients

$$[ {c}_{0} , {c}_{1} , … {c}_{\frac{n}{2} - 1} , - {c}_{\frac{n}{2}} , - {c}_{\frac{n}{2} + 1} , … , - {c}_{n - 1} ] ,$$

in the first dimension (e.g., azimuth), in one example the coefficients of the second dimension (e.g., zenith) can correspond to

$$[ {d}_{0} , d , … {d}_{\frac{n}{2} - 1} , {d}_{\frac{n}{2}} , {d}_{\frac{n}{2} + 1} , … , {d}_{n - 1} ] ,$$

In one example, CBT-RS3 is a difference beam (or difference spatial domain filter) in the second dimension (e.g., zenith), e.g., with beam coefficients

$$[ {d}_{0} , d , … {d}_{\frac{n}{2} - 1} , - {d}_{\frac{n}{2}} , - {d}_{\frac{n}{2} + 1} , … , - {d}_{n - 1} ] ,$$

in one example the coefficients of the first dimension (e.g., azimuth) can correspond to

$$[ {c}_{0} , {c}_{1} , … {c}_{\frac{n}{2} - 1} , {c}_{\frac{n}{2}} , {c}_{\frac{n}{2} + 1} , … , {c}_{n - 1} ] .$$

In a variant example, the first metric is measured using the CSI-RS (e.g., using the main or indicated TCI state) (e.g., CSI-RS is used as CBT-RS1) and the second metric and the third metric are measured using a CBT-RS (e.g., CBT-RS2 and CBT-RS3). In one example, the beam (or spatial domain filter) of the CSI-RS or SRS-like RS is the sum beam, and the beam (or spatial domain filter) of the CBT-RS2 is the difference beam in the first dimension (e.g., azimuth), and the beam (or spatial domain filter) of the CBT-RS3 is the difference beam in the second dimension (e.g., zenith). In a variant example, of the aforementioned examples, the BS determines a TCI state or spatial relation based on the quantity(s) (from the first metric, the second metric and/or the third metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the BS determines a TCI state or spatial relation based on a first quantity (from the first metric and the second metric), and a second quantity (from the first metric and the third metric), and the BS signals the TCI state or the spatial relation to the UE for the UE and/or BS to use for DL transmissions and in case of reciprocity for UL transmissions (e.g., UL transmissions following a main or indicated joint TCI state). In a variant example, of the aforementioned examples, the UE determines a TCI state or spatial relation based on the quantity(s) (from the first metric and/or the second metric and/or the third metric), and the UE signals the TCI state or the spatial relation to the BS for the BS and/or UE to use for DL transmissions and in case of reciprocity for UL transmissions (e.g., UL transmissions following a main or indicated joint TCI state).

Various embodiments of the present disclosure provide for mapping CBT-RS to REs or RBs or Symbols of outside of a DL transmission. In one example, a UE can transmit CSI-RS using a main spatial domain transmission filter (e.g., main beam) and one or more adjacent spatial domain transmission filters (e.g., adjacent beam(s)).

In one example, CSI-RS using the main spatial domain transmission has N-ports. In one example, a CSI-RS (referred to as CBT-RS for Beam tracking reference signal) using an adjacent spatial domain transmission filter has one port. In one example, a CBT-RS using an adjacent spatial domain transmission filter has two ports. In one example, a CBT-RS using an adjacent spatial domain transmission filter has N-ports.

In one example, the CSI-RS and the CBT-RS are multiplexed in a same symbol or in a same group of symbols. In one example, the CSI-RS uses a first one or more CDM groups, and the CBT-RS uses a second one or CDM groups.

In one example, a symbol can have CSI-RS and CBT-RS, for example, a first antenna port(s) or a first CDM group(s) or a first set of RE(s) or a first set of RB(s) is used for CSI-RS, and a second antenna port(s) or a second CDM group(s) or a second set of RE(s) or a second set of RB(s) is used for CBT-RS. The mapping of CDM groups to REs can be as described in this disclosure.

In one example, a symbol can have CSI-RS and CBT-RS, for example, a first antenna port(s) or a first CDM group(s) or a first set of RE(s) or a first set of RB(s) is used for CSI-RS, and a second antenna port(s) or a second CDM group(s) or a second set of RE(s) or a second set of RB(s) is used for CBT-RS. The mapping of CDM groups to REs can be as described in this disclosure. In addition, a symbol can have CSI-RS with no CBT-RS.

In one example, N-port CSI-RS is configured, wherein the N-port CSI-RS has n CDM groups. The n CDM groups can span l time occasions and m frequency occasions such that n=l×m. For example, as illustrated in FIG. 11, a 24-port (N=24), is configured that has 6 (n=6) CDM groups arranged as 2×3 CDM groups, where l=2 and m=3.

In one example, a CSI-RS configuration is used for CSI-RS and CBT-RS. In one example, a first CSI-RS configuration is used CSI-RS and CBT-RS, and a second CSI-RS configuration is used for CBT-RS. In one example, a first CSI-RS configuration is used CSI-RS, and a second CSI-RS configuration is used for CBT-RS.

In one example, a CSI-RS configuration is used for CSI-RS and CBT-RS, wherein CSI-RS and CBT-RS are mapped to CDM groups in different symbols. For example, in FIG. 11, CSI-RS can be mapped to the CDM groups in symbols 4 and 5, and CBT-RS can be mapped to CDM groups in symbols 8 and 9.

In one example, a CSI-RS configuration is used for CSI-RS and CBT-RS, wherein CSI-RS and CBT-RS are mapped to CDM groups in the same or different symbols. For example, in FIG. 11, CSI-RS can be mapped to the CDM group 0 and CBT-RS can be mapped to CDM groups 1 to 5.

In one example, a CSI-RS configuration is used for CSI-RS and CBT-RS, and a CDM group can include ports for CSI-RS and ports for CBT-RS.

In one example, a CDM group used for CBT-RS is associated with one CBT-RS. In one example, a CDM group used for CBT-RS can be associated with more than one CBT-RS.

In one example, a CSI-RS configuration is used at least for multiple CBT-RS (e.g., CBT-RS1, CBT-RS2, etc.). In one example, different CBT-RS can be mapped to different antenna ports of a same CDM group (for example, CBT-RS1 is mapped to a first port(s) of a CDM group, and CBT-RS2 is mapped to a second port(s) of the CMD group).

In one example, a CSI-RS configuration is used at least for multiple CBT-RS (e.g., CBT-RS1, CBT-RS2, etc.). In one example, different CBT-RS are mapped to different CDM groups (for example, CBT-RS1 is mapped to a first CDM group(s), and CBT-RS2 is mapped to a second CMD group(s)), wherein the CDM groups can be in a same symbol(s) or in different symbol(s).

In one example, a CSI-RS configuration is used at least for multiple CBT-RS (e.g., CBT-RS1, CBT-RS2, etc.). In one example, different CBT-RS are mapped to same or different CDM groups in different symbols(s) (for example, CBT-RS1 is mapped to a first CDM group(s) in first symbol(s), and CBT-RS2 is mapped to a second CMD group(s) in second symbol(s)).

In one example, in symbols with reference signal (e.g., CSI-RS/CBT-RS symbols or CBT-RS symbols), a first set of RBs are allocated to CSI-RS, and a second set of RBs are allocated to CBT-RS.
In one example, the RBs allocated to CSI-RS can be configured with CDM groups and antenna ports according the aforementioned CSI-RS configuration.
In one example, the RBs allocated to CBT-RS can be configured with CDM groups and antenna ports according to the aforementioned CSI-RS configuration. In one example, a CBT-RS on an adjacent beam (or spatial domain filter) can be allocated one or two ports or more ports in a CDM group. In one example, a CDM group is used for one CBT-RS. In one example, a CDM group can be used for more than one CBT-RS.
In one example, the REs of RBs allocated to BT-RS can be divided into groups, wherein a group of REs is associated with a CBT-RS. For example, the first group of REs are associated, with a first CBT-RS, the second group of REs are associated with a second CBT-RS and so on. In one example, the REs in a RB associated with a CBT-RS can be contiguous. In one example, the REs in a RB associated with a CBT-RS can be non-contiguous.
In one example, the RBs allocated to CBT-RS can be divided into groups, wherein a group of RBs is associated with a CBT-RS. For example, the first group of RBs are associated with a first CBT-RS, the second group of RBs are associated with a second CBT-RS and so on. In one example, the RBs associated with a CBT-RS can be contiguous. In one example, the RBs associated with a CBT-RS can be non-contiguous.

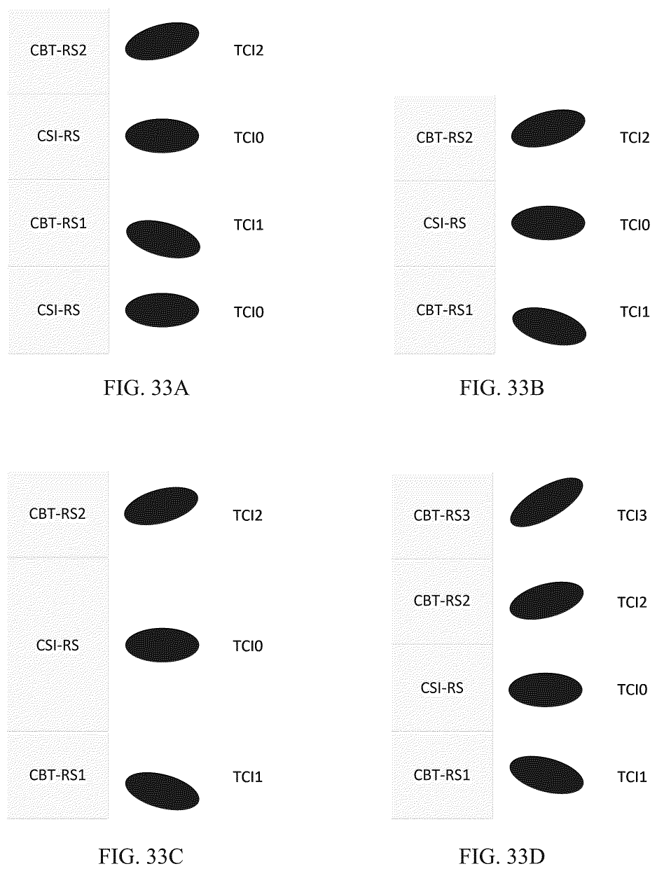

FIGS. 33A-33D illustrate examples of allocating contiguous REs or contiguous RBs to different types of reference signals according to embodiments of the present disclosure. For example, the allocations may be utilized by a UE, such as, UE 116 in FIG. 1. These examples are for illustration only and other embodiments can be used without departing from the scope of the present disclosure.

As illustrated in FIG. 33A, the frequency allocation is split in to 4 equal or near equal frequency bands. In CSI-RS/CBT-RS symbols, frequency band 0 and frequency band 2 are allocated to CSI-RS using TCI state 0 or spatial domain filter 0, frequency band 1 is allocated to CBT-RS1 and uses TCI state 1 or spatial domain filter 1, and frequency band 3 is allocated to CBT-RS2 and uses TCI state 2 or spatial domain filter 2. In a variant example, as illustrated in FIG. 33B, the bands for CSI-RS are contiguous bands, for example, frequency band 0 is allocated to CBT-RS1 and uses TCI state 1 or spatial domain filter 1, frequency band 1 and frequency band 2 are allocated to CSI-RS and uses TCI state 0 or spatial domain filter 0, frequency band 3 is allocated to CBT-RS2 and uses TCI state 2 or spatial domain filter 2.

In yet another example, the frequency allocation is split in frequency bands that can be of unequal size, for example as illustrated in FIG. 33C for the CSI-RS/CBT-RS symbol, frequency band 1 is larger than frequency band 0 and frequency band 2. Frequency band 0 is allocated to CBT-RS1 and uses TCI state 1 or spatial domain filter 1, frequency band 1 is allocated to CSI-RS and uses TCI state 0 or spatial domain filter 0, and frequency band 2 is allocated to CBT-RS2, and uses TCI state 2 or spatial domain filter 2.

In yet another example, the frequency allocation is split in to 4 equal or near equal frequency bands as illustrated in FIG. 33D for the CSI-RS/BT-RS symbol. Frequency band 0 is allocated to CBT-RS1 and uses TCI state 1 or spatial domain filter 1, frequency band 1 is allocated to CSI-RS and uses TCI state 0 or spatial domain filter 0, frequency band 2 is allocated to CBT-RS2, and uses TCI state 2 or spatial domain filter 2, and frequency band 3 is allocated to CBT-RS3, and uses TCI state 3 or spatial domain filter 3.

In a variant of the aforementioned examples, the number of frequency bands can be N. In one example, N=2, e.g., a CSI-RS and CBT-RS are allocated to an OFDM symbol.

A block shown in FIGS. 33A-33D, can represent a symbol, or a group of symbols in a same CDM group, or a group of symbols across multiple CDM groups in a slot (or in an instance of CSI-RS configuration).

In another example of the aforementioned examples of FIGS. 33A-33D, the CBT-RS can have a physical signal structure similar to the physical signal structure of CSI-RS. In one example of the aforementioned examples of FIGS. 33A-33D, the CBT-RS can have a physical signal structure similar to the physical signal structure of DM-RS. In another example of the aforementioned examples of FIGS. 33A-33D, the CBT-RS can have a physical signal structure similar to the physical signal structure of SRS.

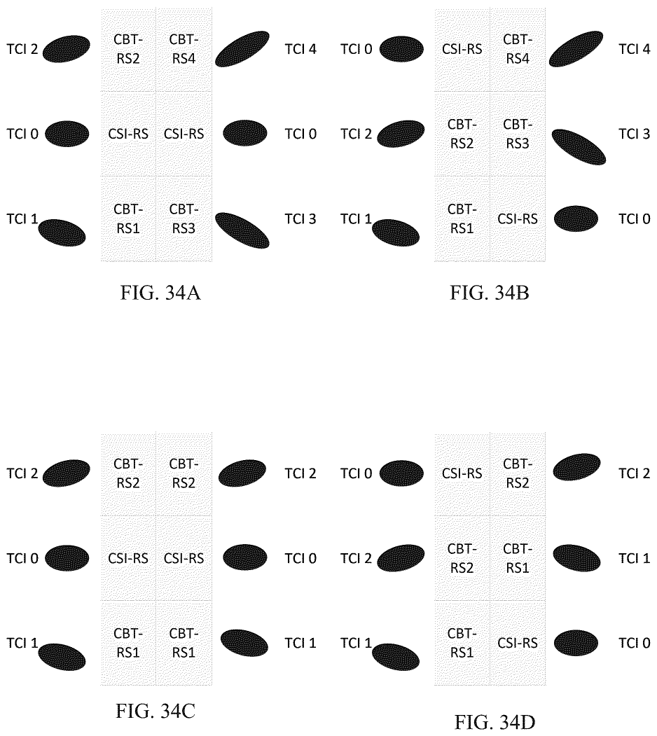

FIGS. 34A-34D illustrate examples of allocating REs or RBs to different types of reference signals according to embodiments of the present disclosure. For example, the allocations may be utilized by a UE, such as, UE 116 in FIG. 1. These examples are for illustration only and other embodiments can be used without departing from the scope of the present disclosure.

In yet another example, there are two CSI-RS/CBT-RS symbols or groups of symbols (e.g., a group of symbols are symbols of a CDM group). In one example, the CSI-RS/CBT-RS symbols or groups of symbols are consecutive. In one example, CSI-RS/CBT-RS symbols or groups of symbols are non-consecutive. In one example, the frequency allocation of each CSI-RS/CBT-RS symbol or group of symbols is split into three frequency bands, wherein different CBT-RS can be allocated to different CSI-RS/CBT-RS as illustrated in FIG. 34A:
In one example, frequency band 0 is allocated to CBT-RS1 in CSI-RS/CBT-RS symbol 0 or symbol group 0 and frequency band 0 is allocated to CBT-RS3 in CSI-RS/CBT-RS symbol 1 or symbol group 1.
In one example, frequency band 1 is allocated to CSI-RS in CSI-RS/CBT-RS symbol 0 or symbol group 0 and CSI-RS/CBT-RS symbol 1 or symbol group 1, in this example, there is no frequency hopping of CSI-RS between symbols.
In one example, frequency band 2 is allocated to CBT-RS2 in CSI-RS/CBT-RS symbol 0 or symbol group 1 and frequency band 0 is allocated to CBT-RS4 in CSI-RS/CBT-RS symbol 1 or symbol group 1.
In a variant example, the same CBT-RS can be repeated in both CSI-RS/CBT-RS symbols or symbol groups without or with frequency hopping.

In yet another example, there are two CSI-RS/CBT-RS symbols or groups of symbols (e.g., a group of symbols are symbols of a CDM group). In one example, the CSI-RS/CBT-RS symbols or groups of symbols are consecutive. In one example, CSI-RS/CBT-RS symbols or groups of symbols are non-consecutive. In one example, the frequency allocation of each CSI-RS/CBT-RS symbol or group of symbols is split into three frequency bands, wherein different CBT-RS can be allocated to different CSI-RS/CBT-RS, with frequency hopping of CSI-RS as illustrated in FIG. 34B:
In one example, frequency band 0 is allocated to CBT-RS1 in CSI-RS/CBT-RS symbol 0 or symbol group 0 and frequency band 0 is allocated to CSI-RS in CSI-RS/CBT-RS symbol 1 or symbol group 1.
In one example, frequency band 1 is allocated to CBT-RS2 in CSI-RS/CBT-RS symbol 0 or symbol group 0 and frequency band 1 is allocated to CBT-RS3 in CSI-RS/CBT-RS symbol 1 or symbol group 1.
In one example, frequency band 2 is allocated to CSI-RS in CSI-RS/CBT-RS symbol 0 or symbol group 0 and frequency band 0 is allocated to CBT-RS4 in CSI-RS/CBT-RS symbol 1 or symbol group 1.
In a variant example, the same CBT-RS can be repeated in both CSI-RS/CBT-RS symbols or symbol groups with or without frequency hopping

In yet another example, there are two CSI-RS/CBT-RS symbols or groups of symbols (e.g., a group of symbols are symbols of a CDM group). In one example, the CSI-RS/CBT-RS symbols or groups of symbols are consecutive. In one example, CSI-RS/CBT-RS symbols or groups of symbols are non-consecutive. In one example, the frequency allocation of each CSI-RS/CBT-RS symbol or groups of symbols is split into three frequency bands, wherein same CBT-RS can be allocated to different CSI-RS/CBT-RS without frequency hopping as illustrated in FIG. 34C:
In one example, frequency band 0 is allocated to CBT-RS1 in CSI-RS/CBT-RS symbol 0 or symbol group 0 and CSI-RS/CBT-RS symbol 1 or symbol group 1.
In one example, frequency band 1 is allocated to CSI-RS in CSI-RS/CBT-RS symbol 0 or symbol group 0 and CSI-RS/CBT-RS symbol 1 or symbol group 1.
In one example, frequency band 2 is allocated to CBT-RS2 in CSI-RS/CBT-RS symbol 0 or symbol group 0 and CSI-RS/CBT-RS symbol 1 or symbol group 1.

In yet another example, there are two CSI-RS/CBT-RS symbols or groups of symbols (e.g., a group of symbols are symbols of a CDM group). In one example, the CSI-RS/CBT-RS symbols or groups of symbols are consecutive. In one example, CSI-RS/CBT-RS symbols or groups of symbols are non-consecutive. In one example, the frequency allocation of each CSI-RS/CBT-RS symbol or groups of symbols is split into three frequency bands, wherein same CBT-RS can be allocated to different CSI-RS/CBT-RS, with frequency hopping of CSI-RS as illustrated in FIG. 34D:
In one example, frequency band 0 is allocated to CBT-RS1 in CSI-RS/CBT-RS symbol 0 or symbol group 0 and frequency band 0 is allocated to CSI-RS in CSI-RS/CBT-RS symbol 1 or symbol group 1.
In one example, frequency band 1 is allocated to CBT-RS2 in CSI-RS/CBT-RS symbol 0 or symbol group 0 and frequency band 1 is allocated to CBT-RS1 in CSI-RS/CBT-RS symbol 1 or symbol group 1.
In one example, frequency band 2 is allocated to CSI-RS in CSI-RS/CBT-RS symbol 0 or symbol group 0 and frequency band 0 is allocated to CBT-RS2 in CSI-RS/CBT-RS symbol 1 or symbol group 1.

In a variant of the aforementioned examples, the number of frequency bands can be N. In one example, N=2, e.g., a CSI-RS and CBT-RS are allocated to an OFDM symbol.

In the aforementioned mentioned: CSI-RS uses TCI state 0 or spatial domain filter 0 or spatial relation 0, CBT-RS1 uses TCI state 1 or spatial domain filter 1 or spatial relation 1, CBT-RS2 uses TCI state 2 or spatial domain filter 2 or spatial relation 2, CBT-RS3 uses TCI state 3 or spatial domain filter 3 or spatial relation 3, and CBT-RS4 uses TCI state 4 or spatial domain filter 4 or spatial relation 4.

In another example of the aforementioned examples of FIGS. 34A-34D, the CBT-RS can have a physical signal structure similar to the physical signal structure of CSI-RS. In one example of the aforementioned examples of FIGS. 34A-34D, the CBT-RS can have a physical signal structure similar to the physical signal structure of DM-RS. In another example of the aforementioned examples of FIGS. 34A-34D, the CBT-RS can have a physical signal structure similar to the physical signal structure of SRS.

In one example, within respective frequency bands, one or more CDM groups are used for respective CSI-RS or respective CBT-RS. In one example, in addition to the CSI-RS/CBT-RS, there is one or more CSI-RS symbols wherein the entire frequency allocation of the CSI-RS symbol is used for CSI-RS, wherein TCI state 0 or spatial domain filter 0 is used. In one example, for symbols used for data transmission (e.g., for transmitting PDSCH), TCI state 0 or spatial relation 0 is used. In aforementioned, example, TCI state 0 or spatial relation 0, is the TCI state or spatial relation of the main beam. TCI state 1 . . . M, or spatial relation 1 . . . M, is the TCI state or spatial relation of the 1^{st}, . . . Mth beam respectively.

In one example, the CSI-RS and the CBT-RS are transmitted (or multiplexed) in different symbols or in different groups of symbols. In one example, a first one or more symbols or groups of symbols can have CSI-RS. A second one or more symbols or groups of symbols can have CBT-RS.

In one example, the REs of the symbol(s) or group(s) of symbols allocated to CBT-RS can be divided into groups, wherein a group of REs is associated with a CBT-RS. For example, the first group of REs are associated, with a first CBT-RS, the second group of REs are associated with a second CBT-RS and so on. In one example, the REs in a symbol or group of symbols associated with a CBT-RS can be contiguous. In one example, the REs in a symbol or group of symbols associated with a CBT-RS can be non-contiguous. In one example, the REs in a RB of a symbol or group of symbols associated with a CBT-RS can be contiguous. In one example, the REs in a RB of a symbol or group of symbols associated with a CBT-RS can be non-contiguous.

In one example, the RBs of the symbol(s) or group(s) of symbols allocated to CBT-RS can be divided into groups, wherein a group of RBs is associated with a CBT-RS. For example, the first group of RBs are associated with a first CBT-RS, the second group of RBs are associated with a second CBT-RS and so on. In one example, the RBs in a symbol or group of symbols associated with a CBT-RS can be contiguous. In one example, the RBs in a symbol or group of symbols associated with a CBT-RS can be non-contiguous.

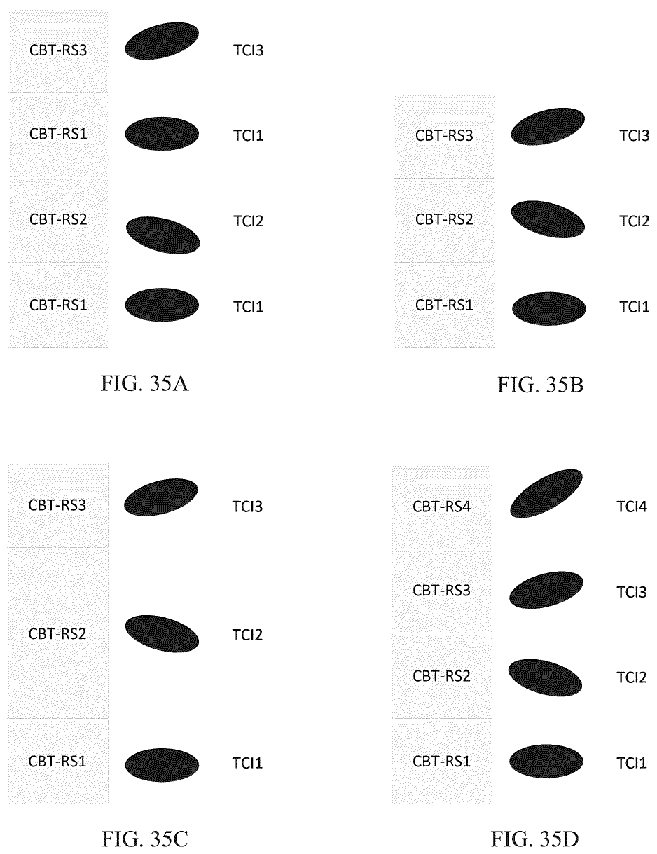

FIGS. 35A-35D illustrate examples of allocating contiguous REs or contiguous RBs to different CBT-RS according to embodiments of the present disclosure. For example, the allocations may be utilized by a UE, such as, UE 116 in FIG. 1. These examples are for illustration only and other embodiments can be used without departing from the scope of the present disclosure.

In one example, a CBT-RS is allocated a one frequency band. In one example, a CBT-RS can be allocated multiple frequency bands. In one example, different CBT-RS are allocated the same number of frequency bands. In one example, different CBT-RS can be allocated different number of frequency bands. In FIG. 35A, the frequency allocation is split in to 4 equal or near equal frequency bands. In CBT-RS symbols or groups of symbols, frequency band 0 and frequency band 2 are allocated to CBT-RS1 using TCI state 1 or spatial domain filter 1, frequency band 1 is allocated to CBT-RS2 and uses TCI state 2 or spatial domain filter 2, and frequency band 3 is allocated to CBT-RS3 and uses TCI state 3 or spatial domain filter 3. In a variant example, as illustrated in FIG. 35B, the bands for CBT-RS, when CBT-RS is allocated multiple bands, are contiguous bands, for example, frequency band 0 is allocated to CBT-RS1 and uses TCI state 1 or spatial domain filter 1, frequency band 1 and frequency band 2 are allocated to CBT-RS2 and uses TCI state 2 or spatial domain filter 2, frequency band 3 is allocated to CBT-RS3 and uses TCI state 3 or spatial domain filter 3.

In yet another example, the frequency allocation is split in frequency bands that can be of unequal size, for example as illustrated in FIG. 35C, where each CBT-RS is allocated one frequency band, for the CBT-RS symbol, frequency band 1 is larger than frequency band 0 and frequency band 2. Frequency band 0 is allocated to CBT-RS1 and uses TCI state 1 or spatial domain filter 1, frequency band 1 is allocated to CBT-RS2 and uses TCI state 2 or spatial domain filter 2, and frequency band 2 is allocated to CBT-RS3, and uses TCI state 3 or spatial domain filter 3.

In yet another example, the frequency allocation is split in to 4 equal or near equal frequency bands as illustrated in FIG. 35D for the CBT-RS symbol or group of symbols. Frequency band 0 is allocated to CBT-RS1 and uses TCI state 1 or spatial domain filter 1, frequency band 1 is allocated to CBT-RS2 and uses TCI state 2 or spatial domain filter 2, frequency band 2 is allocated to CBT-RS3, and uses TCI state 3 or spatial domain filter 3, and frequency band 3 is allocated to CBT-RS4, and uses TCI state 4 or spatial domain filter 4.

In a variant of the aforementioned examples, the number of frequency bands can be N. In one example, N=2. In one example, N=1 (e.g., one CBT-RS per OFDM symbol).

In another example of the aforementioned examples of FIGS. 35A-35D, the CBT-RS can have a physical signal structure similar to the physical signal structure of CSI-RS. In one example of the aforementioned examples of FIGS. 35A-35D, the CBT-RS can have a physical signal structure similar to the physical signal structure of DM-RS. In another example of the aforementioned examples of FIGS. 35A-35D, the CBT-RS can have a physical signal structure similar to the physical signal structure of SRS.

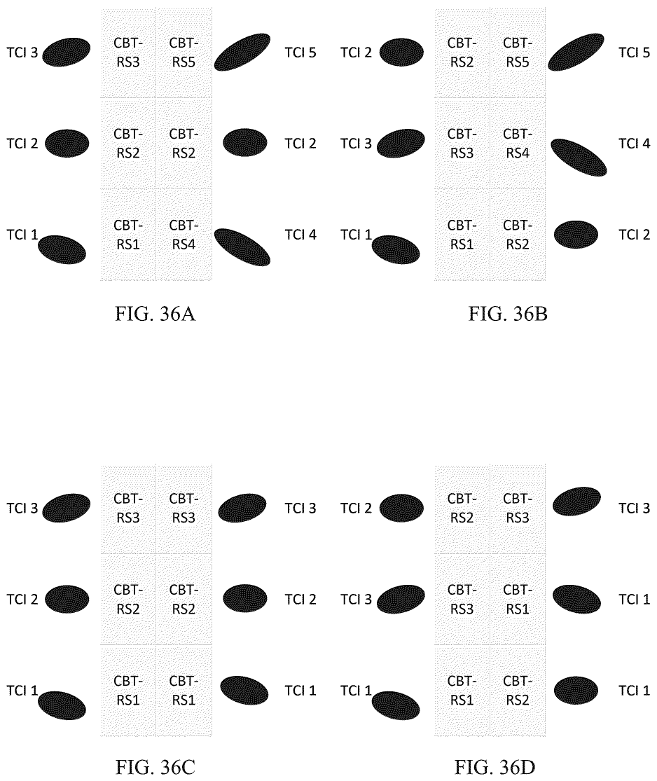

FIGS. 36A-36D illustrate examples of allocating REs or RBs to different CBT-RS according to embodiments of the present disclosure. For example, the allocations may be utilized by a UE, such as, UE 116 in FIG. 1. These examples are for illustration only and other embodiments can be used without departing from the scope of the present disclosure.

In yet another example, there are two CBT-RS symbols or groups of symbols (e.g., a group of symbols are symbols of a CDM group). In one example, the CBT-RS symbols or groups of symbols are consecutive. In one example, CBT-RS symbols or groups of symbols are non-consecutive. In one example, some of the CBT-RS occur in both symbols or groups of symbols (e.g., CBT-RS2 in FIG. 36A), while other CBT-RS occur in one symbol or group of symbols (either symbol 0 symbol group 0, such as CBT-RS1 and CBT-RS3 in FIG. 36A, or symbol 1 symbol group 1 such CBT-RS4 and CBT-RS5 in FIG. 36A). In one example, CBT-RS allocated to both CBT-RS symbols or groups of symbols are allocated the same frequency. In one example, the frequency allocation of each CBT-RS symbol is split into three frequency bands, as illustrated in FIG. 36A:
In one example, frequency band 0 is allocated to CBT-RS1 in CBT-RS symbol 0 or symbol group 0 and frequency band 0 is allocated to CBT-RS4 in CBT-RS symbol 1 or symbol group 1.
In one example, frequency band 1 is allocated to CBT-RS2 in CBT-RS symbol 0 or symbol group 0 and CBT-RS symbol 1 or symbol group 1, in this example, there is no frequency hopping of CSI-RS between symbols or groups of symbols.
In one example, frequency band 2 is allocated to CBT-RS3 in CSI-RS/CBT-RS symbol 0 or symbol group 0 and frequency band 2 is allocated to CBT-RS5 in CSI-RS/CBT-RS symbol 1 or symbol group 1.

In yet another example, there are two CBT-RS symbols or groups of symbols (e.g., a group of symbols are symbols of a CDM group). In one example, the CBT-RS symbols or groups of symbols are consecutive. In one example, the CBT-RS symbols or groups of symbols are non-consecutive. In one example, some of the CBT-RS occur in both symbols or groups of symbols (e.g., CBT-RS2 in FIG. 36B), while other CBT-RS occur in one symbol or group of symbols (either symbol 0 symbol group 0, such as CBT-RS1 and CBT-RS3 in FIG. 36B, or symbol 1 or symbol group 1 such CBT-RS4 and CBT-RS5 in FIG. 36B). In one example, CBT-RS allocated to both CBT-RS symbols or groups of symbols can be allocated different frequencies (e.g., hopping between the first symbol or group of symbols and the second symbol or group of symbols). In one example, the frequency allocation of each CBT-RS symbol or group of symbols is split into three frequency bands, as illustrated in FIG. 36B:
In one example, frequency band 0 is allocated to CBT-RS1 in CBT-RS symbol 0 or symbol group 0 and frequency band 0 is allocated to CBT-RS2 in CBT-RS symbol 1 or symbol group 1.
In one example, frequency band 1 is allocated to CBT-RS3 in CBT-RS symbol 0 or symbol group 0 and frequency band 1 is allocated to CBT-RS4 in CBT-RS symbol 1 or symbol group 1.
In one example, frequency band 2 is allocated to CBT-RS2 in CBT-RS symbol 0 or symbol group 0 and frequency band 2 is allocated to CBT-RS5 in CBT-RS symbol 1 or symbol group 1.

In yet another example, there are two CBT-RS symbols or groups of symbols (e.g., a group of symbols are symbols of a CDM group). In one example, the CBT-RS symbols or groups of symbols are consecutive. In one example, the CBT-RS symbols or groups of symbols are non-consecutive. In one example, the CBT-RS occur in both symbols and groups of symbols. In one example, CBT-RS allocated to both CBT-RS symbols or groups of symbols are allocated the same frequency. In one example, the frequency allocation of each CBT-RS symbol or group of symbols is split into three frequency bands, as illustrated in FIG. 36C:
In one example, frequency band 0 is allocated to CBT-RS1 in CBT-RS symbol 0 or symbol group 0 and CBT-RS symbol 1 or symbol group 1.
In one example, frequency band 1 is allocated to CBT-RS2 in CBT-RS symbol 0 or symbol group 0 and CBT-RS symbol 1 or symbol group 1.
In one example, frequency band 2 is allocated to CBT-RS3 in CBT-RS symbol 0 or symbol group 0 and CBT-RS symbol 1 or symbol group 1.

In yet another example, there are two CBT-RS symbols or groups of symbols (e.g., a group of symbols are symbols of a CDM group). In one example, the CBT-RS symbols or groups of symbols are consecutive. In one example, the CBT-RS symbols or groups of symbols are non-consecutive. In one example, the CBT-RS occur in both symbols and groups of symbols. In one example, CBT-RS allocated to both CBT-RS symbols or groups of symbols can be allocated different frequencies (e.g., hopping between the first symbol or group of symbols and the second symbol or group of symbols). In one example, the frequency allocation of each CBT-RS symbol is split into three frequency bands, as illustrated in FIG. 36D:
In one example, frequency band 0 is allocated to CBT-RS1 in CBT-RS symbol 0 or symbol group 0 and frequency band 0 is allocated to CBT-RS2 in CBT-RS symbol 1 or symbol group 1.
In one example, frequency band 1 is allocated to CBT-RS3 in CBT-RS symbol 0 or symbol group 0 and frequency band 1 is allocated to CBT-RS1 in CBT-RS symbol 1 or symbol group 1.
In one example, frequency band 2 is allocated to CBT-RS2 in CBT-RS symbol 0 or symbol group 0 and frequency band 0 is allocated to CBT-RS3 in CBT-RS symbol 1 or symbol group 1.

In a variant of the aforementioned examples, the number of frequency bands can be N. In one example, N=2. In one example, N=1 (e.g., one CBT-RS per OFDM symbol).

In the aforementioned mentioned: CBT-RS1 uses TCI state 1 or spatial domain filter 1 or spatial relation 1, CBT-RS2 uses TCI state 2 or spatial domain filter 2 or spatial relation 2, CBT-RS3 uses TCI state 3 or spatial domain filter 3 or spatial relation 3, CBT-RS4 uses TCI state 4 or spatial domain filter 4 or spatial relation 4, and CBT-RS5 uses TCI state 5 or spatial domain filter 5 or spatial relation 5.

In another example of the aforementioned examples of FIGS. 36A-36D, the CBT-RS can have a physical signal structure similar to the physical signal structure of CSI-RS. In one example of the aforementioned examples of FIGS. 36A-36D, the CBT-RS can have a physical signal structure similar to the physical signal structure of DM-RS. In another example of the aforementioned examples of FIGS. 33A-33D, the CBT-RS can have a physical signal structure similar to the physical signal structure of SRS.

In one example, within respective frequency bands, one or more CDM groups are used for respective CBT-RS. In one example, there is one or more CSI-RS symbols wherein the entire frequency allocation of the CSI-RS symbol is used for CSI-RS, wherein TCI state 0 or spatial domain filter 0. In one example, for symbols used for data transmission (e.g., for transmitting PDSCH), TCI state 0 or spatial relation 0 is used. In aforementioned, example, TCI state 0 or spatial relation 0, is the TCI state or spatial relation of the main beam. TCI state 1 . . . M, or spatial relation 1 . . . M, is the TCI state or spatial relation of the 1^{st}, . . . Mth beam respectively.

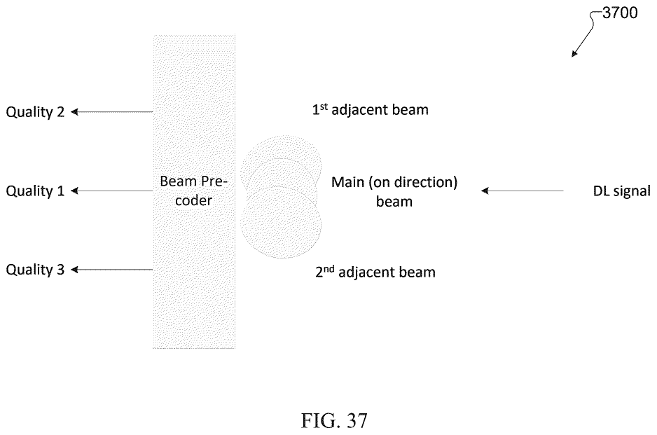

FIG. 37 illustrates an example of DL channel or signal reception 3700 using multiple spatial domain reception filters according to embodiments of the present disclosure. For example, the DL channel or signal reception 3700 may be made by a UE, such as, UE 116 in FIG. 1. This example is for illustration only and other embodiments can be used without departing from the scope of the present disclosure.

Various embodiments of the present disclosure provide for DL reception on multiple beams. In one example, the base station transmits a DL channel or a DL signal. The UE can receive the DL channel or the DL signal using multiple spatial domain reception filters to identify a best receive as illustrated in FIG. 37. For example, the DL signal can be DM-RS or CSI-RS or BT-RS or CBT-RS, and the UE receives the DL signal using a first spatial domain reception filter (e.g., main beam used for reception of DL channels) and determines a first quality of the DL signal, and the UE receives the DL signal using a second spatial domain reception filter (e.g., first adjacent beam) and determines a second quality of the DL signal, and the UE receives the DL signal using a third spatial domain reception filter (e.g., second adjacent beam) and determines a third quality of the DL signal.

Based on a comparison of the first quality, second quality, third quality, the UE decides whether or not to switch the main spatial domain reception filter to one of the adjacent spatial domain filters. A quality can be referencing signal received power (RSRP), signal to interference and noise ratio (SINR), etc. the quality can be an instantaneous value or an averaged value (e.g., sliding window or long term average).

Various embodiments of the present disclosure provide for signaling between UE and BS. In one example, a BS transmits a first DL signal and N second DL signal(s). In one example, the first DL signal is DM-RS, and the N second DL signal(s) are BT-RS as aforementioned. In one example, the first DL signal is CSI-RS, the N second DL signal(s) are CBT-RS as aforementioned. In one example, the first DL signal is transmitted using a first spatial domain filter (e.g., associated with a first TCI state). The N second DL signal(s) are transmitted using a second, third, . . . , (N+1)th spatial domain filter(s) respectively, (e.g., associated with a second, third, . . . , (N+1)th TCI state(s), respectively).

In one example, the first DL signal and N second DL signals(s) are associated by RRC signaling as aforementioned.

In one example, N second DL signals are activated by MAC CE and/or RRC and/or L1 control (e.g., DCI Format) signaling.

In one example, resources for N second DL signals are configured, e.g., resources for N BT-RS or resources for N CBT-RS. In one example, each BT-RS or CBT-RS is transmitted in a separate OFDM symbol.

In one example, the UE measures a signal quality associated with the first DL signal and each of the second N DL signals. In one example, the UE measures a signal quality associated with each of the second N DL signals. In one example, the measured quality is reference signal received power (RSRP) (e.g., L1-RSRP). In one example, the measured quality is signal-to-interference-and-noise ratio (SINR), e.g., L1-SINR. In one example, the UE uses the instantaneous value of the measured quality. In one example, the UE uses an averaged value of the measured quality. In one example, the average is a sliding window average, e.g., an average of the most recent K instantaneous measurements. In one example, the measured quality is an exponential average, e.g., average quantity after instance n=α*(instantaneous quantity of instance n)+(1−α)*(average quantity after instance n−1). Alternatively, average quantity after instance n=(1−α)*(instantaneous quantity of instance n)+α*(average quantity after instance n−1).

In one example, the network can indicate to the UE to reset the average quantity (e.g., to ignore previously averaged value and starting calculating the averaged quantity using the new measurements). For example, the network can indicate to the UE to reset the measurements, when the transmission parameters of the DL signal(s), e.g., spatial filters, change. In one example, a UE can reset the average quantity, when it is indicated and/or applies a new TCI state.

In one example, the UE uses a measured quantity (instantaneous or average) to determine a report to the network. In one example, the report to network is transmitted if one or more of the following occurs:
The measured quantity associated with one or more of the second DL signals is above a threshold (or equal to or above a threshold).
The measured quantity associated with the first DL signals is below (or equal to or below) a threshold.
The measured quantity associated with one or more of the second DL signals is above a first threshold (or equal to or above a threshold); and the measured quantity associated with the first DL signal is below (or equal to or below) a second threshold. In one example, the first threshold and the second threshold can be different. In one example, the first threshold and the second threshold are the same threshold.
The difference (e.g., in dB or dBm) between the measured quality (Q₂) associated with one or more of the second DL signals and the measured quality associated with the first DL signal (Q₁), is above a threshold (or equal to or above a threshold Th). i.e., D=Q₂−Q₁>Th or D=Q₂−Q₁≥Th, where D can be evaluated for each second DL signal.
The difference (e.g., in dB or dBm) between the measured quality (Q₂) associated with one or more of the second DL signals and the measured quality associated with the first DL signal (Q₁), is above (or equal to or above) a first threshold Th; and the measured quantity associated with the corresponding second DL signals is above (or equal to or above) a second threshold.
The difference (e.g., in dB or dBm) between the measured quality (Q₂) associated with one or more of the second DL signals and the measured quality associated with the first DL signal (Q₁), is above (or equal to or above) a first threshold Th; and the measured quantity associated with the first DL signal is below (or equal to or below) a second threshold.
The difference (e.g., in dB or dBm) between the measured quality (Q₂) associated with one or more of the second DL signals and the measured quality associated with the first DL signal (Q₁), is above (or equal to or above) a first threshold Th; and at least one of (1) the measured quantity associated with the corresponding second DL signals is above (or equal to or above) a second threshold; or (2) the measured quantity associated with the first DL signal is below (or equal to or below) a third threshold. In one example, the second threshold and the third threshold can be different. In one example, the second threshold and the third threshold are the same threshold.
The difference between the measured quality (Q₂) associated with one or more of the second DL signals and the measured quality associated with the first DL signal (Q₁), is above (or equal to or above) a first threshold Th; and the measured quantity associated with the corresponding second DL signals is above (or equal to or above) a second threshold; and the measured quantity associated with the first DL signal is below (or equal to or below) a third threshold. In one example, the second threshold and the third threshold can be different. In one example, the second threshold and the third threshold are the same threshold.

In the above examples, the threshold, or the first threshold or the second threshold or the third threshold can be configured and/or updated by SIB and/or RRC and/or MAC CE and/or L1 control (e.g., DCI Format) signaling.

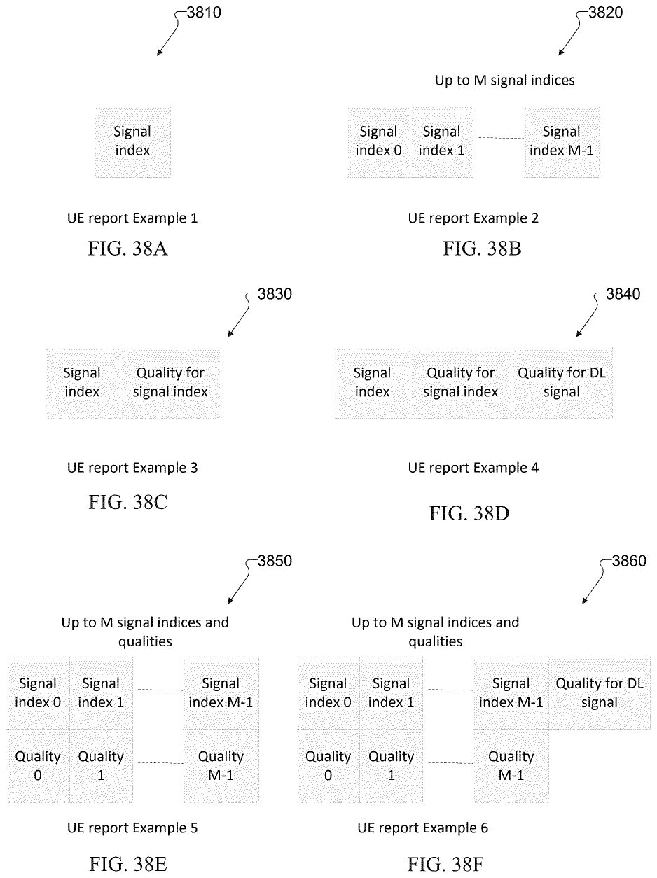

FIGS. 38A-38F illustrate examples of UE reports 3810, 3820, 383, 3840, 3850, and 3860 according to embodiments of the present disclosure. For example, the reports may be made by a UE, such as, UE 116 in FIG. 1. This example is for illustration only and other embodiments can be used without departing from the scope of the present disclosure.

In one example, the UE can report one or more of the following:
The index of a signal, as illustrated in FIG. 38A. In one example, the signal can be the first signal or one of the second N DL signals, e.g., this can be indicated by a field of size ┌log₂(N+1)┐. In one example, the signal can be one of the second N DL signals, e.g., this can be indicated by a field of size ┌log₂ N┐. In one example, the indicated signal is a signal with the largest quality. In one example, the indicated signal is a signal with a quality above (or above or equal to) a threshold (e.g., the UE can select from any of such signals)—condition A. In one example, the indicated signal is a signal with a quality higher than (or higher than or equal to) the quality of the first signal by a threshold (e.g., the UE can select from any of such signals)—condition B, in a variant example such a threshold is 0. In one example, the indicated signal is a signal that satisfies at least one of condition A or condition B. In one example, the indicated signal is a signal that satisfies both condition A and condition B.
In one example, the UE can indicate the multiple indices, as illustrated in FIG. 38B. For example, the UE can indicate M or up to M indices. In one example, the M indices can be from first signal or second N DL signals. In one example, the M indices can be from second N DL signals. In one example, the M indices can be arranged in order of quality, e.g., from highest quality to lowest quality of signals of the M indices, or vice versa, e.g., from lowest quality to highest quality of signals of the M indices. In one example, the M indices can be arranged regardless of quality of the M indices. In one example, the indicated M indices correspond to signals with the largest M signal qualities. In one example, the indicated indices correspond to signals is with a signal quality above (or above or equal to) a threshold (e.g., the UE can select from any of such signals)—condition A. In one example, the indicated M indices correspond to signals with signal qualities higher than (or higher than or equal to) the quality of the first signal by a threshold (e.g., the UE can select from any of such signals)—condition B, in a variant example such a threshold is 0. In one example, the indicated M indices satisfy at least one of condition A or condition B. In one example, the indicated M indices satisfy both condition A and condition B. In one example, M can be specified in the system specifications and/or configured and/or updated by SIB, RRC, MAC CE and/or L1 control (e.g., DCI Format) signaling.
In one example, the UE report can include a signal index, according to the aforementioned examples, and a quality value corresponding to the signal index, as illustrated in FIG. 38C. In one example, the quality value is the RSRP (e.g., L1-RSRP or L3-RSRP) corresponding to the indicated signal index in dBm, e.g., value can be represented by a X1-bit value, in increments of Y1 dB in the range [A1, B1] dBm (e.g., absolute reporting of RSRP). In one example, X1=7 bits, Y1=1 dB, A1=−140 dBm, and B1=−44 dBm. In one example, the quality value is the difference of RSRP of the indicated signal index and the RSRP of the first DL signal, the value can be indicated in dB, e.g., value can be represented by a X2-bit value, in increments of Y2 dB in the range [A2, B2] dB (e.g., differential reporting of RSRP), or the negative of such value. In one example, X2=4 bits, Y2=2 dB, A2=0 dB, and B2=30 dB. In one example, the quality value is the SINR (e.g., L1-SINR or L3-SINR) corresponding to the indicated signal index in dB, e.g., value can be represented by a X3-bit value, in increments of Y3 dB in the range [A3, B3] dB (e.g., absolute reporting of SINR). In one example, X3=7 bits, Y3=0.5 dB, A3=−23 dB, and B3=40 dB. In one example, the quality value is difference of the SINR of the indicated signal index and the SINR of the first DL signal, the value can be indicated in dB, e.g., value can be represented by a X4-bit value, in increments of Y4 dB in the range [A4, B4] dB (e.g., differential reporting of SINR), or the negative of such value. In one example, X4=4 bits, Y4=1 dB, A4=0 dB, and B4=15 dB. In one example, the quality can be CQI or MCS or BLER corresponding to the indicated signal index (e.g., absolute reporting of CQI or MCS or BLER). In one example, the quality value is the difference of the CQI or MCS or BLER of the indicated signal index and the CQI or MCS or BLER of the first DL signal, (e.g., differential reporting of CQI or MCS or BLER), or the negative of such value.
In one example, the UE report can include a signal index, according to the aforementioned examples, and a quality value corresponding to the signal index, and a quality value corresponding to the first DL signal, as illustrated in FIG. 38D. In one example, the quality value is RSRP, e.g., L1-RSRP or L3-RSRP, (absolute or differential). In one example, the quality value is SINR, e.g., LL1-SINR or L3-SINR, (absolute or differential). In one example, the quality value is CQI or MCS or BLER (absolute or differential). In one example, the quality corresponding to the signal index is absolute as aforementioned, and the quality corresponding to the first DL signal is absolute as aforementioned. In one example, the quality corresponding to the signal index is differential, e.g., relative to the quality of the first DL signal as aforementioned, and the quality corresponding to the first DL signal is absolute as aforementioned. In one example, the quality corresponding to the signal index is absolute as aforementioned, and the quality corresponding to the first DL signal is differential, e.g., relative to the quality of the signal index as aforementioned.
In one example, the UE report can include M or up to M signal indices, according to the aforementioned examples, and corresponding M or up to M qualities, as illustrated in FIG. 38E. In one example, the quality value is RSRP, e.g., L1-RSRP or L3-RSRP, (absolute or differential). In one example, the quality value is SINR, e.g., L1-SINR or L3-SINR, (absolute or differential). In one example, the quality value is CQI or MCS or BLER (absolute or differential). In one example, the M (or up to M) qualities corresponding to the M (or up to M) signal indices are absolute as aforementioned. In one example, the M (or up to M) qualities corresponding to the M (or up to M) signal indices are differential (e.g., relative to the quality corresponding to the first DL signal) as aforementioned. In one example, the quality of one of M (or up to M) qualities is absolute as aforementioned, and the qualities of the remaining M−1 (or up M−1) is differential (e.g., relative to the reported absolute quality) as aforementioned, in one example the one of M (or up to M) corresponds to the signal index with the largest (or smallest) quality. In one example, the quality of one of M (or up to M) qualities is differential (e.g., relative to quality of the first DL signal) as aforementioned, and the qualities of the remaining M−1 (or up M−1) is differential (e.g., relative to the reported differential quality that is relative to the quality of the first DL signal) as aforementioned, in one example the one of M (or up to M) corresponds to the signal index with the largest (or smallest) quality.
In one example, the UE report can include M or up to M signal indices, according to the aforementioned examples and corresponding M or up to M qualities, and a quality value corresponding to the first DL signal, as illustrated in FIG. 38F. In one example, the quality value is RSRP, e.g., L1-RSRP or L3-RSRP, (absolute or differential). In one example, the quality value is SINR, e.g., L1-SINR or L3-SINR, (absolute or differential). In one example, the quality value is CQI or MCS or BLER (absolute or differential). In one example, the M (or up to M) qualities corresponding to the M (or up to M) signal indices are absolute as aforementioned, and the quality corresponding to the first DL signal is absolute as aforementioned. In one example, the M (or up to M) qualities corresponding to the M (or up to M) signal indices are differential, e.g., relative to the quality of the first DL signal as aforementioned, and the quality corresponding to the first DL signal is absolute as aforementioned. In one example, the quality of one of M (or up to M) qualities is absolute as aforementioned, and the qualities of the remaining M−1 (or up M−1) is differential (e.g., relative to the reported absolute quality) as aforementioned, and the quality corresponding to the first DL signal is differential (e.g., relative to the reported absolute quality) as aforementioned, in one example the one of M (or up to M) corresponds to the signal index with the largest (or smallest) quality. In one example, the quality of one of M (or up to M) qualities is differential (e.g., relative to quality of the first DL signal) as aforementioned, and the qualities of the remaining M−1 (or up M−1) is differential (e.g., relative to the reported differential quality that is relative to the quality of the first DL signal) as aforementioned, and the quality corresponding to the first DL signal is absolute as aforementioned, in one example the one of M (or up to M) corresponds to the signal index with the largest (or smallest) quality.

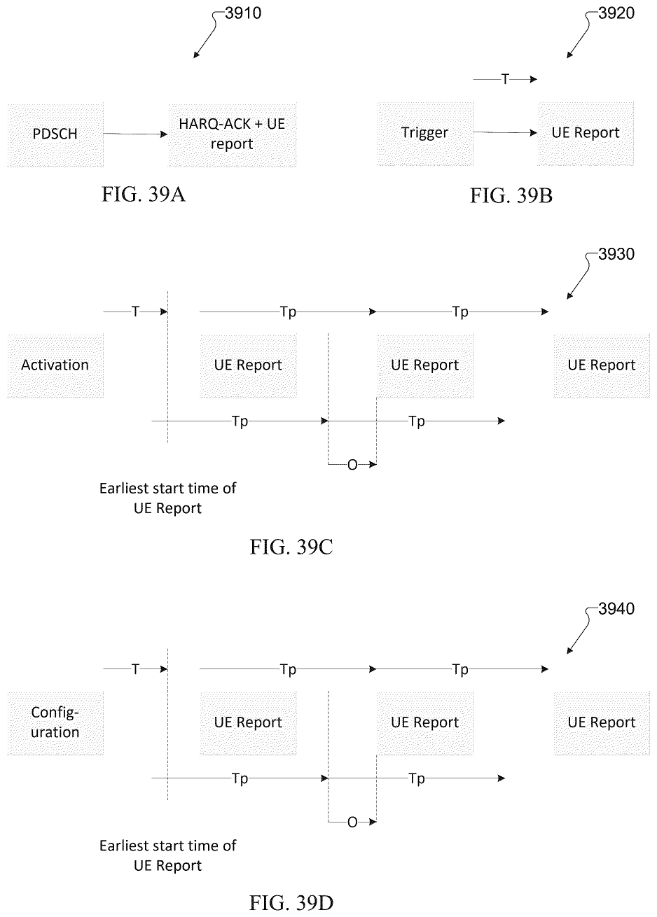

FIGS. 39A-39D illustrate examples of UE reporting 3910, 3920, 3930, and 3940 according to embodiments of the present disclosure. For example, the reporting may be made by a UE, such as, UE 116 in FIG. 1. This example is for illustration only and other embodiments can be used without departing from the scope of the present disclosure.

In one example, the UE report is included with HARQ-ACK feedback as illustrated in FIG. 39A. In one example, the UE report is included in a separate UCI message. In one example, the UE report can be aperiodic, e.g., the UE report can be dynamically triggered by L1 control (e.g., DCI Format) signaling, or by MAC CE signaling, or by RRC signaling as illustrated in FIG. 39B. In one example, the DCI Format is UE specific. In one example, the DCI Format is to a group of UEs (e.g., group common DCI). In one example, the triggering signaling can provide information related to the structure of the report, e.g., the value of M, whether to include qualities of M signals in report, whether to include quality of DL signal in report, information about absolute or relatively quality reporting, type of quality to report, e.g., RSRP and/or SINR and/or CQI and/or MCS and/or BLER. In one example, some or all of the aforementioned parameters can be specified in the specifications and/or configured or updated by higher layer signaling. In one example, the time from the trigger (e.g., DCI Format or MAC CE or RRC message) and the transmission of the report is T, as illustrated in FIG. 39B. In one example, T can be from start of signal carrying trigger to start of signal carrying UE report. In one example, T can be from end of signal carrying trigger to start of signal carrying UE report, as illustrated in FIG. 39B. In one example, T can be from start of signal carrying trigger to end of signal carrying UE report. In one example, T can be from end of signal carrying trigger to end of signal carrying UE report. In one example, T is indicated in the trigger signal. In one example, T is specified in the system specification and/or configured or updated by higher layer signaling.

In one example, the UE report is included in a separate UCI message. In one example, the UE report can be semi-persistent, e.g., the UE report can be dynamically activated by L1 control (e.g., DCI Format) signaling, or by MAC CE signaling, or by RRC signaling as illustrated in FIG. 39C. In one example, the DCI Format is UE specific. In one example, the DCI Format is to a group of UEs (e.g., group common DCI). After activation, the UE report is transmitted periodically with a period, Tp, and a slot offset, O, within the period until it is deactivated. In one example, the activation signaling can provide information related to the structure of the report, e.g., the value of M, whether to include qualities of M signals in report, whether to include quality of DL signal in report, information about absolute or relatively quality reporting, type of quality to report, e.g., RSRP and/or SINR and/or CQI and/or MCS and/or BLER, information about period Tp and offset O within the period. In one example, some or all of the aforementioned parameters can be specified in the specifications and/or configured or updated by higher layer signaling. In one example, the time from the activating (e.g., DCI Format or MAC CE or RRC) message and the earliest transmission of the report is T, as illustrated in FIG. 39C. In one example, T can be from start of signal carrying activation to earliest possible start of signal carrying UE report. In one example, T can be from end of signal carrying activation to earliest possible start of signal carrying UE report, as illustrated in FIG. 39C. In one example, T can be from start of signal carrying activation to earliest possible end of signal carrying UE report. In one example, T can be from end of signal carrying activation to earliest possible end of signal carrying UE report. In example, T can be the start or end of the signal carrying the activation and the start of period containing the first instance (e.g., time O before start of first instance) of the UE report. In one example, T+O can be from start or end of signal carrying activation to earliest possible start (e.g., first instance) of signal carrying UE report. In one example, T and/or O is indicated in the activation signal. In one example, T and/or O is specified in the system specification and/or configured or updated by higher layer signaling.

In one example, the UE report is included in a separate UCI message. In one example, the UE report can be periodic, e.g., the UE report can be configured by MAC CE signaling, or by RRC signaling as illustrated in FIG. 39D. After configuration, the UE transmitted periodically with a period, Tp, and a slot offset, O, within the period until it is de-configured or re-configured with new parameters. In one example, the configuration signaling can provide information related to the structure of the report, e.g., the value of M, whether to include qualities of M signals in report, whether to include quality of DL signal in report, information about absolute or relatively quality reporting, type of quality to report, e.g., RSRP and/or SINR and/or CQI and/or MCS and/or BLER, information about period Tp and offset O within the period. In one example, some or all of the aforementioned parameters can be specified in the specifications and/or configured or updated by separate higher layer signaling. In one example, the time from the configuration (e.g., MAC CE or RRC) message and the earliest transmission of the report is T, as illustrated in FIG. 39D. In one example, T can be from start of signal carrying configuration to earliest possible start of signal carrying UE report. In one example, T can be from end of signal carrying configuration to earliest possible start of signal carrying UE report, as illustrated in FIG. 39D. In one example, T can be from start of signal carrying configuration to earliest possible end of signal carrying UE report. In one example, T can be from end of signal carrying configuration to earliest possible end of signal carrying UE report. In example, T can be the start or end of the signal carrying the configuration and the start of period containing the first instance (e.g., time O before start of first instance) of signal carrying UE report. In one example, T+O can be from start or end of signal carrying configuration to earliest possible start (e.g., first instance) of signal carrying UE report. In one example, T and/or O is indicated in the configuration signal. In one example, T and/or O is specified in the system specification and/or configured or updated by higher layer signaling (e.g., in a separate message).

In one example, after the BS receives the UE report, the BS can update the TCI state based on the UE report following the unified TCI state framework. For example, an updated TCI state is signaled to the UE in a DL related DCI Format (with or without DL assignment) or in an UL related DCI Format (with or without UL grant), or in a purpose designed DCI format for TCI state indication, or in a purpose designed channel for TCI state indication.

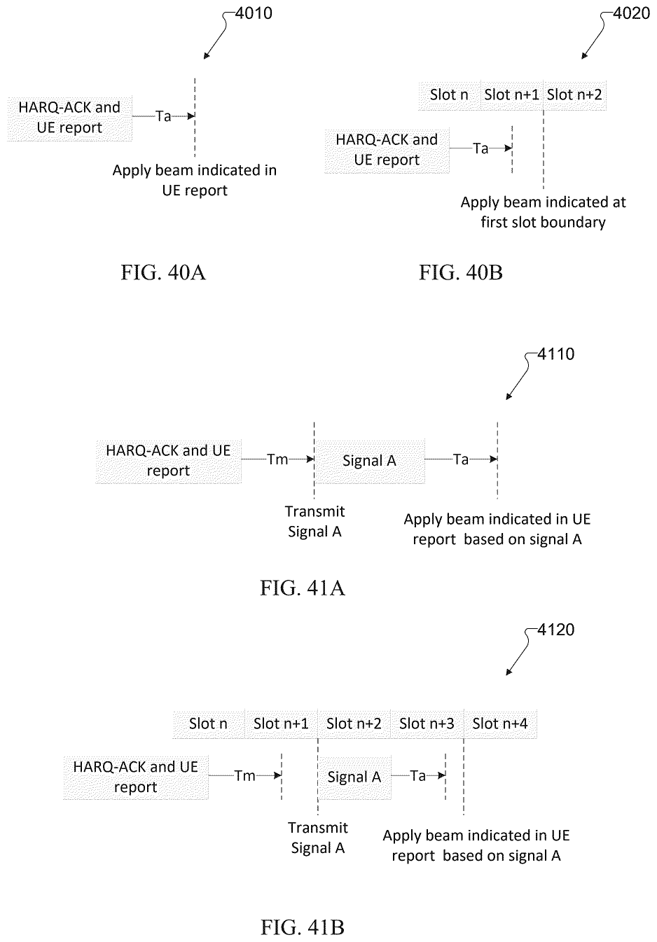

In one example, the HARQ-ACK report can include a UE report indicating a signal index as described in FIG. 39A and FIG. 40A. In one example, after a time Ta from the UE report, as illustrated in FIGS. 40A and 40B, the UE and BS can apply a TCI state or spatial domain filter or beam associated with the indicated signal index. In one example, the BS and UE apply a TCI state or spatial domain filter or beam associated with the indicated signal index starting at time Ta from the (start or end) UE of report as illustrated in FIG. 40A. In one example, the BS and UE apply a TCI state or spatial domain filter or beam associated with the indicated signal index starting at start of a slot or time unit or sub-frame or frame starting at or after a time Ta from the (start or end) UE of report as illustrated in FIG. 40B.

FIGS. 40A-40B illustrate examples of UE reporting 4010 and 4020 according to embodiments of the present disclosure. For example, the reporting may be made by a UE, such as, UE 116 in FIG. 1. This example is for illustration only and other embodiments can be used without departing from the scope of the present disclosure.

In one example, the HARQ-ACK report can include a UE report indicating a signal index as described in FIG. 39A and FIG. 40A. In one example, after a time Tm from the UE report, as illustrated in FIGS. 41A and 41B, the BS can send a signal A (e.g., using a DL signal or a DL channel or DCI format to indicate (acknowledge) the reception of the UE report for the UE. In one example, the DCI Format is UE specific. In one example, the DCI Format is to a group of UEs (e.g., group common DCI). In one example, the signal can indicate whether the beam will be applied or not.

FIGS. 41A-41B illustrate examples of UE reporting 4110 and 4120 according to embodiments of the present disclosure. For example, the reporting may be made by a UE, such as, UE 116 in FIG. 1. This example is for illustration only and other embodiments can be used without departing from the scope of the present disclosure.

In one example, signal A is transmitted a time Tm from the start or end of the signal caring the UE report, as illustrated in FIG. 41A. In one example, signal A is transmitted starting at start of a slot or time unit or sub-frame or frame starting at or after a time Tm from the (start or end) of the UE report as illustrated in FIG. 41B. In one example, if the UE acknowledges the UE report or if the UE indicates the signal index in the beam report will be applied, the BS and UE apply a TCI state or spatial domain filter or beam associated with the indicated signal index. In one example, the BS and UE apply a TCI state or spatial domain filter or beam associated with the indicated signal index starting at time Ta from the (start or end) signal A as illustrated in FIG. 41A. In one example, the BS and UE apply a TCI state or spatial domain filter or beam associated with the indicated signal index starting at start of a slot or time unit or sub-frame or frame starting at or after a time Ta from the (start or end) signal A as illustrated in FIG. 41B. In a variant example, signal A can be transmitted at a slot boundary and the beam can be applied at any time Ta from signal. In a variant example, signal A can be transmitted at any time Tm from the UE report, and the beam can be applied at a slot boundary.

In a variant example of the examples of FIGS. 40A-41B, the UE report can be transmitted without HARQ-ACK, as illustrated in FIG. 38A/38B, FIG. 38C/38D, and FIG. 38E/38F. The UE and BS can apply the TCI state at a time Ta from the UE report or from signal A or from the start of the slot/time-unit/sub-frame/frame starting at or after time Ta from the UE report or signal A. The BS can transmit a signal A after at a time Tm from the UE report or from the start of the slot/time-unit/sub-frame/frame starting at or after time Tm from the UE report.

In a variant example of the examples of FIGS. 41A-41B, a UE report can include M signal indices, as aforementioned, and signal A can indicate one of the M signals included in the UE report. In one example, the size of the field in signal A can be ┌log₂ M┐. In another example, signal A can include an indication code point for beam not changed, hence the size of the field in signal A can be ┌log₂(M+1)┐. In one example, the UE report is transmitted with HARQ-ACK following the examples of this disclosure. In one example, the UE report is transmitted without HARQ-ACK following the examples of this disclosure.

Embodiments of the present disclosure also recognize that a current NR/5G primary focus on communications on the wireless network exists. The wireless systems for sensing, such as Radar applications, may occur. However, until recently sensing and communication systems have been regarded as separate systems. Embodiments of the present disclosure recognize the usefulness of integrating sensing into communication-based wireless networks, as it allows the offer of new services and applications. The integration of sensing into wireless networks used for communication is a new feature or capability known as integrated sensing and communications (ISAC), or joint sensing and communications (JSAC).

The objective of sensing is to able to detect and track target objects in the surrounding environment such as unmanned aerial vehicles (UAVs), humans indoors or outdoors, automotive vehicles, automated guided vehicles (AGV) e.g., on factory floors, and objects causing hazards on the highways and railways.

To address these needs for ISAC, 3GPP has undertaken a study on channel modeling for ISAC for NR [RP-234069], the primary focus of the study is on frequency ranges from 0.5 to 52 GHz, with the assumption that the modeling approach can scale to 100 GHz. The study builds on the use cases identified for ISAC by 3GPP SA groups in TR22.837.

In sensing, a transmitter transmits a sensing signal, known as the sensing transmitter, the sensing signal interacts with the target object(s) as well as other environment or background object(s), and is received by a receiver known as the sensing receiver. With knowledge of the transmitted sensing signal and the received sensing signal, the system can identify, detect and/or track the target object(s). The sensing transmitter and the sensing receiver can be in a same device, which is known as mono-static sensing. Alternatively, the sensing transmitter and the sensing receiver can be in different devices, which is known as bi-static sensing. There can be multiple sensing transmitters and/or sensing receivers which known as multi-static sensing.

There are 6 sensing modes: (1) TRP—TRP bi-static sensing, (2) TRP mono-static sensing, (3) TRP-UE bi-static sensing, (4) UE-TRP bi-static sensing, (5) UE-UE bi-static sensing, and (6) UE mono-static sensing.

The 3GPP study item in [RP-234069] is to identify deployment scenarios for the above use cases, and define channel modeling details for sensing.

In one example the target frequency ranges of sensing is mmWaves, where ample spectrum is available for signals with large bandwidth with can provide high-accuracy target estimation for sensing and high-throughput low-latency traffic for communications. In mmWaves, the spatial domain can be leverage for sensing and for communications. Embodiments of the present disclosure provide a beam-based ISAC system where different beams can be used for sensing and for communications. Embodiments of the present disclosure provide design aspects for such beams, as well as interference mitigation of the sensing signal and the communications signal.

Integrated sensing and communications (ISAC) is envisioned to be one of the enabling technologies in 6G, being able to use shared hardware for sensing of the environment as well as communications. A variety of applications benefits from ISAC, such as smart roads, smart factories, unmanned aerial vehicles (UAVs), etc. Sensing allows accurate awareness of position and velocity of objects in the environment, while communications, with high throughput, hyper-reliability and/or low latency allows for information sharing between devices and joint decision making. This motivates the need to support ISAC in a cost and spectrum efficient manner, while meeting the individual requirements of sensing and communications.

Different ISAC schemes have been proposed for future wireless networks. In schemes with separate signaling, different resources are used for sensing and communications, for example, different time and/or frequency resources can be used for sensing and communications, the transmission characteristics of the signal (e.g., waveform) can be optimized for the target scenario (sensing or communications). Alternatively, schemes with shared signaling, shared time/frequency resources are used for sensing and communication, resulting in more efficient spectrum utilization, however, the signal is jointly designed to meet the sensing and communication requirements, which can result in sub-optimal sensing/communication performance.

To achieve accurate localization and speed estimation for sensing, and high-throughput for communications, signals with large bandwidth can be utilized. These signals typically operate in high frequency regions (e.g., mmWaves), where spectrum is available to support large bandwidth signals. Operation in mmWave depends heavily on beam-based operation. The signal is beam-formed in the intended direction of travel for transmitters, or in the intended direction of reception for receivers to overcome higher pathloss at higher frequencies. Beam-forming also mitigates interference, by avoiding transmissions in directions where the signal is not intended to go and can cause interference, and avoiding receptions in directions where the signal is not expected to arrive from and suppress interferers in those directions.

ISAC system operating in high frequency region (e.g., mmWaves), can leverage the spatial domain when transmitting signals for sensing and for communications. In this disclosure, a structure for multi-beam ISAC, where a transceiver can transmit or receiver sensing and communication signals on different beams is provided. Mechanisms to mitigate interference between the sensing and communication beams are also provided.

This disclosure provides aspects related transmission of sensing and communication signals for ISAC. A multi-beam system is used, where the sensing signal is transmitted on a first beam and the communication signal is transmitted on a second beam. This disclosure provides:
Mitigation of interference causes by sensing on the communication signal, including measuring the sensing signal interference and cancelling it out, or using the sensing signal to carry the communication information to provide an additional path for the communication signal.
Determining the power of the communication signal and the sensing signal.

In this disclosure, device can refer to UE or BS/base station/TRP.

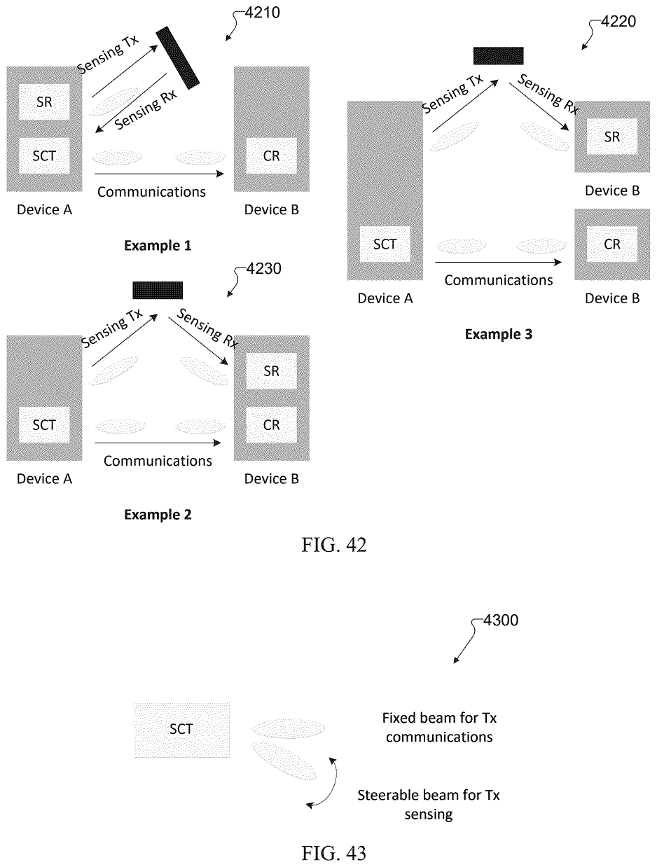

FIG. 42 illustrates examples of components for an integrated sensing and communications system according to embodiments of the present disclosure. For example, the devices in the integrated sensing and communications system may be UEs, TRPs, and/or BSs, such as, UE 116 and BS 102 in FIG. 1. This example is for illustration only and other embodiments can be used without departing from the scope of the present disclosure

An integrated sensing and communications system can have three components:
A shared transmitter transmitting a communication and sensing signal(s), denoted as SCT.
A sensing receiver to receive the signal and sense the environment, denoted as SR.
A communication receiver to receive the signal for communication purposes, denoted as CR.

The ISAC system can have different configurations:
In one example, as illustrated in 4210, the sensing and communications transmitter (SCT) is in the same device as the sensing receiver (SR). This is an example of mono-static sensing.
In another example, as illustrated in 4230, the sensing receiver (SR) and communications receiver (CR) are in the same device. This is an example of bi-static sensing.
In another example, as illustrated in 4220, each of the sensing and communications transmitter (SCT), the sensing receiver (SR) and the communications receiver (CR) is in its own device. This is an example of bi-static sensing.

FIG. 43 illustrates an example SCT 4300 according to embodiments of the present disclosure. For example, the SCT 4300 may be implemented in a device such as a UE, TRP, and/or BS, such as, for example, UE 116 and BS 102 in FIG. 1. This example is for illustration only and other embodiments can be used without departing from the scope of the present disclosure. In one example, the SCT 4300 has an antenna array that can transmit on two beams (e.g., 2 main lobes). A first beam can be used for sensing, and this beam has a steerable direction as illustrated in FIG. 43. A second beam can be used for communications. This beam has a fixed beam direction or spatial relation. The beam direction or spatial relation is determined based on device receiving the communication signal.

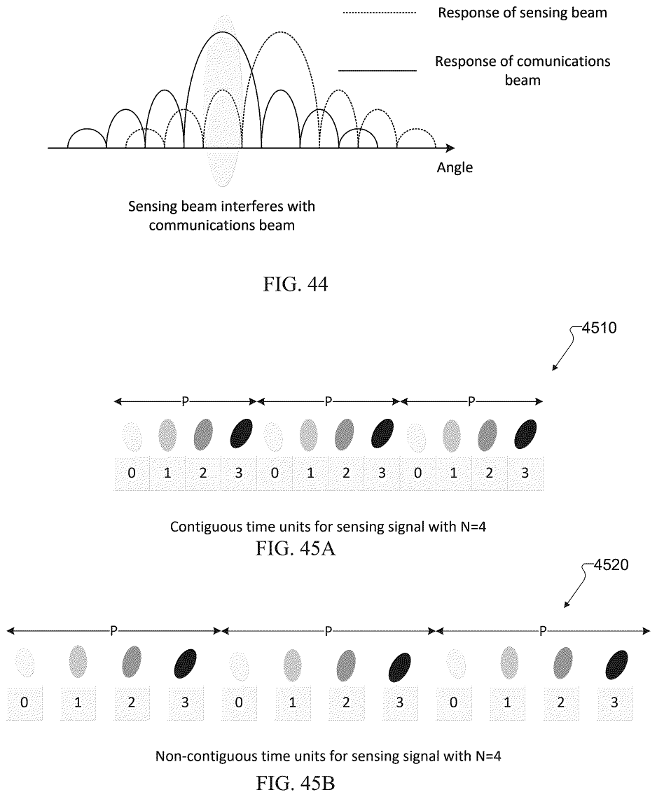

FIG. 44 illustrates an example sensing and communication beam interference according to embodiments of the present disclosure. This example is for illustration only and other embodiments can be used without departing from the scope of the present disclosure.

In one example, a slide lope of the first beam can interfere with the main lobe of the second beam as illustrated in FIG. 44, if the second beam is used for communication, the signal transmitted on the first beam can interfere with the communication signal transmitted on the second beam. Not only does the sensing beam interfere with the communications beam, but the fact that the sensing beam is steerable, i.e., changeable, makes the interference change over time.

Various embodiments of the present disclosure mitigate the interference of the sensing beam on the communication beam. In one example, the signal transmitted on the first beam is a reference signal for sensing (e.g., referred to as the sensing signal), and the signal transmitted in the second beam is the communication signal (e.g., referred to as the communication signal). In one example, the reference signal for sensing is a pseudorandom sequence or Gold sequence, and the pseudorandom sequence or Gold sequence is initialized at least based on an ID of a beam (or spatial relation on transmission configuration indicator (TCI) state) used for sensing. In a variant example, the initialization of the sequence used for the sensing signal is based on the time-unit the sensing signal is transmitted in.

In one example, the receiving device of the communication signal is configured with one or more of the following:
Beam Pattern of sensing signal. For example, the pattern can include when a beam or spatial relation or TCI state is used. For example, a pattern can define by a periodicity, and pattern of beams or spatial relations or TCI states within each period, and the time the sensing signal dwells (or remains) in each beam.
Time and/or frequency resources used for sensing signal.

FIGS. 45A and 45B illustrate examples of beam patterns 4510 and 4520 for sensing signals according to embodiments of the present disclosure. For example, the beam patterns 4510 and 4520 may be utilized by a SCT, such as, SCT 4300 in FIG. 43. These examples are for illustration only and other embodiments can be used without departing from the scope of the present disclosure.

In one example, the sensing signal is configured with a period P. Within the period P, there are N time-units during which the sensing signal is transmitted. In one example, the N time-units are contiguous, e.g., cover the entire period P as illustrated in FIG. 45A. In one example, the time-units are not contiguous e.g., as illustrated in FIG. 45B. In one example, the time units repeat every period P. In one example, a same beam or spatial domain filter is used by the sensing transmitter in a time-unit of each period. For example, in time-unit 0, beam 0 or spatial domain filter 0 is used, in time-unit 1, beam 1 or spatial domain filter 1 is used, . . . , in time-unit N−1, beam N−1 or spatial domain filter N−1 is used as illustrated in FIG. 45A and FIG. 45B. The period P and/or the number of time-units N and/or the duration of a time-unit and/or the starting position of a time-unit (e.g., offset within a period) and/or bandwidth (e.g., number of RBs or sub-carriers) or sensing signal can be configured or updated by SIB and/or RRC and/or MAC CE and/or L1 control (e.g., DCI Format) signaling.

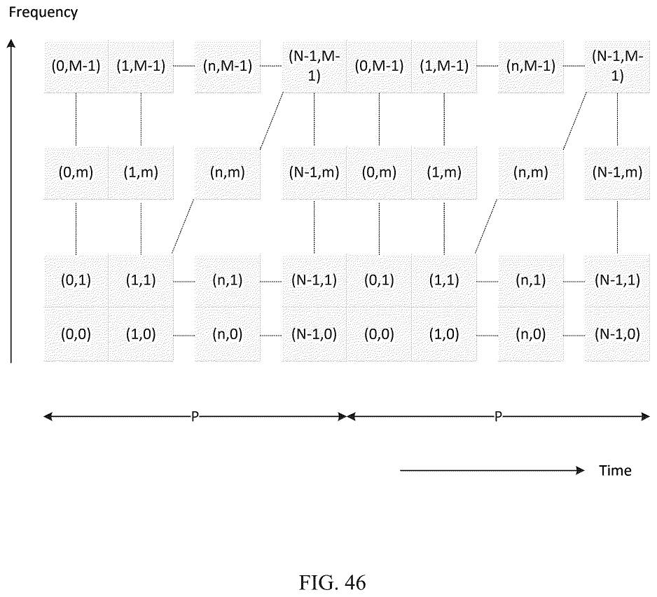

FIG. 46 illustrates an example transmission period for a sensing signal over time and frequency units according to embodiments of the present disclosure. For example, the sensing signal may be transmitted by a SCT, such as, SCT 4300 in FIG. 43. These examples are for illustration only and other embodiments can be used without departing from the scope of the present disclosure.

In a variant example, the sensing signal can be transmitted periodically with a period P over N time-units and M frequency units, as illustrated in FIG. 46, wherein for a time-unit n and a frequency-unit m, beam or spatial domain filter is used, the time-units and frequency units repeat every period P. Wherein n=0, 1, . . . N−1 and m=0, 1, . . . , M−1. In one example, the time-units are contiguous. In one example, the time-units are non-contiguous. In one example, the frequency units are contiguous. In one example, the frequency units are non-contiguous. The period P and/or the number of time-units N and/or the duration of a time-unit and/or the starting position of a time-unit (e.g., offset within a period) and/or number of frequency-units M and/or frequency span of frequency-unit and/or starting position of a frequency unit (e.g., offset with a bandwidth) and/or bandwidth of all frequency units can be configured or updated by SIB and/or RRC and/or MAC CE and/or L1 control (e.g., DCI Format) signaling.

In one example, the sensing receiver may assume time-units and/or time-unit/frequency-unit pairs with same index in different time periods have same transmit beam or spatial domain filter.

In one example, the device transmitting the sensing signal is a network (e.g., BS or TRP). The aforementioned information can be configured to receiving device (e.g., UE) by SIB signaling, e.g., cell common signaling can be used to broadcast information about sensing reference signal used in the cell. In another example, the aforementioned information can be configured to receiving device (e.g., UE) by RRC and/or MAC CE and/or L1 control (e.g., DCI Format) signaling.

In one example, the device transmitting the sensing signal is a UE. The aforementioned information can be configured to transmitting device (e.g., UE) by SIB and/or RRC and/or MAC CE and/or L1 control (e.g., DCI Format) signaling.

In one example, the devices receiving the communication signal (e.g., BS or UE) receives the configuration information of the sensing signal (e.g., sequence used, time and frequency resources). The device receiving the communication signal can estimate the interference caused by the sensing signal (e.g., this is calculated in each time-unit with a same sensing signal, or in each time-unit/frequency-unit pair with a same sensing signal). The device receiving the communication signal can cancel the interference caused by the sensing signal.

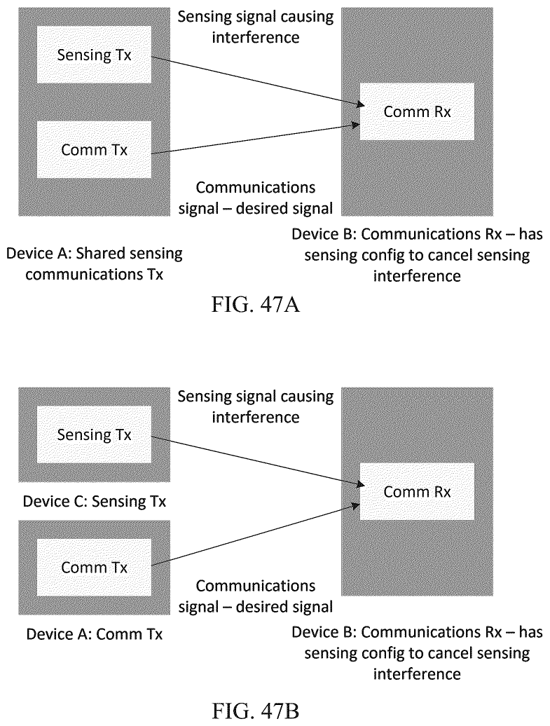

FIG. 47A illustrates an example of a sensing signal transmitted by the same device transmitting the communication signal according to embodiments of the present disclosure. FIG. 47B illustrates an example of the sensing signal and the communication signal transmitted from different devices according to embodiments of the present disclosure. These examples are for illustration only and other embodiments can be used without departing from the scope of the present disclosure.

In one example, the sensing signal can come for the same device transmitting the communication signal, as illustrated in FIG. 47A. In one example, the sensing signal and the communication signal are transmitted from different devices, as illustrated in FIG. 47B.

In one example, the same signal is transmitted on the first beam (sensing signal), e.g., used for sensing and on the second beam (communication signal). The communications signal with user's data information is also used for sensing and transmitted on the first beam (e.g., the beam used for used for sensing, e.g., the steerable beam). The device receiving the communications signal, can leverage the fact that the sensing signal also contains user's data combine the two signals (e.g., coherently) to improve the received signal SNR. The signal transmitted on the first beam (e.g., sensing signal) includes user's data and a first DMRS. The signal transmitted on the second beam (e.g., communication signal) includes user data and second DMRS. As the sensing signal can use a different beam or spatial domain filter in each time-unit as illustrated in FIGS. 45A and 45B or in each time-unit/frequency-unit pair as illustrated in FIG. 46, the first DMRS can be present in each time-unit or time-unit/frequency-unit pair to estimate the corresponding channel.

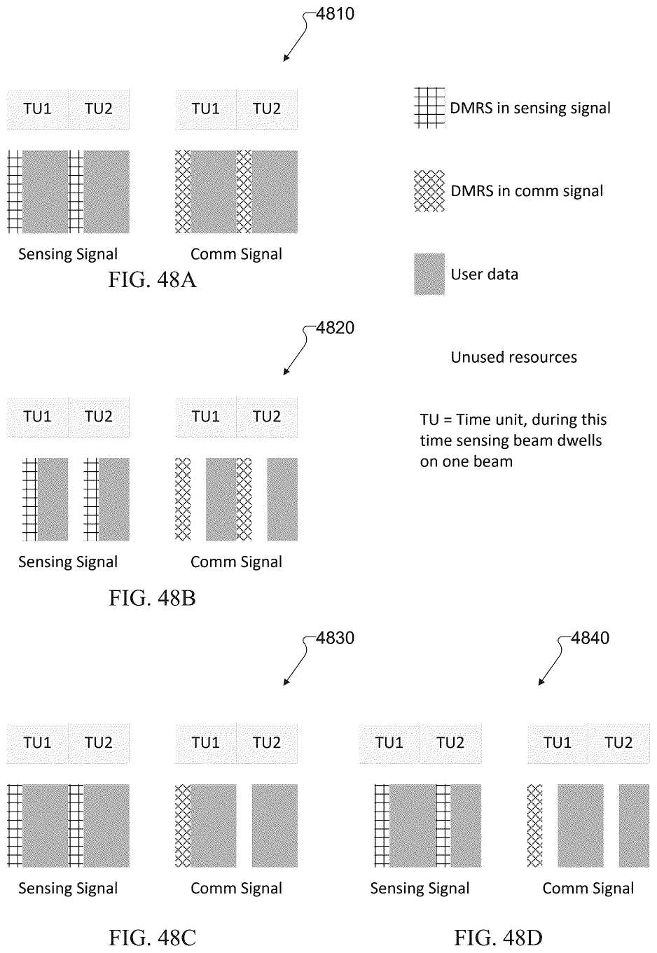

The following are examples of multiplexing the multiplexing the data, first DMRS and second DMRS.
In one example, the first DMRS and the second DMRS can use the same time-frequency resources, orthogonal codes are used for the first DMRS and the second DMRS. This is illustrated in FIG. 48A.
In one example, resources used for first DMRS on the sensing signal, correspond to unused resources on the communication signal. This is illustrated in FIG. 48B.
In one example, resources used for second DMRS on the communication signal correspond to unused resources on the sensing signal. This is illustrated in FIG. 48B.

FIGS. 48A-48D illustrate examples of multiplexing a first DMRS transmitted on sensing signal and a second DMRS transmitted on communication signal and data transmitted on both the communication and data signal according to embodiments of the present disclosure. In the examples for FIGS. 48A-48D, the communication transmission spans two time-units (TUs) (as an example, can be more or less), during each time-unit the sensing beam dwells in one beam or spatial domain filter. In 4810, there is a first DMRS (for sensing signal) in each TU. There is an overlapping second DMRS (for communication signal) in each TU. The first DMRS and second DMRS can use orthogonal resources, where the orthogonality can be in time-domain or frequency domain or code domain.

In 4820, there is a first DMRS (for sensing signal) in each TU, the overlapping resources in the communication signal are unused. There is a second DMRS (for communications signal) in each TU, the overlapping resources in the sensing signal are unused. This can be viewed as an example of first DMRS (for sensing signal) and second DMRS (for communications signal) using orthogonal time resources.

In 4830, there is a first DMRS (for sensing signal) in each TU, in the first TU the first DMRS (for sensing signal) overlaps with a second DMRS (for communications signal), in the second TU the overlapping resources of the first DMRS are unused in the communications signal. This can be viewed as an example of first DMRS (for sensing signal) and second DMRS (for communications signal) using orthogonal resources in first TU.

In 4840, there is a first DMRS (for sensing signal) in each TU, the overlapping resources in the communication signal are unused. There is a second DMRS (for communications signal) in the first TU, the overlapping resources in the sensing signal are unused. This can be viewed as an example of first DMRS (for sensing signal) and second DMRS (for communications signal) using orthogonal time resources in the first TU.

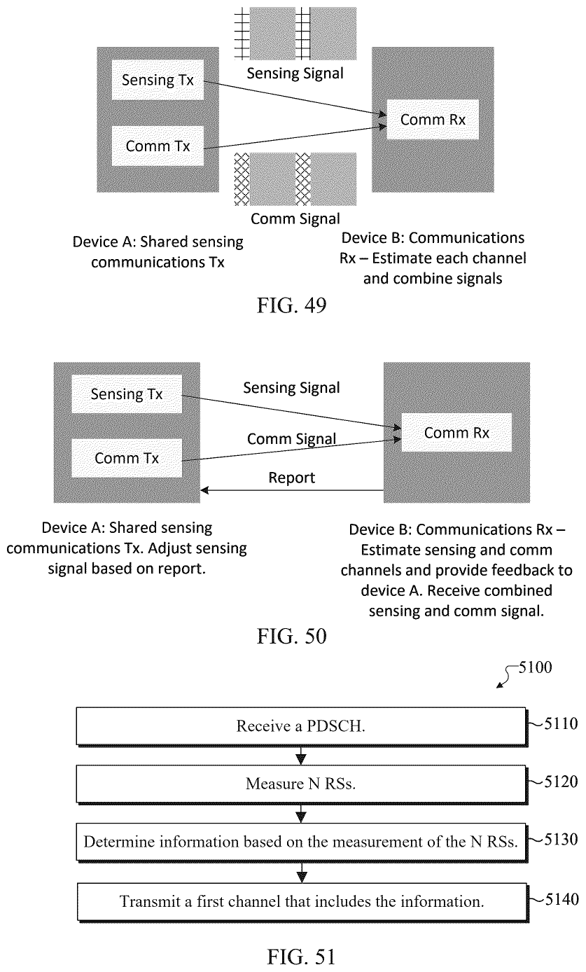

FIG. 49 illustrates an example of devices performing sensing and communication according to embodiments of the present disclosure. This example is for illustration only and other embodiments can be used without departing from the scope of the present disclosure.

In one example, the device receiving the communication signal receives the sensing signal, and uses the first DMRS to estimate the channel of the sensing signal, and uses the second DMRS to estimate the channel of the communication signal. The device can then coherently combine the user data on the sensing signal and communication signal using the corresponding channel estimate. As sensing beam or spatial domain filter changes in each TU, the channel for the sensing signal is estimated in each TU. This is illustrated in FIG. 49 as an example, assuming the signal structure of FIG. 48A.

FIG. 50 illustrates another example of devices performing sensing and communication according to embodiments of the present disclosure. This example is for illustration only and other embodiments can be used without departing from the scope of the present disclosure.

In one example, the second device receiving the communications signal estimates the sensing channel for each time-unit (e.g., as illustrated in FIGS. 45A and 45B) or each time-unit/frequency-unit pair (e.g., as illustrated in FIG. 46). The second device feedbacks (report from second device to first device) the estimates (for each time-unit or for each time-unit/frequency pair respectively) to the first device transmitting the communication and sensing signals. The first device transmitting the sensing signal and communications signal can adjust the sensing signal in such a way that the communication signal and sensing signal combine coherently when received at the second device. This is illustrated in FIG. 50.

In one example, the report from the second device to the first device includes the channel quality of the sensing signal for each time-unit (e.g., as in FIGS. 45A and 45B) or each time-unit/frequency-unit pair (e.g., as in FIG. 46)—corresponding to a sensing beam or spatial domain filter, as well the channel quality of the communications signal.

In one example, the report from the second device to the first device includes ratio or difference of the channel quality of the sensing signal for each time-unit (e.g., as in FIGS. 45A and 45B) or each time-unit/frequency-unit pair (e.g., as in FIG. 46)—corresponding to a sensing beam or spatial domain filter, and that of the channel quality of the communications signal (for example the phase difference and/or amplitude ratio and/or amplitude difference in dB).

In one example, the signal transmitted from a first device on the first beam (sensing signal), is a first encoded from of the communication signal. The second transmitted from the first device on the second beam (communication signal) is a second encoded form of the communication signal. The encoding is done in such a way that when the two signals are received at a second device intending to receive the communication signal, the second device is able to extract the communication signal.

An example of such encoding is provided. Let the intended communication signal in two resource elements be A₀ and A₁. The intended communication signal is encoded for transmission over two resource elements in the communication signal and a corresponding two resource elements in the sensing signal. In one example, the two resource elements can be two sub-carriers in a same symbol (e.g., two consecutive sub-carriers in same symbol). In one example, the two resource elements can be two symbols on a same sub-carrier (e.g., two consecutive symbols with a same sub-carrier). Let the encoding be such,
The first communication signal resource element is A₀+A₁.
The second communication signal resource element is A₀−A₁
The corresponding first sensing signal resource element is A₀−A₁.
The corresponding second sensing signal resource element is A₀+A₁.
The channel response of the communication signal is H_{c}. The channel response of the sensing signal is Hₛ.
Therefore, the first resource element at the receiver is (H_{c}+Hₛ)A₀+(H_{c}−Hₛ)A₁, and
The second resource element at receiver is (H_{c}+Hₛ)A₀−(H_{c}−Hₛ)A₁.

By adding the first resource element and the second resource element at the receiver, the result is 2(H_{c}+Hₛ)A₀. By subtracting the second resource element from the first resource element ta the receiver, the result is 2(H_{c}−Hₛ)A₁. By knowing the sensing channel and communication channel, i.e., H_{c} and Hₛ the receiver can get A₀ and A₁. H_{c} and Hₛ can be obtained from respective DMRS signals in communication signal and sensing signal respectively as aforementioned.

In one example, the beams or spatial domain filters for communication and sensing can have a same shape (e.g., beam width). In one example, the beams or spatial domain filters for communication and sensing can have different shapes (e.g., different beam width).

In one example, a device determines a first power Pₛ for the sensing signal and a second power for the P_{c} for the communications signal. In one example, Pₛ is determined by the device, e.g., based on the sensing target (e.g., distance and/or size and/or speed of sensing target).

In one example, the device is configured a power for the sensing signal Pₛ, and the device is configured a power for the communication signal P_{c}. In one example, Pₛ is determined by the device, e.g., based on the sensing target (e.g., distance and/or size and/or speed of sensing target).

In one example, the device is configured a power for the sensing signal Pₛ, and the device determines a power for the communication signal P_{c}, e.g., based on power control such that P_{c}≤P_{c,max}. Wherein, P_{c,max} is configured to the device or determine based on device capability or power class. In one example, Pₛ is determined by the device, e.g., based on the sensing target (e.g., distance and/or size and/or speed of sensing target).

In one example, the device determines a power for the communication signal P_{c}, e.g., based on power control, the device is configured a maximum power Pₘₐₓ, or P_{c,max} is determined based on device capability or power class, the device determines the sensing power such Pₛ=Pₘₐₓ−P_{c}.

In one example, the device determines a power for the communication signal P_{c}, e.g., based on power control, the device is configured a maximum power Pₘₐₓ, or P_{c,max} is determined based on device capability or power class, the device determines the sensing power such Pₛ=max(Pₘₐₓ−P_{c}, P_{s,max}), wherein P_{s,max} is configured or determined by the device, e.g., based on the sensing target (e.g., distance and/or size and/or speed of sensing target).

In one example, the device determines Pₛ, based on one or more of the above examples. If Pₛ is less than or less than or equal to P_{s,min}, the sensing signal is not transmitted. In one example, P_{s,min} is configured to the device. In one example P_{s,min} is determined by the device, e.g., based on the sensing target (e.g., distance and/or size and/or speed of sensing target).

FIG. 51 illustrates an example method 5100 performed by a UE in a wireless communication system according to embodiments of the present disclosure. The method 5100 of FIG. 51 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 5100 is for illustration only and other embodiments can be used without departing from the scope of the present disclosure.

The method 5100 begins with the UE receiving a PDSCH (5110). For example, in 5110, the PDSCH includes first REs associated with DL-SCH, second REs associated with DMRS, and third REs associated with N RSs, where N is larger than or equal to 1. For example, each of the N RSs is associated with a corresponding spatial domain filter. In various embodiments, the UE receives a configuration message indicating a value of N and the PDSCH is in response to DCI that indicates transmission of the N RSs. In some examples, the PDSCH is in response to DCI that indicates a value of N. In some examples, the third REs are included in M1 OFDM symbols. The first REs and second REs are included in M2 OFDM symbols, where M1 and M2≥1.

The UE then measures N RSs (5120). The UE then determines information based on the measurement of the N RSs (5130). In various embodiments, the information is an index corresponding to a RS among the DMRS and the N RSs. The RS is based on a RSRP. The information is represented by a bit field of size ┌log₂(N+1)┐, where index 0 represents the DMRS and indices 1 to N represent a corresponding RS of the N RSs. In various embodiments, the UE determines a TCI state based on the information and the applies the TCI state at a start of a slot that is an earliest slot from a time T of the first channel.

The UE then transmits a first channel that includes the information (5140). In various embodiments, the first channel includes HARQ-ACK information.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive a physical downlink shared channel (PDSCH), wherein the PDSCH includes:
first resource elements (REs) associated with downlink shared channel (DL-SCH),
second REs associated with demodulation reference signals (DMRS), and
third REs associated with N reference signals (RSs), where N is larger than or equal to 1, wherein each of the N RSs is associated with a corresponding spatial domain filter; and
a processor operably coupled to the transceiver, the processor configured to:
measure the N RSs, and
determine information based on the measurement of the N RSs,
wherein the transceiver is further configured to transmit a first channel that includes the information.

2. The UE of claim 1, wherein the PDSCH is in response to downlink control information (DCI) that indicates a value of N.

3. The UE of claim 1, wherein:
the transceiver is further configured to receive a configuration message indicating a value of N, and
the PDSCH is in response to downlink control information (DCI) that indicates transmission of the N RSs.

4. The UE of claim 1 wherein:
the information is an index corresponding to a RS among the DMRS and the N RSs,
the RS is based on a reference signal received power (RSRP), and
the information is represented by a bit field of size ┌log₂(N+1)┐, where index 0 represents the DMRS and indices 1 to N represent a corresponding RS of the N RSs.

5. The UE of claim 1, wherein the first channel includes hybrid automatic repeat request acknowledgement (HARQ-ACK) information.

6. The UE of claim 1, wherein:
the third REs are included in M1 orthogonal frequency division multiplexing (OFDM) symbols, and
the first REs and second REs are included in M2 OFDM symbols, where M1≥1 and M2≥1.

7. The UE of claim 1, wherein:
the processor is further configured to determine a transmission configuration indicator (TCI) state based on the information, and
the transceiver is further configured to apply the TCI state at a start of a slot that is an earliest slot from a time T of the first channel.

8. A base station (BS), comprising:
a processor; and
a transceiver operably coupled to the processor, the transceiver configured to:
transmit a physical downlink shared channel (PDSCH), wherein the PDSCH includes:
first resource elements (REs) associated with downlink shared channel (DL-SCH),
second REs associated with demodulation reference signals (DMRS), and
third REs associated with N reference signals (RSs), where N is larger than or equal to 1, wherein each of the N RSs is associated with a corresponding spatial domain filter, and
receive a first channel that includes information related to measurement of the N RSs.

9. The BS of claim 8, wherein the PDSCH is in response to downlink control information (DCI) that indicates a value of N.

10. The BS of claim 8, wherein:
the transceiver is further configured to transmit a configuration message indicating a value of N, and
the PDSCH is in response to downlink control information (DCI) that indicates transmission of the N RSs.

11. The BS of claim 8 wherein:
the information is an index corresponding to a RS among the DMRS and the N RSs,
the RS is based on a reference signal received power (RSRP), and
the information is represented by a bit field of size ┌log₂(N+1)┐, where index 0 represents the DMRS and indices 1 to N represent a corresponding RS of the N RSs.

12. The BS of claim 8, wherein the first channel includes hybrid automatic repeat request acknowledgement (HARQ-ACK) information.

13. The BS of claim 8, wherein:
the third REs are included in M1 orthogonal frequency division multiplexing (OFDM) symbols, and
the first REs and second REs are included in M2 OFDM symbols, where M1≥1 and M2≥1.

14. The BS of claim 8, wherein:
the processor is further configured to determine a transmission configuration indicator (TCI) state based on the information, and
the transceiver is further configured to apply the TCI state at a start of a slot that is an earliest slot from a time T of the first channel.

15. A method of operating a user equipment (UE), the method comprising:
receiving a physical downlink shared channel (PDSCH), wherein the PDSCH includes:
first resource elements (REs) associated with downlink shared channel (DL-SCH),
second REs associated with demodulation reference signals (DMRS), and
third REs associated with N reference signals (RSs), where N is larger than or equal to 1, wherein each of the N RSs is associated with a corresponding spatial domain filter;
measuring the N RSs;
determining information based on the measurement of the N RSs; and
transmitting a first channel that includes the information.

16. The method of claim 15, wherein the PDSCH is in response to downlink control information (DCI) that indicates a value of N.

17. The method of claim 15, further comprising:
receiving a configuration message indicating a value of N,
wherein the PDSCH is in response to downlink control information (DCI) that indicates transmission of the N RSs.

18. The method of claim 15, wherein:
the information is an index corresponding to a RS among the DMRS and the N RSs,
the RS is based on a reference signal received power (RSRP), and
the information is represented by a bit field of size ┌log₂(N+1)┐, where index 0 represents the DMRS and indices 1 to N represent a corresponding RS of the N RSs.

19. The method of claim 15, wherein the first channel includes hybrid automatic repeat request acknowledgement (HARQ-ACK) information.

20. The method of claim 15, further comprising:
determining a transmission configuration indicator (TCI) state based on the information; and
applying the TCI state at a start of a slot that is an earliest slot from a time T of the first channel.
